(19) United States
(12) Patent Application Publication
(10) Pub. No.: US 2009/0134367 A1
(43) Pub. Date: May 28, 2009

(54) COLOR FILTER INK, COLOR FILTER INK SET, COLOR FILTER, IMAGE DISPLAY DEVICE, AND ELECTRONIC DEVICE

(75) Inventors: Masaya SHIBATANI, Matsumoto (JP); Mitsuhiro ISOBE, Kofu (JP); Hiroshi KIGUCHI, Suwa (JP); Akihiro SHINTANI, Shiojiri-shi (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/272,158

(22) Filed: Nov. 17, 2008

(30) Foreign Application Priority Data
Nov. 28, 2007 (JP) 2007-306954

(51) Int. Cl. G02C 7/10; G02F 1/361; C09D 11/10

(52) U.S. Cl. 252/582

(57) ABSTRACT

A color filter ink is adapted to be used to manufacture a color filter by an inkjet method. The color filter ink includes a main pigment including a halogenated phthalocyanine zinc complex, a secondary pigment including a sulfonated pigment derivative, a solvent and a curable resin material. The curable resin material includes a first polymer and a second polymer. The first polymer includes at least a first epoxy-containing vinyl monomer as a monomer component. The second polymer includes at least the fluoroalkyl- or fluoroaryl-containing vinyl monomer represented by a prescribed chemical formula as a monomer component, which is absent from the first polymer.

### CROSS-REFERENCE TO RELATED APPLICATIONS

This application claims priority to Japanese Patent Application No. 2007-306954 filed on Nov. 28, 2007. The entire disclosure of Japanese Patent Application No. 2007-306954 is hereby incorporated herein by reference.

### BACKGROUND

1. Technical Field

The present invention relates to a color filter ink, a color filter ink set, a color filter, an image display device, and an electronic device.

2. Related Art

Color filters are generally used in liquid crystal display devices (LCD) and the like that display color.

Color filters have conventionally been manufactured using a so-called photolithography method in which a coating film composed of a material (color layer formation composition) that includes a colorant, a photosensitive resin, a functional monomer, a polymerization initiator, and other components is formed on a substrate, and then photosensitive processing for radiating light via a photomask, development processing, and the like are performed. In such a method, the color filters are usually manufactured by repeating a process in which a coating film corresponding to each color is formed on substantially the entire surface of the substrate, only a portion of the coating film is cured, and most of the film other than the cured portion is removed, so that there is no color overlap. Therefore, only a portion of the coating film formed in color filter manufacturing remains as a color layer in the finished color filter, and most of the coating film is removed in the manufacturing process. Therefore, not only does the manufacturing cost of the color filter increase, but the process is also undesirable from the perspective of resource saving.

Methods have recently been proposed for forming the color layer of a color filter through the use of an inkjet head (droplet discharge head) (see Japanese Laid-Open Patent Publication No. 2002-372613, for example). In such a method, because the discharge position and the like of droplets of the material (color layer formation composition) used to form the color layer are easily controlled, and waste of the color layer formation composition can be reduced, the environmental impact can be reduced, and manufacturing cost can also be minimized.

Since pigments generally have superior color fastness to light in comparison to dyes, pigments are widely used as colorants in color filter inks. When manufacturing a color filter, three colors of ink (color filter ink) corresponding to the three primary colors of light (red, green, and blue) are normally used.

C.I. pigment green 36 is widely used as a green color filter ink due to the dispersion and dispersion stability of the pigment particles. However, the higher luminance demanded of display images in recent years is difficult to accommodate with C.I. pigment green 36.

Meanwhile, it has been discovered by the present inventors that when manufacturing a color filter, a green colorant having superior lightness, luminance and contrast to C.I. pigment green 36 can be obtained by using a halogenated phthalocyanine zinc complex. However, the dispersion of a halogenated phthalocyanine zinc complex in an ink is poor. Thus, when a color filter ink containing a halogenated phthalocyanine zinc complex is used to form a colored portion, such problems as unevenness of color and unevenness of saturation occur and it is difficult to prevent these problems in a stable manner for a long period of time. Additionally, when a color filter ink containing a halogenated phthalocyanine zinc complex is used, it is difficult to discharge droplets of the color filter ink in a sufficiently stable manner, i.e., the droplet discharge stability is not sufficient.

### SUMMARY

An object of the present invention is to provide an inkjet-type color filter ink that has excellent discharge stability and excellent long-term dispersion stability (dispersion stability) of a pigment and enables a color filter to be manufactured which can produce a display image having excellent lightness and contrast, in which unevenness of color and saturation among regions is suppressed, and which has excellent durability and uniformity of characteristics between individual units. It is also an object of the present invention to provide a color filter ink set provided with such a color filter ink. Still another object is to provide a color filter that enable a display image having excellent lightness and contrast to be obtained, in which unevenness of color and saturation among regions is suppressed, and that has excellent durability and uniformity of characteristics between individual units. Another object is to provide an image display device and electronic device equipped with the color filter.

The aforementioned objects are achieved by the present invention, which is described below.

A color filter ink in accordance with the first aspect is adapted to be used to manufacture a color filter by an inkjet method. The color filter ink includes a main pigment, a secondary pigment, a solvent and a curable resin material. The main pigment includes a halogenated phthalocyanine zinc complex. The secondary pigment includes a sulfonated pigment derivative. The curable resin material includes a first polymer and a second polymer. The first polymer includes at least a first epoxy-containing vinyl monomer as a monomer component and not including a fluoroalkyl- or fluoroaryl-containing vinyl monomer represented by a chemical formula (1) below as a monomer component. The second polymer includes at least the fluoroalkyl- or fluoroaryl-containing vinyl monomer represented by the chemical formula (1) below as a monomer component.

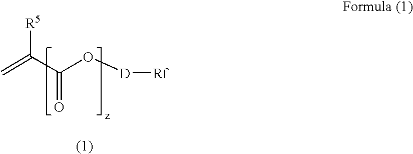

In the chemical formula (1), R⁵ represents a hydrogen atom or a C₁₋₇ alkyl group, D represents a single bond hydrocarbon group, a bivalent hydrocarbon group or a bivalent hydrocarbon group having a hetero atom, Rf represents a C₁₋₂₀ fluoroalkyl group or fluoroaryl group, and a value z is 0 or 1.

In this way, it is possible to provide an inkjet-type color filter ink set that has excellent discharge stability and excellent long-term dispersion stability (dispersion stability) of a pigment and enables a color filter to be manufactured which can produce a display image having excellent lightness and contrast, in which unevenness of color and saturation among regions is suppressed, and which has excellent durability and uniformity of characteristics between individual units.

In the color filter ink as described above, the first polymer is preferably a copolymer having the first epoxy-containing vinyl monomer and a second vinyl monomer as monomer components, the second vinyl monomer having an isocyanate group or a block isocyanate group in which an isocyanate group is protected by a protective group.

It is thereby possible to effectively prevent the color of the color filter (colored portion) manufactured using the color filter ink from changing over time, and to endow the color filter with particularly excellent durability.

In the color filter ink as described above, the first polymer is preferably a copolymer having the first epoxy-containing vinyl monomer and a third vinyl monomer as monomer components, the third vinyl monomer having a hydroxyl group.

The adhesion to the color filter substrate of the colored portion of the color filter formed using the color filter ink can thereby be reliably maintained over a longer period of time, and the durability of the color filter can be made particularly excellent.

In the color filter ink as described above, a ratio of a content of the first polymer to a content of the second polymer is preferably 25:75 to 75:25 in terms of weight.

The discharge stability of the color filter ink can thereby be made particularly excellent. Unevenness of color and saturation among different regions of a color filter manufactured using the color filter ink can be more reliably prevented, and excellent uniformity of characteristics can be achieved between individual units (i.e., color filters). The color filter can also be endowed with particularly excellent durability.

In the color filter ink as described above, the pigment derivative has a chemical structure represented by a chemical formula (2) below.

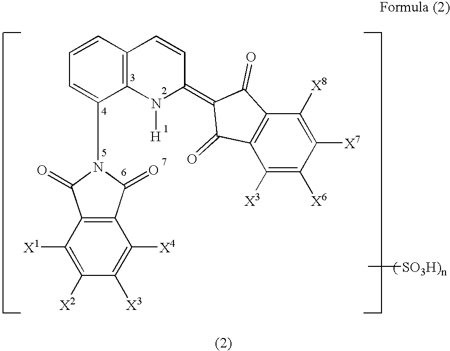

In the chemical formula (2), n is an integer from 1 to 5, and each of X¹ to X⁸ is independently one of a hydrogen atom and a halogen atom.

The long-term dispersion stability of the pigment particles in the color filter ink and the droplet discharge stability of the color filter ink can thereby be made to be particularly excellent.

It is preferable for the color filter ink as described above to contain 0.5 to 32 parts by weight of the pigment derivative with respect to 100 parts by weight of the main pigment.

The long-term dispersion stability of the pigment particles in the color filter ink and the droplet discharge stability of the color filter ink can thereby be made to be particularly excellent, and a colored portion having excellent lightness can be formed.

In the color filter ink as described above, it is preferable for the solvent to contain one or more compounds selected from the group consisting of 1,3-butylene glycol diacetate, bis(2-butoxyethyl)ether, and diethylene glycol monobutyl ether acetate.

The long-term dispersion stability of the pigment particles in the color filter ink and the droplet discharge stability of the color filter ink can thereby be made to be particularly excellent.

A color filter ink set according to the second aspect is a color filter ink set comprising a plurality of different colors of color filter ink, wherein a color filter ink according to the present invention is provided as a green ink.

It is thereby possible to provide an inkjet-type color filter ink that has excellent discharge stability and excellent long-term dispersion stability (dispersion stability) of a pigment, that enables a display image having excellent lightness and contrast to be obtained, with which unevenness of color and saturation among regions is suppressed, that provides excellent uniformity of characteristics between individual units, and that can be suitably used to manufacture a color filter having excellent durability.

A color filter according to the third aspect is manufactured using a color filter ink according to the present invention.

It is thereby possible to provide a color filter that has excellent durability and excellent uniformity of characteristics between individual units, in which unevenness of color and saturation between regions is suppressed, and with which a display image having excellent lightness and contrast can be obtained.

A color filter according to the fourth aspect is manufactured using a color filter ink set according to the present invention.

It is thereby possible to provide a color filter that has excellent durability and excellent uniformity of characteristics between individual units, in which unevenness of color and saturation between regions is suppressed, and with which a display image having excellent lightness and contrast can be obtained.

An image display device according to the fifth aspect is equipped with a color filter according to the present invention.

It is thereby possible to provide an image display device that has excellent durability and excellent uniformity of characteristics between individual units, in which unevenness of color and saturation between regions of a display section is suppressed, and with which a display image having excellent lightness and contrast can be obtained.

The image display device as described above is preferably a liquid crystal panel.

It is thereby possible to provide an image display device that has excellent durability and excellent uniformity of characteristics between individual units, in which unevenness of color and saturation between regions of a display section is suppressed, and with which a display image having excellent lightness and contrast can be obtained.

An electronic device according to the sixth aspect is characterized is equipped with an image display device according to the present invention.

It is thereby possible to provide an electronic device that has excellent durability and excellent uniformity of characteristics between individual units, in which unevenness of color and saturation between regions of a display section is suppressed, and with which a display image having excellent lightness and contrast can be obtained.

### BRIEF DESCRIPTION OF THE DRAWINGS

Referring now to the attached drawings which form a part of this original disclosure:

FIG. 1 is a cross-sectional view showing a preferred embodiment of a color filter according to the present invention.

FIG. 2 includes a series of cross-sectional views (1a) to (1e) showing a method for manufacturing a color filter.

FIG. 3 is perspective view showing a droplet discharge device using in the manufacture of the color filter.

FIG. 4 is a view of the droplet discharge means of the droplet discharge device shown in FIG. 3 as seen from the stage.

FIG. 5 is a view showing the bottom surface of the droplet discharge head of the droplet discharge device shown in FIG. 3.

FIG. 6 includes a pair of diagrams (a) and (b) showing a droplet discharge head of the droplet discharge device shown in FIG. 3, wherein FIG. 6(a) is a cross-sectional perspective view and FIG. 6(b) is a cross-sectional view.

FIG. 7 is a cross-sectional view showing an embodiment of a liquid crystal display device.

FIG. 8 is a perspective view showing a mobile (or notebook) personal computer exemplifying an electronic device in accordance with the present invention.

FIG. 9 is a perspective view showing a portable telephone (including PHS) exemplifying an electronic device in accordance with the present invention.

FIG. 10 is a perspective view showing a digital still camera exemplifying an electronic device in accordance with the present invention.

### DETAILED DESCRIPTION OF EXEMPLARY EMBODIMENTS

Preferred embodiments of the present invention will now be explained.

### Color Filter Ink

The color filter ink of the present invention is an ink used to manufacture a color filter (form the colored portion of a color filter), and is used particularly in the manufacture of a color filter by an inkjet method.

The color filter ink contains a pigment, a solvent, and a curable resin material.

### Pigment

A color filter ink in accordance with the present invention contains a halogenated phthalocyanine zinc complex as a main pigment and a sulfonated pigment derivative as a secondary pigment.

### Main Pigment (Halogenated Phthalocyanine Zinc Complex)

The halogenated phthalocyanine zinc complex used as the main pigment has zinc as a central metal and halogenated phthalocyanine as a ligand. Halogenated phthalocyanine zinc complex has superior lightness to C.I. pigment green 7 and C.I. pigment green 36. Consequently, a color filter having excellent lightness can be obtained by using a color filter ink containing a halogenated phthalocyanine zinc complex.

In a halogenated phthalocyanine, at least a portion of the hydrogen atoms of a benzene ring forming the phthalocyanine have been replaced with halogen atoms. Although any halogenated phthalocyanine that satisfies this condition is acceptable, it is preferable for the halogenated phthalocyanine to have a chemical structure in accordance with Formula (3) shown below. A halogenated phthalocyanine zinc complex in accordance with this structure has excellent lightness and luminance, as well as excellent coloration.

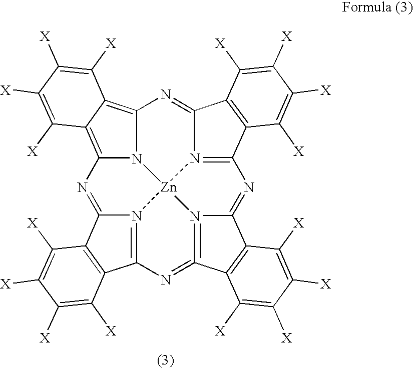

In Formula (3), each X is independently a hydrogen atom (H), a chlorine atom (Cl), or a bromine atom (Br), the number of H in one molecule is from 0 to 4, the number of Cl in one molecule is 0 to 8, and the number of Br in one molecule is 4 to 16.

While there are no particular limitations on the content of halogenated phthalocyanine zinc complex in the color filter ink, the content is preferably 2.8 to 10.7 wt %, and more preferably 2.9 to 8.6 wt %.

Additionally, it is acceptable for the halogenated phthalocyanine zinc complex to be a single compound or a mixture of a plurality of different types of compounds.

### Secondary Pigment

In the present invention, as explained previously, the color filter ink contains a sulfonated pigment derivative as a secondary pigment in addition to the halogenated phthalocyanine zinc complex (main pigment).

The present inventor has discovered that by including a sulfonated pigment derivative (and also including a curable resin material, as explained later) in addition to the halogenated phthalocyanine zinc complex (main pigment), excellent dispersion and dispersion stability of the halogenated phthalocyanine zinc complex in the floor filter ink can be achieved (a halogenated phthalocyanine zinc complex has poor dispersion and dispersion stability when used alone) and a color filter manufactured using the color filter ink can be made to have excellent contrast and lightness.

The sulfonated pigment derivative used as the secondary pigment is obtained by applying a sulfonation treatment to a publicly known pigment or publicly known pigment derivative.

The sulfonation can be accomplished with an aromatic substitution reaction using such a sulfonation agent as, for example, fuming sulfuric acid, a concentrated sulfuric acid, a mixture of fuming sulfuric acid and concentrated sulfuric acid, a mixture of sulfuric acid and phosphorus pentoxide, chlorosulfonic acid, sodium bisulfite, or a mixture of sulfuryl chloride and aluminum chloride. It is also acceptable to heat the reactants during the aromatic substitution reaction if necessary.

During sulfonation treatment, it is acceptable to use a catalyst if necessary. Examples of catalysts that can be used include calcium sulfate, aluminum sulfate, iron sulfate, and other metal sulfate salts. Using a catalyst provides such effects as preventing or suppressing undesirable side reactions, loosening the reaction conditions, and increasing the reaction rate.

There are no particular limitations on the amount of a catalyst to be used, but it is preferable to use 0.05 to 10 parts by weight of the catalyst with respect to every 100 parts by weight of the pigment to be sulfonated.

In order to control (suppress) the reaction rate, it is acceptable to use ethylene glycol, propylene glycol, chloroform, ethylene chloride, or carbon tetrachloride in the reaction system.

After the sulfonation reaction is finished, the sulfonated pigment derivative can be precipitated out of the reaction mixture by pouring the reaction mixture into an amount of water that is much larger than the amount of sulfonation agent used. The sulfonated pigment derivative can then be obtained by filtering the sulfonated pigment derivative out of the water, washing it in dilute hydrochloric acid or another dilute acid, rinsing it with water, and drying it. If chloroform, ethylene chloride, carbon tetrachloride or other volatile, non-water soluble solvent was used, then it is preferable to remove the solvent by distillation before putting the reaction mixture into water.

With the present invention, the sulfonic acid obtained as explained above can be used as is to serve as the secondary pigment (sulfonated pigment derivative) or a salt of the sulfonic acid can be used as the secondary pigment (sulfonated pigment derivative). Examples of compounds and elements that form a salt with the sulfonic acid include such univalent, bivalent, and trivalent metals as lithium, potassium, sodium, calcium, magnesium, strontium, and aluminum, such monoalkyl amines as ethyl amine and butyl amine, such dialkyl amines as dimethyl amine and diethyl amine, such trialkyl amine monoethanol amines as trimethyl amine and triethyl amine, such alkanolamines as diethanol amine and triethanol amine, and ammonia. All of the amines mentioned are organic amines.

Among these, if a salt of an alkaline metal is used, the salt will be water soluble and the certain advantageous effects are obtained. Specifically, after dissolving the salt in water, non-water soluble impurities can be removed by simply filtering the solution and a sulfonated pigment derivative having a higher purity can be obtained.

In the present invention, it is acceptable to use any sulfonated pigment derivative as the secondary pigment, but it is preferable for the secondary pigment to have a chemical structure in accordance with Formula (2) shown below.

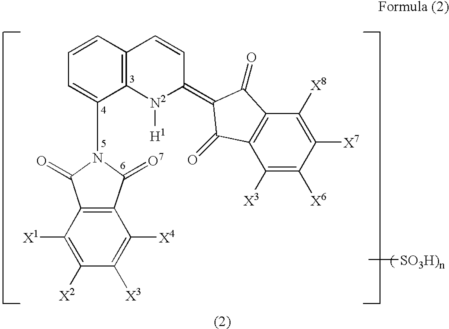

In Formula (2), n is an integer from 1 to 5, and X¹ to X⁸ are each independently either a hydrogen atom or a halogen atom.

With such a structure, the long-term dispersion stability of the pigment particles in the color filter ink can be made to be particularly excellent. Additionally, since a particularly efficient fine dispersion step can be accomplished using a method to be described later, the color filter ink can be manufactured in a shorter amount of time using a smaller amount of energy. As a result, the color filter ink can manufactured with a particularly high productivity, thereby contributing to a reduction of production cost. Also, a color filter manufactured using the color filter ink can also be endowed with particularly excellent contrast, lightness, and other characteristics.

It is through diligent research that the inventor has discovered that the superb effects described above can be obtained by using a sulfonated pigment derivative (secondary pigment) having a specific chemical structure together with a halogenated phthalocyanine zinc complex (main pigment). The mechanism by which these effects are obtained is not known in detail, but what is believed to be a reason for these effects will now be explained. The halogenated phthalocyanine of the main pigment forms a highly conjugated system throughout the entire molecule and has a planar structure, thus making it stable in terms of energy. Since the planar halogenated phthalocyanine molecules are arranged to be stacked on top of one another (in a parallel fashion), a stable state is obtained in which the π electrons of the conjugated systems of the respective molecules overlap one another. Consequently, the main pigment naturally coheres to itself and does not readily disperse in a solvent in a stable fashion.

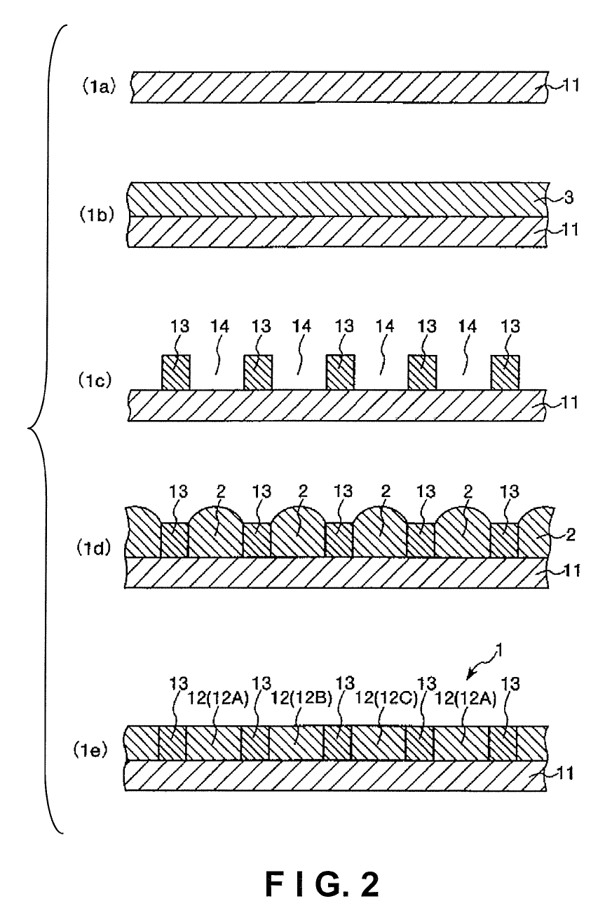

Meanwhile, in the sulfonated pigment derivative described above, a hydrogen atom bonded to a nitrogen atom as shown in Formula (2) forms a hydrogen bond with an oxygen atom forming a phthalimide structure. Thus, the hydrogen atom bonded to a nitrogen atom in Formula (2) is strongly bonded to both a nitrogen atom forming a quinoline structure and to an oxygen atom forming a phthalimide structure, and the sulfonated pigment derivative has a stable annular structure (seven member ring structure) made up of the seven atoms labeled with the numerals 1 to 7 in FIG. 2. Because of the seven member ring structure, the plane of the quinoline structure and the plane of the phthalimide structure are not parallel

Since the plane of the quinoline structure and the plane of the phthalimide structure are not parallel, a sulfonated pigment derivative having an appropriate affinity to halogenated phthalocyanine can enter between the molecules of the halogenated phthalocyanine zinc complex and cause the halogenated phthalocyanine zinc complex (which readily coheres to itself as described above) not to cohere to itself readily. Additionally, the sulfonated pigment derivative (secondary pigment) exhibits excellent dispersion in a solvent to be described later because it has a sulfo group within each molecule thereof. It is believed that these factors combine constructively to provide the excellent effects described previously.

Although in the present invention it is preferable for the sulfonated pigment derivative to have the chemical structure shown in Formula (2), as described previously, it is particularly preferable for the sulfonated pigment derivative to have the chemical structure shown in Formula (4). With the chemical structure shown in Formula (4), the previously described effects are exhibited even more markedly. It is believed that this result occurs because the sulfonated pigment derivative has an excellent affinity with respect to a solvent and a curable resin material that will be described later while also having an excellent affinity with respect to the halogenated main pigment, the former affinity being due to the sulfonated pigment derivative having a sulfo group and the latter affinity being due to the sulfonated pigment derivative being strongly halogenated.

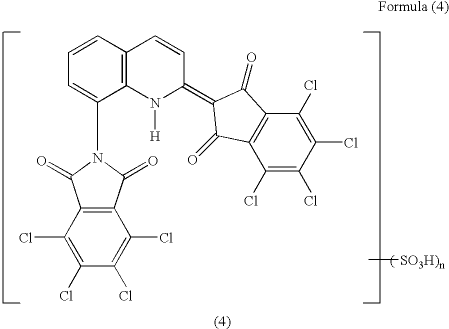

In Formula (4), n is an integer from 1 to 5.

While there are no particular limitations on the content of the sulfonated pigment derivative in the color filter ink, the content is preferably 0.07 to 2.7 wt %, and more preferably 0.2 to 2.1 wt %.

Also, while there are no particular limitations on the content of the secondary pigment (sulfonated pigment derivative) in the color filter ink, it is preferable for the color filter ink to contain 0.5 to 32 parts by weight of the secondary pigment for every 100 parts by weight of the main pigment or, more preferably, 7 to 28 parts by weight of the secondary pigment for every 100 parts by weight of the main pigment. When these content conditions are satisfied, the long-term dispersion stability of the pigment particles in the color filter ink is particularly excellent and a colored portion having particularly excellent brightness and contrast can be formed with the color filter ink. If the content of the secondary pigment (sulfonated pigment derivative) is too low, then it will be difficult to achieve a sufficient total content of pigment in the color filter ink and, depending on the type of solvent used, it will be difficult to obtain a sufficient long-term dispersion stability of the pigment particles in the color filter ink. Conversely, if the content of the secondary pigment (sulfonated pigment derivative) is too high, then the relative content of the main pigment will decline and it will be difficult to achieve the desired green color with excellent lightness.

Additionally, it is acceptable for the sulfonated pigment derivative (secondary pigment) to be a single compound or a mixture of a plurality of different types of compounds.

### Other Pigments

In the present invention, the color filter ink should include as pigments a halogenated phthalocyanine zinc complex (main pigment) and a sulfonated pigment derivative (secondary pigment), as described heretofore. However, it is also acceptable for the color filter ink to contain other pigment components (additional pigments).

Although various types of organic pigments and inorganic pigments can be used as additional pigments, examples include compounds categorized as “pigments” in the Color Index (C.I., The Society of Dyer and Colourists). More specifically, compounds having the following Color Index (C.I.) numbers can be used: C.I. pigment yellows 1, 3, 12, 13, 14, 15, 16, 17, 20, 24, 31, 34, 35, 35:1, 37, 37:1, 42, 43, 53, 55, 60, 61, 65, 71, 73, 74, 81, 83, 93, 94, 95, 97, 98, 100, 101, 104, 106, 108, 109, 110, 113, 114, 116, 117, 119, 120, 126, 127, 128, 129, 138, 139, 150, 151, 152, 153, 154, 155, 156, 157, 166, 168, 175, 180, 184, 185; C.I. pigment oranges 1, 5, 13, 14, 15, 16, 17, 20, 20:1, 24, 34, 36, 38, 40, 43, 46, 49, 51, 61, 63, 64, 72, 73, 104; C.I. pigment violets 1,3, 14, 16, 19, 23, 29, 32, 36, 38, 50; C.I. pigment reds 1, 2, 3, 4, 5, 6, 7, 8, 9, 10, 11, 12, 14, 15, 16, 17, 18, 19, 21, 22, 23, 30, 31, 32, 37, 38, 40, 41, 42, 48:1, 48:2, 48:3, 48:4, 49:1, 49:2, 50:1, 52:1, 53:1, 57, 57:1, 57:2, 58:2, 58:4, 60:1, 63:1; 63:2, 64:1, 81, 81:1, 83, 88, 90:1, 97, 101, 102, 104, 105, 106, 108, 108:1, 112, 113, 114, 122, 123, 144, 146, 149, 150, 151, 166, 168, 170, 171, 172, 174, 175, 176, 177, 178, 179, 180, 185, 187, 188, 190, 193, 194, 202, 206, 207, 208, 209, 215, 216, 220, 224, 226, 242, 243, 245, 254, 255, 264, 265; C.I. pigment blues 1, 15, 15:1, 15:2, 15:3, 15:4, 15:6, 17:1, 18, 60, 27, 28, 29, 35, 36, 60, 80; C.I. pigment greens 7, 36, 15, 17, 18, 19, 26, 50; C.I. pigment browns 7, 11, 23, 25, 33; C.I. pigment blacks 1 and 7; and derivatives of any of these. It is also acceptable to use one or a combination of two or more of any of these pigments.

When an additional pigment is used, there are no particular limitations on the content (amount) of the additional pigment in the color filter ink, but it is preferable for the content to be smaller than the content of the halogenated phthalocyanine zinc complex and the content of the sulfonated pigment derivative.

It is preferable for the content of pigment (main pigment and secondary pigment) to be from 2.0 to 25 wt %, more preferable for the same to be from 3.5 to 20 wt %, and still more preferable for the same to be from 4.0 to 9.4%. When the content of pigments is within any of these ranges, a color filter having a higher color saturation can be manufactured using the color filter ink and a sharper display image can be obtained using the color filter. Additionally, a colored portion having a prescribed color saturation can be obtained with a smaller amount of color filter ink, which is advantageous in terms of saving resources. Also, since the amount of solvent that evaporates while a colored portion of a color filter is being formed can be suppressed, the impact on the environment can be reduced. When a conventional color filter ink contains a comparatively high concentration of pigment, the discharge stability is particularly low and flight deflection, instability of the droplet discharge quantity, and other problems occur particularly easily during discharging of the color filter ink. Furthermore, with a conventional color filter ink, particularly when droplet discharging of the color filter ink is executed in order to form a color portion on a large substrate (e.g., G5 or larger), the occurrence of bad products (rejected filters) is high due to variation of the discharge amount among different locations on the surface and the level of productivity with which the color filters can be manufactured declines markedly. Conversely, with the present invention, even when the color filter ink contains a relatively high concentration of pigment, such problems as those described above can be reliably prevented from occurring. Unevenness of color and saturation among different locations of a manufactured color filter and variation of characteristics between individual units can be reliably prevented, and color filters can be manufactured with excellent productivity, as will be described in detail later. In short, the effects of the present invention are more clearly demonstrated when the color filter ink contains a comparatively high concentration of pigment, as described above. The present invention also enables a color filter having excellent durability to be manufactured.

Although there are no particular limitations on the average particle size (diameter) of the pigment particles in the color filter ink, the average particle size is preferably from 10 to 200 nm or, more preferably, from 20 to 180 nm. With such an average pigment particle size, the dispersion stability of the pigment in the color filter ink is excellent and a color filter having excellent light fastness and providing superior contrast and lightness can be manufactured using the color filter ink.

### Solvent

The solvent functions as a dispersion medium that disperses the pigments in the color filter ink. In a color filter ink manufacturing method that will be explained later, the solvent normally functions as a solvent serving to dissolve a thermoplastic resin in a dispersion liquid. Also, normally, most of a solvent (dispersion medium) forming the color filter ink is removed during the process of manufacturing a color filter.

Ester compounds, ether compounds, hydroxyketones, carbonic diesters, cyclic amides, and the like may be used as the solvent. Preferred among these are (1) ethers (polyvalent alcohol ethers) as condensates of polyvalent alcohols (e.g., ethylene glycol, propylene glycol, butylene glycol, glycerin, and the like); alkyl ethers (e.g., methyl ether, ethyl ether, butyl ether, hexyl ether, and the like) of polyvalent alcohols or polyvalent alcohol ethers; and esters (e.g., formate, acetate, propionate, and the like); (2) esters (e.g., methyl esters and the like) of polyvalent carboxylic acids (e.g., succinic acid, glutamic acid, and the like); (3) ethers, esters, and the like of compounds (hydroxy acids) having at least one hydroxyl group and at least one carboxyl group in the molecule thereof; and (4) carbonic diesters having a chemical structure such as that obtained by reaction of a polyvalent alcohol and a phosgene. Examples of compounds that can be used as the solvent include 2-(2-methoxy-1-methylethoxy)-1-methyl ethyl acetate, triethylene glycol dimethyl ether, triethylene glycol diacetate, diethylene glycol monoethyl ether acetate, 4-methyl-1,3-dioxolan-2-one, bis(2-butoxyethyl)ether, dimethyl glutarate, ethylene glycol di-n-butyrate, 1,3-butylene glycol diacetate, diethylene glycol monobutyl ether acetate, tetraethylene glycol dimethyl ether, 1,6-diacetoxyhexane, tripropylene glycol monomethyl ether, butoxypropanol, diethylene glycol methylethyl ether, diethylene glycol methyl butyl ether, triethylene glycol methylethyl ether, triethylene glycol methyl butyl ether, dipropylene glycol monomethyl ether acetate, diethylene glycol dimethyl ether, ethyl 3-ethoxy propionate, diethylene glycol ethyl methyl ether, 3-methoxybutyl acetate, diethylene glycol diethyl ether, ethyl octanoate, ethylene glycol monobutyl ether acetate, ethylene glycol monobutyl ether, cyclohexyl acetate, diethyl succinate, ethylene glycol diacetate, propylene glycol diacetate, 4-hydroxy-4-methyl-2-pentanone, dimethyl succinate, 1-butoxy-2-propanol, diethylene glycol monoethyl ether, diethylene glycol monomethyl ether, dipropylene glycol monomethyl ether, 3-methoxy-n-butyl acetate, diacetin, dipropylene glycol mono n-propyl ether, polyethylene glycol monomethyl ether, butyl glycolate, ethylene glycol monohexyl ether, dipropylene glycol mono n-butyl ether, N-methyl-2-pyrrolidone, triethylene glycol butyl methyl ether, bis(2-propoxyethyl)ether, diethylene glycol diacetate, diethylene glycol butyl methyl ether, diethylene glycol butyl ethyl ether, diethylene glycol butyl propyl ether, diethylene glycol ethyl propyl ether, diethylene glycol methyl propyl ether, diethylene glycol propyl ether acetate, triethylene glycol methyl ether acetate, triethylene glycol ethyl ether acetate, triethylene glycol propyl ether acetate, triethylene glycol butyl ether acetate, triethylene glycol butyl ethyl ether, triethylene glycol ethyl methyl ether, triethylene glycol ethyl propyl ether, triethylene glycol methyl propyl ether, dipropylene glycol methyl ether acetate, n-nonyl alcohol, diethylene glycol monobutyl ether, triethylene glycol monomethyl ether, ethylene glycol 2-ethylhexyl ether, triethylene glycol monoethyl ether, diethylene glycol monohexyl ether, triethylene glycol monobutyl ether, diethylene glycol mono-2-ethylhexyl ether, tripropylene glycol mono n-butyl ether, and butyl cellosolve acetate. One compound or a combination of two or more compounds selected from the above examples can be used. It is preferable for the solvent to contain one or more selected from the group consisting of 1, 3-butylene glycol diacetate, bis(2-butoxyethyl) ether, and diethylene glycol monobutyl ether acetate. When such a solvent is used, the secondary pigment has an appropriate degree of affinity for the solvent and a structure in which the secondary pigment covers the surfaces of the main pigment particles can obtained more readily. As a result, the pigment particles can achieve a superior long-term stability in the color filter ink. Even if the content of pigment in the color filter ink is high, a sufficient long-term dispersion stability of the pigment can be obtained. Additionally, the color filter ink can be endowed with superior discharge stability of droplets; unevenness of color, saturation, and the like in regions of the manufactured color filter can be more effectively suppressed; and color filters manufactured with the color filter ink can be endowed with superior uniformity of characteristics between individual units. When the solvent (which functions as a dispersion medium in the color filter ink) is such a compound as described above, the chemical structural relationships among the compound, the previously described pigments, and a curable resin material that will be described later are such that the solubility of the curable resin material is excellent and a disproportionate amount of the curable resin material is distributed onto the surfaces of the pigment particles in the color filter ink. As a result, a color filter ink having excellent droplet discharge stability, excellent dispersion stability of the pigment particles in the color filter ink, and excellent long-term storage characteristics can be obtained. Additionally, since the curable resin material is distributed disproportionately to the pigment particles and the dispersion stability of the pigment particles is excellent, the viscosity of the color filter ink can be reduced and the dispersion strength increased such that a display image having improved contrast can be obtained. Also, when the solvent (which functions as a dispersion medium in the color filter ink) is such a compound as described above, the color filter ink can be made to reliably spread into the entire cell in a color filter manufacturing method such as will be described later, and a flattened colored portion can easily be formed without strictly prescribing the conditions for removing the solvent. In other words, the internal shape of the pixels is easily controlled during baking.

The boiling point of the solvent at atmospheric pressure (1 atm) is preferably 160 to 300° C., more preferably 180 to 290° C., and even more preferably 200 to 280° C. When the boiling point of the solvent at atmospheric pressure is within this range, clogging of a droplet discharge head (used to discharge droplets of the color filter ink) with the color filter ink can be prevented effectively and color filters can be manufactured with excellent productivity.

It is preferable for the vapor pressure of the solvent at a temperature of 25° C. to be 0.7 mm Hg or lower and still more preferable for the same to be 0.1 mm Hg or lower. When the vapor pressure of the liquid medium is within this range, clogging of a droplet discharge head (used to discharge droplets of the color filter ink) with the color filter ink can be prevented effectively and color filters can be manufactured with excellent productivity.

It is preferable for the content of solvent in the color filter ink to be from 50 to 98 wt %, more preferable for the same to be from 70 to 95 wt %, and still more preferable for the same to be from 80 to 93%. When the content of solvent is within any of these ranges, the discharge properties of the color filter ink from the droplet discharge head are particularly excellent and a color filter manufactured with the color filter ink can be endowed with excellent durability. Adequate color saturation can also be ensured in a manufactured color filter.

### Curable Resin Material

A color filter ink generally contains a resin material (binder resin) for such purposes as enhancing the adhesion of a colored portion formed using the ink with respect to the substrate. The resin material needs to be resistant to solvents in order to prevent adverse effects from occurring due to the application of chemicals and/or washing in steps subsequent to the ink application step in an inkjet method. With a conventional color filter ink, however, it is difficult to endow the color filter (colored portion) with adequate durability. With a conventional color filter ink, when droplets are discharged for long periods of time or droplets are discharged continuously by the inkjet method, the trajectory of the discharged droplets changes (so-called flight deflection occurs) and it becomes impossible to land the droplets in the desired region. Moreover, the droplet discharge quantity becomes unstable, and other problems occur. When such problems occur, the different inks used to form colored portions of different colors on the substrate or the like onto which the droplets are to be discharged become mixed together (i.e., the colors mix) and the color saturation varies among colored portions that were supposed to have the same color saturation. As a result, uneven color and uneven saturation occur between regions of the same color filter, variation of characteristics (particularly contrast ratio, color reproduction range, and other color characteristics) occurs among numerous color filters, and the reliability of the color filters is reduced. Such problems are particularly severe when droplets are discharged on a large substrate (e.g., G5 or larger) to form colored portions, and these problems cause severe reduction of the productivity (process yield) with which color filters can be manufactured. The present inventor has observed that such problems are severe when halogenated phthalocyanine zinc complex is used as a pigment in a color filter ink.

The inventors conducted a concentrated investigation aimed at overcoming such problems as those described above. As a result, the inventors discovered that the problems described above can be overcome by including in the color filter ink such a curable resin material (binder resin) as the one described in detail later.

The curable resin material (curable resin composition) of a color filter ink in accordance with the present invention will now be described in detail.

The curable resin material used in a color filter ink according to the present invention includes a polymer A (first polymer) containing at least an epoxy-containing vinyl monomer al as a monomer component, and a polymer B (second polymer) containing at least a fluoroalkyl- or fluoroaryl-containing vinyl monomer as a monomer component.

### Polymer A

The polymer A contains at least the epoxy-containing vinyl monomer al as a monomer component. The polymer A may be composed of essentially a single compound, or may be a mixture of a plurality of types of compounds. However, when the polymer A is a mixture of a plurality of types of compounds, each of the compounds contains at least the epoxy-containing vinyl monomer al as a monomer component.

### Epoxy-Containing Vinyl Monomer a1

The polymer A contains at least the epoxy-containing vinyl monomer a1 as a monomer component. By using the epoxy-containing vinyl monomer a1 as a monomer component, an epoxy group can be introduced easily and reliably into the polymer A. Additionally, by including the epoxy-containing vinyl monomer a1 as a monomer component, a color filter ink having excellent dispersion stability of the pigment particles in the color filter ink, excellent long-term storage characteristics, and excellent droplet discharge stability can be obtained. Including the epoxy-containing vinyl monomer a1 as a monomer component also enables a colored portion formed using the color filter ink to have excellent solvent resistance. Including the epoxy-containing vinyl monomer a1 as a monomer component is also useful because the curable resin material (binder resin) can be cured under relatively mild conditions when a colored portion is formed using the color filter ink, and the formed colored portion is endowed with excellent hardness and other characteristics. When the polymer A includes a vinyl monomer a2, a vinyl monomer a3, and other components described later, the polymer can be suitably synthesized, and a polymer A having the desired characteristics can be obtained easily and reliably.

The epoxy-containing vinyl monomer a1 used can have the structure indicated by Formula (5) below, for example. By providing the epoxy-containing vinyl monomer al with such a structure, a color filter ink having particularly excellent dispersion stability of the pigment particles in the color filter ink, particularly excellent long-term storage characteristics, and particularly excellent droplet discharge stability can be obtained. When the epoxy-containing vinyl monomer a1 has the structure indicated by Formula (5) below, a colored portion formed using the color filter ink can be endowed with even better solvent resistance. Additionally, when the epoxy-containing vinyl monomer a1 has the structure indicated by Formula (5) below, the curable resin material (binder resin) can be cured under relatively mild conditions when a colored portion is formed using the color filter ink, and the formed colored portion is endowed with excellent hardness and other characteristics. When the epoxy-containing vinyl monomer a1 has such a structure, the polymer A can be endowed with particularly excellent compatibility with the polymer B described later, and a colored portion formed using the color filter ink can be endowed with particularly high transparency.

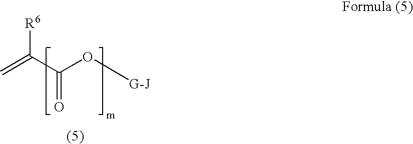

In Formula (5), R⁶ is a hydrogen atom or a C₁₋₇ alkyl group; G is a single bond hydrocarbon group or a bivalent hydrocarbon group optionally including a hetero atom; J is an epoxy group or an alicyclic epoxy group optionally having a substitute group with 3 to 10 carbons in a cyclic structure; and m is 0 or 1.

In Formula (5), examples of the C₁₋₇ alkyl group indicated by R⁶ include methyl, ethyl, propyl, isopropyl, butyl, isobutyl, s-butyl, pentyl, hexyl, heptyl, and other alkyl groups, but a hydrogen atom or a C₁₋₂ alkyl group is preferred, and a hydrogen atom or a methyl group is more preferred. With such a structure for the epoxy-containing vinyl monomer a1, a color filter ink having particularly excellent dispersion stability of the pigment particles in the color filter ink, particularly excellent long-term storage characteristics, and particularly excellent droplet discharge stability can be obtained. Additionally, a displayed image having particularly excellent contrast can be obtained using a color filter manufactured with the color filter ink. Moreover, a colored portion formed using the color filter ink can be endowed with excellent hardness and other characteristics. The polymer A can be endowed with particularly excellent compatibility with the polymer B described later, and a colored portion formed using the color filter ink can be endowed with extremely high transparency.

Typical examples of the bivalent hydrocarbon group indicated by G in Formula (5) (which may contain a hetero atom) include straight-chain or branched alkylene groups, i.e., more specifically, methylenes, ethylenes, propylenes, tetramethylenes, ethyl ethylenes, pentamethylenes, hexamethylenes, oxymethylenes, oxyethylenes, oxypropylenes, and the like.

Specific examples of the epoxy-containing vinyl monomer a1 include glycidyl (meth)acrylate, methylglycidyl (meth)acrylate, ethylglycidyl (meth)acrylate, glycidyl vinylbenzyl ether (product name: VBGE; manufactured by Seimi Chemical), the alicyclic epoxy-containing unsaturated compounds indicated by Formulas (5-1) through (2-31) below, and the like. One of these compounds or a combination of two or more of these compounds may be selected and used, but (3,4-epoxycyclohexyl)methyl (meth)acrylate is particularly preferred as the epoxy-containing vinyl monomer a1. With such a structure for the epoxy-containing vinyl monomer a1, a color filter ink having particularly excellent dispersion stability of the pigment particles in the color filter ink, particularly excellent long-term storage characteristics, and particularly excellent droplet discharge stability can be obtained. A colored portion formed using the color filter ink can also be endowed with particularly excellent hardness, solvent resistance, and other characteristics. Additionally, the polymer A can be endowed with particularly excellent compatibility with the polymer B described later, and a colored portion formed using the color filter ink can be endowed with extremely high transparency.

Formulas (5-1) through (5-31)

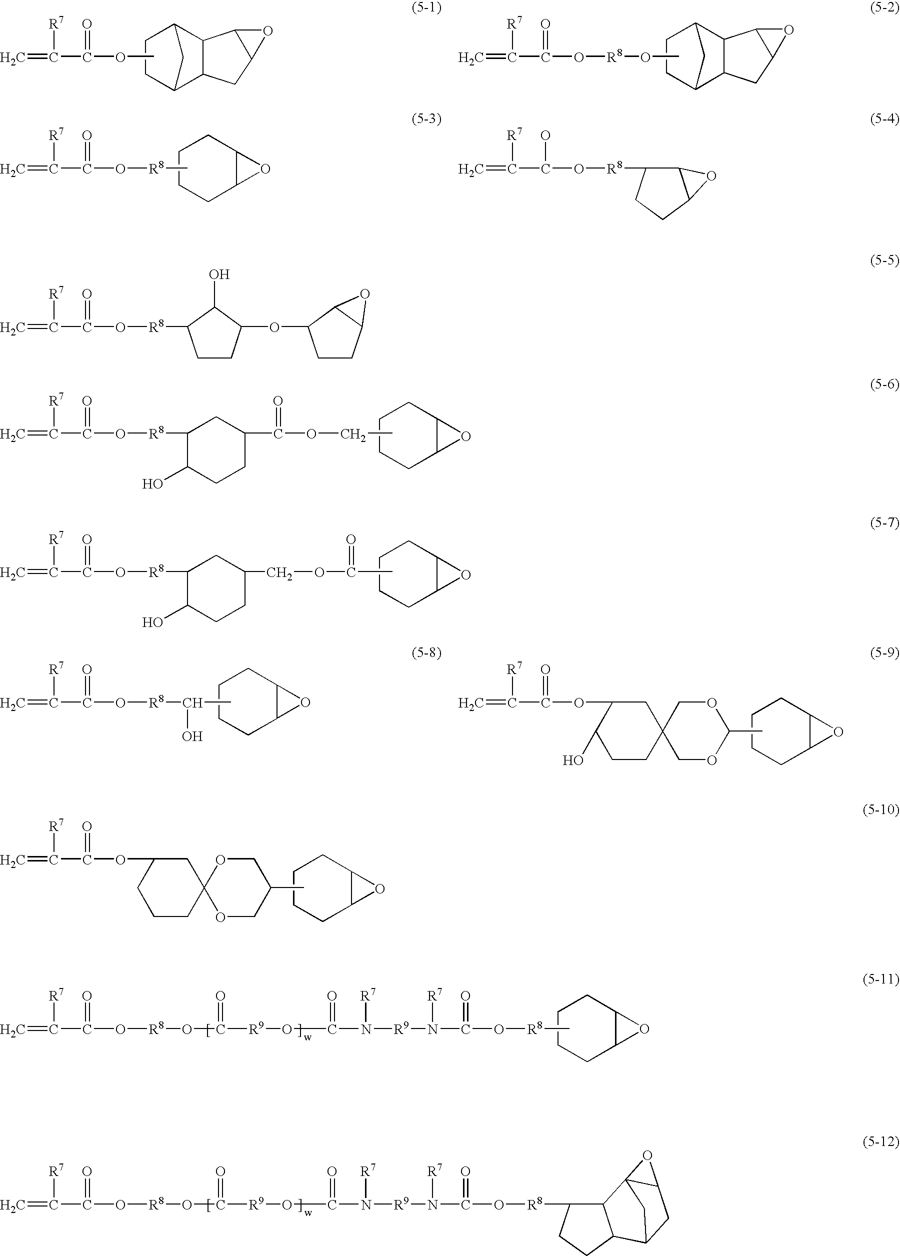

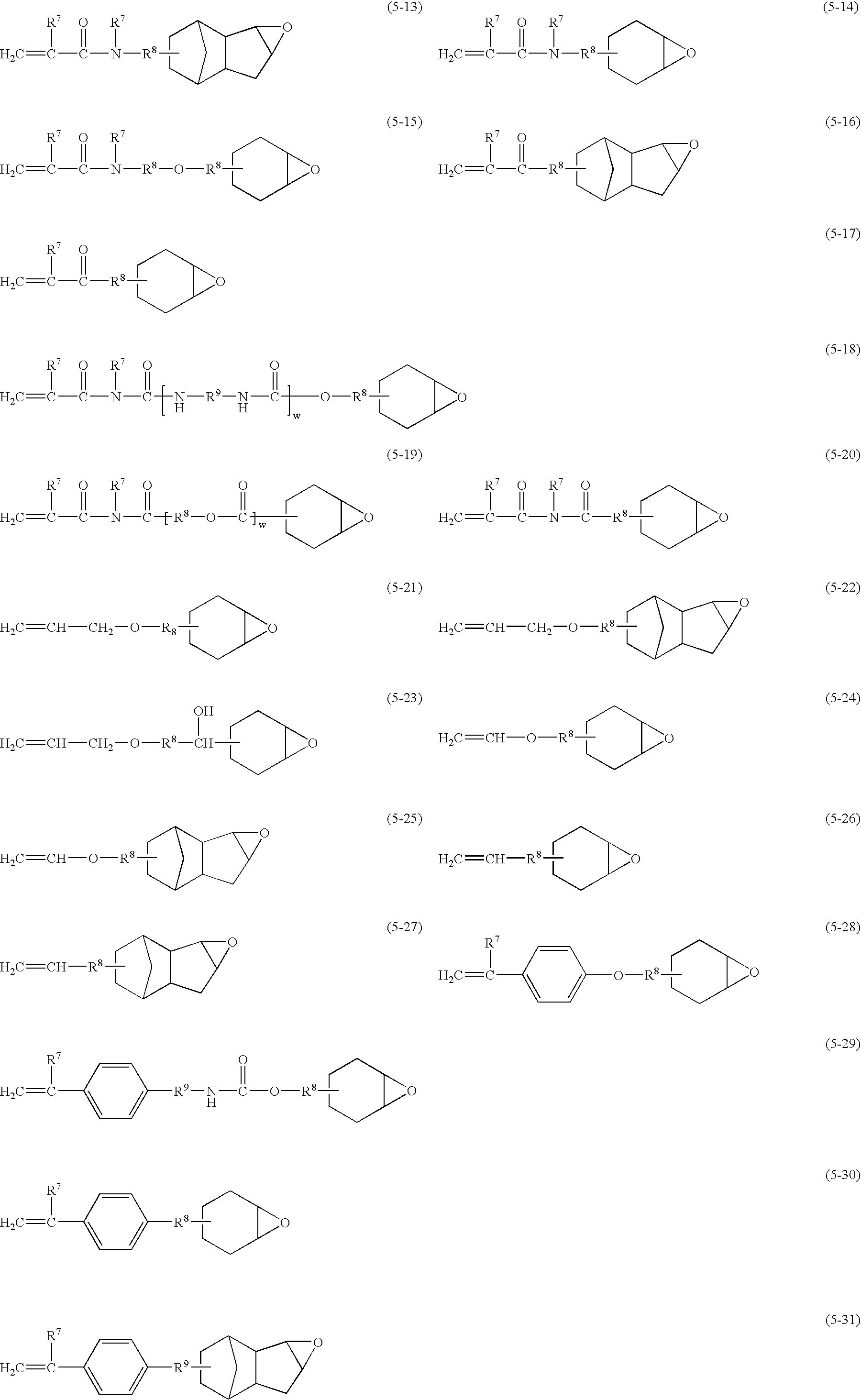

In Formulas (5-1) through (5-31), R⁷ is a hydrogen atom or a methyl group; R⁸ is a C₁₋₈ bivalent hydrocarbon group; and R⁹ is a C₁₋₂₀ bivalent hydrocarbon group. R⁷, R⁸, and R⁹ may be the same or different, and w is 0 to 10. The content ratio (which is a value calculated based on the weight of the monomer used to synthesize the polymer) of the epoxy-containing vinyl monomer a1 in the polymer C is preferably 50 to 99 wt %, and more preferably 70 to 94 wt %. When the content of the epoxy-containing vinyl monomer a1 in the polymer A is within one of these ranges, a color filter ink having excellent dispersion stability of the pigment particles in the color filter ink, excellent long-term storage characteristics, and excellent droplet discharge stability can be obtained. When the content ratio of the epoxy-containing vinyl monomer a1 in the polymer A is within the aforementioned range, the resin material (binder resin) can be cured under relatively mild conditions when a colored portion is formed using the color filter ink, and a colored portion formed using the color filter ink can be endowed with particularly excellent hardness, solvent resistance, and other characteristics. When the polymer A is a mixture of a plurality different compounds, a weighted average value (weighted average value based on weight ratio) of the compounds can be used as the value of the content ratio of the epoxy-containing vinyl monomer a1. Also, when the polymer A is a mixture of a plurality of different compounds, the compounds all preferably contain the epoxy-containing vinyl monomer a1 in such a content ratio as described above.

### Vinyl Monomer a2

Although the polymer A contains at least the epoxy-containing vinyl monomer al as a monomer component, the polymer A is preferably a polymer (copolymer) containing the epoxy-containing vinyl monomer a1 and, additionally, a vinyl monomer a2 as a monomer component provided with an isocyanate group or a block isocyanate group in which an isocyanate group is protected by a protective group. The content of gas (dissolved gas, bubbles present as microbubbles, or the like) in the color filter ink can thereby be reduced more effectively, and particularly excellent droplet discharge stability can be obtained with the inkjet method. As a result, it is possible to more effectively prevent the occurrence of uneven color, uneven saturation, and the like between different regions of a color filter manufactured using the color filter ink and to prevent variation of characteristics between individual units.

Examples of polymerizable vinyl monomers a2 include 2-acryloyloxyethyl isocyanate (product name: Karenz MOI; manufactured by Showa Denko), 2-methacryloyloxyethyl isocyanate, and other (meth)acryloyl isocyanates and the like in which (meth)acryloyl is bonded with an isocyanate group via a C₂₋₆ alkylene group.

The isocyanate group of the abovementioned (meth)acryloyl isocyanate is preferably a block isocyanate group. The term “block isocyanate group” refers to an isocyanate group in which the terminal end is masked by a blocking agent. Examples of monomers having a block isocyanate group include ethyl 2-(0-[1′-methylpropylideneamino]carboxyamino) ethyl methacrylate and the like, and are commercially available under the trade name Karenz MOI-BM, manufactured by Showa Denko. Either one or a combination of two of these polymerizable vinyl monomers may be used.

The content ratio (which is a value obtained by substitution with the weight of the monomer used to synthesize the polymer) of the vinyl monomer a2 in the polymer A is preferably 2 to 20 parts by weight—more preferably 3 to 15 parts by weight—for every 100 parts by weight of the epoxy-containing vinyl monomer a1. When the content ratio of the vinyl monomer a2 in the polymer A is within the aforementioned range, the content of gas (dissolved gas, bubbles present as microbubbles, or the like) in the color filter ink can be reduced more effectively and a color filter ink having sufficient long-term storage properties and particularly excellent droplet discharge stability in the inkjet method can be obtained. A colored portion formed using the color filter ink can also be endowed with adequately high transparency. Conversely, when the content ratio of the vinyl monomer a2 in the polymer A is less than the lower limit of the aforementioned range, the aforementioned effects of including a vinyl monomer a2 may not be adequately demonstrated. Meanwhile, when the content ratio of the vinyl monomer a2 in the polymer A exceeds the upper limit of the aforementioned range, the compatibility of the polymer A with the polymer B described later decreases and it may be difficult to endow a colored portion formed using the color filter ink with adequate transparency. When the polymer A is a mixture of a plurality of different compounds, a weighted average value (weighted average value based on weight ratio) of the compounds can be used as the value of the content ratio of the vinyl monomer a2. Also, when the polymer A is a mixture of a plurality of different compounds, the compounds all preferably contain the vinyl monomer a2 in such a content ratio as described above.

### Vinyl Monomer a3

Although the polymer A may contains at least the epoxy-containing vinyl monomer a1 as a monomer component, the polymer A is preferably a polymer (a copolymer) containing the epoxy-containing vinyl monomer a1 and, additionally, a vinyl monomer a3 provided with a hydroxyl group. When a vinyl monomer a3 is included, a colored portion formed using the color filter ink can be endowed with particularly excellent adhesion to the substrate, particularly when repeatedly exposed to the sudden temperature changes that accompany image display. As a result, for example, the occurrence of light leakage (white spots, bright points) and other problems can be reliably prevented even when the color filter is used for a long time. Specifically, the color filter can be endowed with particularly excellent durability. When the polymer A contains the vinyl monomer a3 as a monomer component, the polymer A can be endowed with particularly excellent compatibility with the polymer B described hereinafter, and a colored portion formed using the color filter ink can be endowed with extremely high transparency.

Examples of the vinyl monomer a3 include monoester compounds of a acrylic acid or methacrylic acid with 2-hydroxyethyl (meth)acrylate, hydroxypropyl (meth)acrylate, 2,3-dihydroxybutyl (meth)acrylate, 4-hydroxybutyl (meth)acrylate, 6-hydroxyhexyl (meth)acrylate, 8-hydroxyoctyl (meth)acrylate, 4-hydroxymethyl cyclohexyl (meth)acrylate, polyalkylene glycol mono(meth)acrylate, and other polyvalent alcohols; compounds in which ε-caprolactone is ring-open polymerized with the abovementioned monoester compounds of a polyvalent alcohol and acrylic acid or methacrylic acid (PLACCEL FA series, PLACCEL FM series, and the like manufactured by Daicel Chemical Industries); compounds in which ethylene oxide and propylene oxide is ring-open polymerized; and the like. One compound or a combination of two compounds selected from the above examples can be used.

The content ratio (which is a value obtained by substitution with the weight of the monomer used to synthesize the polymer) of the vinyl monomer a2 in the polymer A is preferably 3 to 20 parts by weight—more preferably 3 to 15 parts by weight—for every 100 parts by weight of the epoxy-containing vinyl monomer a1. When the content ratio of the vinyl monomer a3 in the polymer A is within the aforementioned range, the color filter ink is endowed with adequate long-term storage properties and other characteristics and a color filter having particularly excellent durability can be manufactured using the color filter ink. Additionally, a colored portion formed using the color filter ink can be endowed with high transparency. Conversely, when the content ratio of the vinyl monomer a3 in the polymer A is less than the lower limit of the aforementioned range, the aforementioned effects of including a vinyl monomer a3 may not be adequately demonstrated. Meanwhile, when the content ratio of the vinyl monomer a3 in the polymer A exceeds the upper limit of the aforementioned range, it may be difficult to make the content ratio of gas in the color filter ink adequately low. When the polymer A is a mixture of a plurality of different compounds, a weighted average value (weighted average value based on weight ratio) of the compounds can be used as the value of the content ratio of the vinyl monomer a3. Also, when the polymer A is a mixture of a plurality of different compounds, the compounds all preferably contain the vinyl monomer a3 in such a content ratio as described above.

### Other Polymerizable Vinyl Monomer a4

It is acceptable for the polymer A to contain as a monomer component a polymerizable vinyl monomer a4 other than the epoxy-containing vinyl monomer a1, the vinyl monomer a2, and the vinyl monomer a3 described above. A vinyl monomer that can be copolymerized with the epoxy-containing vinyl monomer a1 can be used as the polymerizable vinyl monomer a4. Specific examples thereof include methyl (meth)acrylate, ethyl (meth)acrylate, butyl (meth)acrylate, 2-ethylhexyl (meth)acrylate, phenyl (meth)acrylate, cyclohexyl (meth)acrylate, dicyclopentanyl (meth)acrylate, dicyclopentanyloxyethyl (meth)acrylate, isobornyl (meth)acrylate, benzyl (meth)acrylate, phenylethyl (meth)acrylate, and other C₁₋₁₂ alkyl and aralkyl (meth)acrylates; styrene, α-methylstyrene, and other vinyl aromatic compounds. One compound or a combination of two compounds selected from the above examples can be used. However, the polymer A does not contain as a monomer component a fluoroalkyl-containing or fluoroaryl-containing vinyl monomer b1 such as will be described later. The polymer A also preferably does not contain an alkoxysilyl-containing vinyl monomer such as described above as a monomer component.

The content ratio (which is a value obtained by substitution with the weight of the monomer used to synthesize the polymer) of the polymerizable vinyl monomer a4 in the polymer A is preferably 15 parts by weight or less, and more preferably 7 parts by weight or less, with respect to 100 parts by weight of the epoxy-containing vinyl monomer a1. When the polymer A is a mixture of a plurality of different compounds, a weighted average value (weighted average value based on weight ratio) of the compounds may be used as the content ratio of the polymerizable vinyl monomer a4. Also, when the polymer A is a mixture of a plurality of different compounds, the content ratio of the polymerizable vinyl monomer a4 with respect to each of the compounds preferably satisfies such conditions as those described above.

As described above, the polymer A contains at least the epoxy-containing vinyl monomer a1 as a monomer component and does not contain the fluoroalkyl-containing or fluoroaryl-containing vinyl monomer b1 described later as a monomer component. Meanwhile, the polymer A preferably contains the vinyl monomer a2 and the vinyl monomer a3 in addition to the epoxy-containing vinyl monomer a1. In this way, the effects of including a vinyl monomer a2 as described above and the effects of including a vinyl monomer a3 as described above can be obtained at the same time.

Although there are no particular limitations on the content (content ratio) of the polymer A in the curable resin material (binder resin), the content of the polymer A is preferably 25 to 80 wt % or, more preferably, 33 to 70 wt %. When the polymer A is a mixture of a plurality of different compounds, the sum of the content ratios of the mixed compounds is used as the content ratio of the polymer A.

### Polymer B

In a color filter ink according to the present invention, the curable resin material (binder resin) includes a polymer A such as described above and a polymer B that contains at least the fluoroalkyl-containing or fluoroaryl-containing vinyl monomer b1 indicated by Formula (1) below as a monomer component.

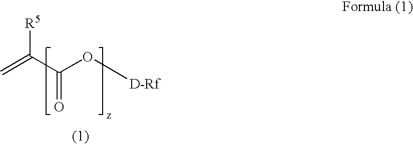

In Formula (1), R⁵ is a hydrogen atom or a C₁₋₇ alkyl group; D is a single bond hydrocarbon group or a bivalent hydrocarbon group optionally including a hetero atom; Rf is a C₁₋₂₀ fluoroalkyl group or fluoroaryl group; and z is 0 or 1.

In a conventional color filter ink, a relatively large amount of gas tends to become incorporated into the ink during preparation of the ink, and the gas content is difficult to reduce even if a de-aeration treatment or the like is performed. Even if the gas content in the conventional color filter ink is initially reduced to a relatively low level by de-aeration or the like, gas from the atmosphere is incorporated over the course of prolonged storage and during the course of repeatedly discharging and depleting the ink during droplet discharge of the ink from the discharge holes. Consequently, there is a strong tendency for the content ratio of gas (dissolved gas, bubbles present as microbubbles, or the like) in the color filter ink to increase. When the gas content ratio in the color filter ink increases in this manner, the discharge of droplets by the inkjet method becomes unstable and such problems as unevenness of color and saturation between regions and variation of characteristics between individual units occur more easily. Furthermore, the present inventor has observed that these problems become more prominent when a halogenated phthalocyanine zinc complex is used as a pigment.

In a color filter ink according to the present invention, however, since the curable resin material (binder resin) contains the polymer A as well as the polymer B, the content ratio of gas in the color filter ink can be reduced and the color filter ink can be endowed with excellent discharge stability. Furthermore, unevenness of color and saturation between different regions of a color filter manufactured using the color filter ink can be suppressed and color filters manufactured using the color filter ink can be endowed with excellent uniformity of characteristics between individual units. By including both the polymer A and the polymer B in the curable resin material (binder resin), a color filter manufactured using the color filter ink can be endowed with excellent durability. Furthermore, in the present invention, by including both the polymer A and the polymer B in the curable resin material (binder resin), excellent mixing stability of the resin material with the pigment can be obtained over a long period of time and color filters having excellent contrast can be manufactured stably over a long period of time. Since the color filter ink, once prepared, can be suitably used for a long time, the frequency of replacing the color filter ink and replacing the color filter ink in the droplet discharge device can be reduced. Color filters can therefore be manufactured with particularly excellent productivity, and the consistency of quality of the manufactured color filters is enhanced. Such excellent effects (synergistic effects) are not obtained with only one of the polymers A and B (i.e., only polymer A or polymer B) is used.

The polymer B may be composed of essentially a single compound or a mixture of a plurality of different compounds. However, when the polymer B is a mixture of a plurality of compounds, each of the compounds contains at least the fluoroalkyl-containing or fluoroaryl-containing vinyl monomer b1 as a monomer component.

### Fluoroalkyl-Containing or Fluoroaryl-Containing Vinyl Monomer b1

The polymer B contains at least the fluoroalkyl-containing or fluoroaryl-containing vinyl monomer b1 indicated by Formula (1) as a monomer component. By including a fluoroalkyl-containing or fluoroaryl-containing vinyl monomer b1 as a monomer component, a fluoroalkyl group or a fluoroaryl group can be easily and reliably introduced into the polymer B. Also, by including a fluoroalkyl-containing or fluoroaryl-containing vinyl monomer b1 as a monomer component, undesirable adhesion of ink droplets to a nozzle of the droplet discharge device and adhesion (bonding) to the nozzle of solid components of the color filter ink can be reliably prevented, and excellent droplet discharge stability can be maintained over a long period of time. By including the fluoroalkyl-containing or fluoroaryl-containing vinyl monomer b1 as a monomer component, a colored portion formed with the color filter ink can be endowed with adequately excellent hardness, adhesion to the substrate, light fastness, thermal resistance, and other characteristics. Furthermore, by including in the polymer B a vinyl monomer b2 as will be described later, the polymer B can be synthesized in a favorable manner and a polymer B having the desired characteristics can be obtained easily and reliably.

In Formula (1), examples of the C₁₋₇ alkyl group indicated by R⁵ include methyl, ethyl, propyl, isopropyl, butyl, isobutyl, s-butyl, pentyl, hexyl, heptyl, and other alkyl groups, but a hydrogen atom or a C₁₋₂ alkyl group is preferred, and a hydrogen atom or a methyl group is more preferred. The dispersion stability of the pigment in the color filter ink and the droplet discharge stability of the color filter ink can thereby be made to be particularly excellent, and a colored portion having particularly excellent light fastness can be formed.

Typical examples of the bivalent hydrocarbon group (hydrocarbon group optionally including a hetero atom) indicated by D in Formula (1) include straight-chain or branched alkylene groups, or more specifically, methylenes, ethylenes, propylenes, tetramethylenes, ethyl ethylenes, pentamethylenes, hexamethylenes, oxymethylenes, oxyethylenes, oxypropylenes, and the like.

Specific examples of monomers indicated by Formula (1) include CF₃(CF₂)₃CH₂CH═CH₂, CF₃(CF₂)₃CH═CH₂, CF₃(CF₂)₅CH₂CH═CH₂, CF₃(CF₂)₅CH═C₂, CF₃(CF₂)₇CH═CH₂, CF₃(CF₂)₉CH₂CH═CH₂, CF₃(CF₂)₉CH═CH₂, (CF₃)₂CF(CF₂)₂CH₂CH═CH₂, (CF₃)₂CF(CF₂)₂CH═CH₂, (CF₃)₂CF(CF₂)₄CH₂CH═CH₂, (CF₃)₂CF(CF₂)₄CH═CH₂, (CF₃)₂CF(CF₂)₆CH₂CH═CH₂, (CF₃)₂CF(CF₂)₆CH═CH₂, F₅C₆CH═CH₂, CF₃(CF₂)₅CH₂CH₂OCH₂CH═CH₂, CF₃(CF₂)₅C₂CH₂CH₂OCH₂CH═CH₂, CF₃(CF₂)₇CH₂CH₂OCH₂CH═CH₂, CF₃(CF₂)₇CH₂CH₂CH₂OCH₂CH═CH₂, CF₃(CF₂)₉CH₂CH₂OCH₂CH═CH₂, CF₃(CF₂)₉CH₂CH₂CH₂OCH₂CH═CH₂, H(CF₂)₆CH₂OCH₂CH═CH₂, H(CF₂)₈CH₂OCH₂CH═CH₂, (CF₃)₂CF(CF₂)₂CH₂CH₂OCOCH═CH₂, (CF₃)₂CF(CF₂)₂CH₂CH₂OCOC(CH₂)═CH₂, (CF₃)₂CF(CF₂)₄CH₂CH₂OCOCH═CH₂, (CF₃)₂CF(CF₂)₄CH₂CH₂OCOC(CH₃)═CH₂, (CF₃)₂CF(CF₂)₆CH₂CH₂OCOCH═CH₂, (CF₃)₂CF(CF₂)₆CH₂CH₂OCOC(CH₃)═CH₂, CF₃(CF₂)₅CH₂CH₂OCOCH═CH₂, CF₃(CF₂)₅CH₂CH₂OCOC(CH₃)═CH₂, CF₃(CF₂)₇CH₂CH₂OCOCH═CH₂, CF₃(CF₂)₇CH₂CH₂OCOC(CH₃)═CH₂, CF₃(CF₂)₉CH₂CH₂OCOCH═CH₂, CF₃(CF₂)₉CH₂CH₂OCOC(CH₃)═CH₂, H(CF₂)₆CH₂CH₂OCOCH═CH₂, H(CF₂)₈CH₂CH₂OCOC(CH₃)═CH₂, F(CF₂)₈CH₂CH₂OCOCH═CH₂, F(CF₂)₈CH₂CH₂OCOC(CH₃)═CH₂, H(CF₂)₄CH₂OCOC(CH₃)═CH₂, and H(CF₂)₄CH₂OCOCH═CH₂. One compound or a combination of two or more compounds selected from the above examples can be used.

The content ratio (which is a value obtained by substitution with the weight of the monomer used to synthesize the polymer) of the fluoroalkyl-containing or fluoroaryl-containing vinyl monomer b1 in the polymer B is preferably 10 to 60 wt %, and more preferably 15 to 50 wt %. When the content ratio of the fluoroalkyl-containing or fluoroaryl-containing vinyl monomer b1 in the polymer B is within the aforementioned range, the dispersion stability of the pigment in the color filter ink, the discharge stability of the color filter ink, and the thermal resistance of a colored portion formed using the color filter ink can be made to be particularly excellent. The compatibility of the polymer B with respect to the polymer A can also be made particularly excellent, and a colored portion formed using the color filter ink can be endowed with particularly high transparency. In contrast, when the content ratio of the fluoroalkyl-containing or fluoroaryl-containing vinyl monomer b1 in the polymer B is less than the aforementioned lower limit, the effects of including the fluoroalkyl-containing or fluoroaryl-containing vinyl monomer b1 such as described above may not be adequately demonstrated. When the content ratio of the fluoroalkyl-containing or fluoroaryl-containing vinyl monomer b1 in the polymer B exceeds the aforementioned upper limit, it may be difficult to endow a colored portion formed using the color filter ink with adequately excellent transparency. When the polymer B is a mixture of a plurality of different compounds, a weighted average value (weighted average value based on weight ratio) of the compounds may be used as the content ratio of the fluoroalkyl-containing or fluoroaryl-containing vinyl monomer b1. Also, when the polymer B is a mixture of a plurality of different compounds, the compounds all preferably contain the fluoroalkyl-containing or fluoroaryl-containing vinyl monomer b1 in such a content ratio as described above.

### Other Polymerizable Vinyl Monomer b2

The polymer B may contain as a monomer component a polymerizable vinyl monomer b2 other than the fluoroalkyl-containing or fluoroaryl-containing vinyl monomer b1 described above. A vinyl monomer that can be copolymerized with the fluoroalkyl-containing or fluoroaryl-containing vinyl monomer b1 can be used as the polymerizable vinyl monomer b2. Specific examples thereof include: glycidyl (meth)acrylate, methylglycidyl (meth)acrylate, ethylglycidyl (meth)acrylate, glycidyl vinylbenzyl ether (product name: VBGE; manufactured by Seimi Chemical), and epoxy-containing vinyl monomers indicated by Formula (2) above such as the alicyclic epoxy-containing unsaturated compounds indicated by Formulas (2-1) through (2-31) above; 2-acryloyloxyethyl isocyanate (product name: Karenz MOI; manufactured by Showa Denko), 2-methacryloyloxyethyl isocyanate, and other (meth)acryloyl isocyanates and the like in which (meth)acryloyl is bonded with an isocyanate group via a C₂₋₆ alkylene group; ethyl 2-(0-[1′-methylpropylideneamino]carboxyamino) ethyl methacrylate (product name: Karenz MOI-BM; manufactured by Showa Denko) and other polymerizable vinyl monomers provided with an isocyanate group or a block isocyanate group in which an isocyanate group is protected by a protective group; 2-hydroxyethyl (meth)acrylate, hydroxypropyl (meth)acrylate, 2,3-dihydroxybutyl (meth)acrylate, 4-hydroxybutyl (meth)acrylate, 6-hydroxyhexyl (meth)acrylate, 8-hydroxyoctyl (meth)acrylate, 4-hydroxymethyl cyclohexyl (meth)acrylate, polyalkylene glycol mono(meth)acrylate, and other monoester compounds of a polyvalent alcohol and acrylic acid or methacrylic acid; compounds in which ε-caprolactone is ring-open polymerized with the abovementioned monoester compounds of a polyvalent alcohol and acrylic acid or methacrylic acid (PLACCEL FA series, PLACCEL FM series, and the like manufactured by Daicel Chemical Industries); compounds in which ethylene oxide and propylene oxide is ring-open polymerized, and other polymerizable vinyl monomers provided with a hydroxyl group; methyl (meth)acrylate, ethyl (meth)acrylate, butyl (meth)acrylate, 2-ethylhexyl (meth)acrylate, phenyl (meth)acrylate, cyclohexyl (meth)acrylate, dicyclopentanyl (meth)acrylate, dicyclopentanyloxyethyl (meth)acrylate, isobornyl (meth)acrylate, benzyl (meth)acrylate, phenylethyl (meth)acrylate, and other C₁₋₁₂ alkyl and aralkyl (meth)acrylates; styrene, α-methylstyrene, and other vinyl aromatic compounds; vinyltrimethoxysilane, vinyltriethoxysilane, vinylmethyldimethoxysilane, vinylmethyldiethoxysilane, γ-(meth)acryloyloxypropyltrimethoxysilane, γ-(meth)acryloyloxypropylmethyldimethoxysilane, γ-(meth)acryloyloxypropylmethyldiethoxysilane, γ-(meth)acryloyloxypropyltriethoxysilane, β-(meth)acryloyloxyethyltrimethoxysilane, γ-(meth)acryloyloxybutylphenyldimethoxysilane, and other alkoxysilyl-containing vinyl monomers. One compound or a combination of two or more compounds selected from the above examples can be used. Among these examples, including an epoxy-containing vinyl monomer as the polymerizable vinyl monomer b2 makes it possible to obtain particularly excellent compatibility between the polymer A and the polymer B and to endow a colored portion formed using the color filter ink with extremely excellent transparency. However, the polymer B preferably does not include an alkoxysilyl-containing vinyl monomer such as will be described later as a monomer component.

The content ratio (which is a value obtained by substitution with the weight of the monomer used to synthesize the polymer) of the polymerizable vinyl monomer b2 in the polymer B is preferably 40 to 90 wt %, and more preferably 50 to 85 wt %. When the polymer B is a mixture of a plurality of different compounds, the weighted average value (weighted average value based on weight ratio) of the compounds may be used as the content ratio of the polymerizable vinyl monomer b2. Also, when the polymer B is a mixture of a plurality of different compounds, the content ratio of the polymerizable vinyl monomer b2 with respect to each of the compounds preferably satisfies such conditions as those described above.

Although there are no particular limitations on the content (content ratio) of the polymer B in the curable resin material (binder resin), the content of the polymer B is preferably 20 to 60 wt % or, more preferably, 25 to 55 wt %. When the polymer B is a mixture of a plurality of different compounds, the sum of the content ratios of the compounds may be used as the content ratio of the polymer B.

The ratio of the polymer A content and the polymer B content in terms of weight is preferably 25:75 to 75:25, and more preferably 45:55 to 55:45. Satisfying such conditions enables the color filter ink to be endowed with particularly excellent discharge stability. Furthermore, unevenness of color and saturation between different regions of a color filter manufactured using the color filter ink can be more reliably prevented, and color filters manufactured using the color filter ink can be endowed with excellent uniformity of characteristics between individual units. The color filter(s) can also be endowed with particularly excellent durability.

### Polymer C

The curable resin material (binder resin) includes the polymer A and polymer B such as described above, but also may include a polymer C that contains as a monomer component an alkoxysilyl-containing vinyl monomer c1 indicated by Formula (6) below.

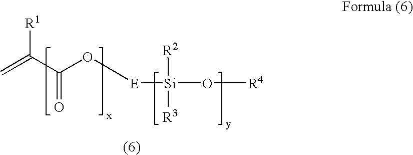

In Formula (6), R¹ is a hydrogen atom or a C₁₋₇ alkyl group; E is a single bond hydrocarbon group or a bivalent hydrocarbon group; R² is a C₁₋₆ alkyl group or a C₁₋₆ alkoxyl group; R³ is a C₁₋₆ alkyl group or a C₁₋₆ alkoxyl group; R⁴ is a C₁₋₆ alkyl group; x is 0 or 1; and y is an integer from 1 to 10.

By including such a polymer C, curing of the polymer A can be supplemented when the curable resin material (curable resin composition) is cured to form a colored portion, the colored portion can be formed under relatively mild conditions, and the formed colored portion can be endowed with particularly excellent hardness and adhesion to the substrate.

The polymer C may be composed of essentially a single compound, or may be a mixture of a plurality of different compounds. However, when the polymer C is a mixture of a plurality of compounds, each of the compounds contains at least the alkoxysilyl-containing vinyl monomer c1 as a monomer component.

### Alkoxysilyl-Containing Vinyl Monomer c1

The polymer C contains at least the alkoxysilyl-containing vinyl monomer c1 indicated by Formula (6) as a monomer component. By using such an alkoxysilyl-containing vinyl monomer c1 as a monomer component, an alkoxysilyl group can be introduced easily and reliably into the polymer C. Also, by including such an alkoxysilyl-containing vinyl monomer c1 as a monomer component, curing of the polymer A can be supplemented when the curable resin material (curable resin composition) is cured to form a colored portion, the colored portion can be formed under relatively mild conditions, and the formed colored portion can be endowed with particularly excellent hardness and adhesion to the substrate. When the polymer C includes a vinyl monomer c2 or the like such as will be described later, the polymer can be suitably synthesized and a polymer C having the desired characteristics can be easily and reliably obtained.

In Formula (6), examples of the C₁₋₇ alkyl group indicated by R¹ include methyl, ethyl, propyl, isopropyl, butyl, isobutyl, s-butyl, pentyl, hexyl, heptyl, and other alkyl groups, but a hydrogen atom or a C₁₋₂ alkyl group is preferred, and a hydrogen atom or a methyl group is more preferred. The color filter ink can thereby be endowed with particularly excellent discharge stability, and a colored portion formed with the color filter ink can be endowed with particularly excellent hardness, adhesion to the substrate, and other characteristics. The polymer C can also be endowed with particularly excellent compatibility with the polymer A, and a colored portion formed using the color filter ink can be endowed with particularly high transparency.

Typical examples of the bivalent hydrocarbon group indicated by E in Formula (6) include straight-chain or branched alkylene groups, or more specifically, methylenes, ethylenes, propylenes, tetramethylenes, ethyl ethylenes, pentamethylenes, hexamethylenes, and the like. Among these examples, a C₁₋₃ straight-chain alkylene group (e.g., methylene, ethylene, propylene) is particularly preferred.

Examples of the C₁₋₆ alkyl groups indicated by R², R³, and R⁴ in Formula (6) include straight-chain or branched alkyl groups, e.g., methyl, ethyl, propyl, isopropyl, butyl, isobutyl, s-butyl, pentyl, hexyl, and the like. Examples of the C₁₋₆ alkoxyl groups indicated by R² and R³ include straight-chain or branched alkoxyl groups, e.g., methoxy, ethoxy, propoxy, isopropoxy, butoxy, isobutoxy, s-butoxy, pentoxy, hexyloxy, and the like.

Specific examples of monomers indicated by Formula (6) include: vinyltrimethoxysilane, vinyltriethoxysilane, vinylmethyldimethoxysilane, vinylmethyldiethoxysilane, γ-(meth)acryloyloxypropyltrimethoxysilane, γ-(meth)acryloyloxypropylmethyldimethoxysilane, γ-(meth)acryloyloxypropylmethyldiethoxysilane, γ-(meth)acryloyloxypropyltriethoxysilane, β-(meth)acryloyloxyethyltrimethoxysilane, γ-(meth)acryloyloxybutylphenyldimethoxysilane, and other alkoxysilyl-containing polymerizable unsaturated compounds. One compound or a combination of two or more compounds selected from the above examples can be used.

The content ratio (which is a value obtained by substitution with the weight of the monomer used to synthesize the polymer) of the alkoxysilyl-containing vinyl monomer c1 in the polymer C is preferably 70 to 100 wt % or, more preferably, 80 to 100 wt %. When the content ratio of the alkoxysilyl-containing vinyl monomer c1 in the polymer C is within the aforementioned range, the color filter ink can be endowed with particularly excellent discharge stability and dispersion stability of the pigment in the color filter ink, curing of the polymer A can be supplemented when the curable resin material (curable resin composition) is cured to form a colored portion, and a colored portion can be formed under relatively mild conditions. A colored portion formed with the color filter ink can also be endowed with particularly excellent hardness, adhesion to a substrate, light fastness, thermal resistance, and other characteristics. When the polymer C is a mixture of a plurality of different compounds, the weighted average value (weighted average value based on weight ratio) of the compounds may be used as the content ratio of the alkoxysilyl-containing vinyl monomer c1. Also, when the polymer C is a mixture of a plurality of different compounds, the compounds all preferably contain the alkoxysilyl-containing vinyl monomer c1 in such a content ratio as described above.

### Other Polymerziable Vinyl Monomer c2

The polymer C contains at least the alkoxysilyl-containing vinyl monomer c1 as a monomer component, but it may also contain as a monomer component a polymerizable vinyl monomer c2 other than the alkoxysilyl-containing vinyl monomer c1 in addition to the alkoxysilyl-containing vinyl monomer c1. A vinyl monomer that can be copolymerized with the alkoxysilyl-containing vinyl monomer c1 can be used as the polymerizable vinyl monomer c2, and specific examples thereof include 2-hydroxyethyl (meth)acrylate, hydroxypropyl (meth)acrylate, 2,3-dihydroxybutyl (meth)acrylate, 4-hydroxybutyl (meth)acrylate, 6-hydroxyhexyl (meth)acrylate, 8-hydroxyoctyl (meth)acrylate, 4-hydroxymethyl cyclohexyl (meth)acrylate, polyalkylene glycol mono(meth)acrylate, and other monoester compounds of a polyvalent alcohol and acrylic acid or methacrylic acid; compounds in which ε-caprolactone is ring-open polymerized with the abovementioned monoester compounds of a polyvalent alcohol and acrylic acid or methacrylic acid (PLACCEL FA series, PLACCEL FM series, and the like manufactured by Daicel Chemical Industries); compounds in which ethylene oxide and propylene oxide is ring-open polymerized, and other polymerizable vinyl monomers provided with a hydroxyl group; methyl (meth)acrylate, ethyl (meth)acrylate, butyl (meth)acrylate, 2-ethylhexyl (meth)acrylate, phenyl (meth)acrylate, cyclohexyl (meth)acrylate, dicyclopentanyl (meth)acrylate, dicyclopentanyloxyethyl (meth)acrylate, isobornyl (meth)acrylate, benzyl (meth)acrylate, phenylethyl (meth)acrylate, and other C₁₋₁₂ alkyl and aralkyl (meth)acrylates; styrene, α-methylstyrene, and other vinyl aromatic compounds. One compound or a combination of two or more compounds selected from the above examples can be used. However, the polymer C does not contain as monomer components an epoxy-containing vinyl monomer a1 and a fluoroalkyl- or fluoroaryl-containing vinyl monomer b1 such as previously described.

The content ratio (which is a value obtained by substitution with the weight of the monomer used to synthesize the polymer) of the polymerizable vinyl monomer c2 in the polymer C is preferably 30 wt % or less or, more preferably, 20 wt % or less. When the polymer C is a mixture of a plurality of different compounds, a weighted average value (weighted average value based on weight ratio) of the compounds may be used as the content ratio of the polymerizable vinyl monomer c2. When the polymer C is a mixture of a plurality of different compounds, the content ratio of the polymerizable vinyl monomer c2 with respect to the mixture of compounds preferably satisfies such conditions as those described above.

As described above, the polymer C contains at least the alkoxysilyl-containing vinyl monomer c1 as a monomer component. Although it is acceptable for the polymer C to contain a monomer component other than the alkoxysilyl-containing vinyl monomer c1, the polymer C is preferably a homopolymer of the alkoxysilyl-containing vinyl monomer c1. In other words, the polymer C preferably does not contain components other than the alkoxysilyl-containing vinyl monomer c1 as monomer components. In this way, the dispersion stability of the pigments in the color filter ink, the discharge stability of the color filter ink and the durability (particularly adhesion to the substrate) of a color filter manufactured using the color filter ink can be made particularly excellent.

Although there are no particular limitations on the content (content ratio) of the polymer C in the curable resin material (binder resin), the content of the polymer C is preferably 20 to 60 wt % or, more preferably, 25 to 55 wt %. When the polymer C is a mixture of a plurality of different compounds, the sum of the content ratios of the compounds may be used as the content ratio of the polymer C.

The ratio of the polymer A content to the polymer B content in terms of weight is preferably 25:75 to 75:25 or, more preferably, 45:55 to 55:45. Satisfying such conditions enables the color filter ink to be endowed with particularly excellent discharge stability and particularly excellent dispersion stability of the pigment in the color filter ink. Furthermore, unevenness of color and saturation between different regions of a color filter manufactured using the color filter ink can be more reliably prevented, and color filters manufactured using the color filter ink can be endowed with excellent uniformity of characteristics between individual units. The color filter(s) can also be endowed with particularly excellent durability.

The weight-average molecular weight of each polymer (polymer A, polymer B, polymer C) such as described above is preferably 1000 to 50,000, more preferably 1200 to 10,000, and even more preferably 1500 to 5000. The degree of dispersion (weight-average molecular weight Mw/number-average molecular weight Mn) of each polymer (polymer A, polymer B, polymer C) described above is about 1 to 3.

The content ratio of the curable resin material in the color filter ink is preferably 0.5 to 10 wt %, and more preferably 1 to 5 wt %. When the content ratio of the curable resin material is within this range, the color filter ink with can be endowed with excellent discharge properties from the droplet discharge head and a color filter manufactured using the color filter ink can be endowed with particularly excellent durability. Adequate color saturation can also be ensured in a manufactured color filter.

The content of the curable resin material is preferably 15 to 50 parts by weight or, more preferably, 19 to 42 parts by weight for every 100 parts by weight of pigment. Satisfying such conditions enables the color filter ink to be endowed with particularly excellent discharge stability and particularly excellent dispersion stability of the pigment in the color filter ink. Additionally, a colored portion formed on a color filter using the color filter ink can be endowed with particularly excellent coloration and contrast. Also, a colored portion formed using the color filter ink can be endowed with particularly excellent adhesion to the substrate.

The curable resin material (binder resin) contained in the color filter ink may also include a polymer other than the polymer A, polymer B, and polymer C described above.

It is acceptable for the color filter ink to contain components other than those described above. An example of a component other than the pigments, solvent, and curable resin material that make up the color filter ink is a dispersing agent (dispersant).

### Dispersing Agent

A dispersing agent is a component that helps improve the dispersion of pigment particles in the color filter ink. By including a dispersing agent in the color filter ink, the dispersion and dispersion stability of the pigment can be made particularly excellent. When a dispersing agent is used, the dispersing agent adheres (adsorbs) to the surfaces of the pigment particles (pigment particles that are not dispersed and have comparatively large diameters) added to a liquid in which the dispersing agent is dispersed (dispersing-agent-dispersed liquid) during a fine dispersion step of a manufacturing method that will be described later and enable the pigment particles (pigment particles that are not dispersed and have comparatively large diameters) to achieve an excellent degree of dispersion in the dispersing-agent-dispersed liquid. As a result, the fine dispersion treatment of the fine dispersion step can be executed efficiently and the color filter ink can be manufactured with particularly excellent productivity. Furthermore, the color filter ink ultimately obtained can be endowed with particularly excellent long-term dispersion stability of the pigment particles (finely distributed pigment particles) therein, and a color filter manufactured using the color filter ink can be endowed with particularly excellent lightness and contrast.

There are no particular limitations on the dispersing agent and, for example, a polymer dispersing agent can be used. Examples of polymer dispersing agents include basic polymer dispersing agents, neutral polymer dispersing agents, and acidic polymer dispersing agents. Examples of such polymer dispersing agents include dispersing agents made of an acrylic or modified acrylic copolymer, urethane-based dispersing agents, and dispersing agents made of a polyaminoamide salt, polyether ester, a phosphate ester, or an aliphatic polycarboxylic acid.

More specific examples of dispersing agents that can be used include: Disperbyk 101, Disperbyk 102, Disperbyk 103, Disperbyk P104, Disperbyk P104S, Disperbyk 220S, Disperbyk 106, Disperbyk 108, Disperbyk 109, Disperbyk 110, Disperbyk 111, Disperbyk 112, Disperbyk 116, Disperbyk 140, Disperbyk 142, Disperbyk 160, Disperbyk 161, Disperbyk 162, Disperbyk 163, Disperbyk 164, Disperbyk 166, Disperbyk 167, Disperbyk 168, Disperbyk 170, Disperbyk 171, Disperbyk 174, Disperbyk 180, Disperbyk 182, Disperbyk 183, Disperbyk 184, Disperbyk 185, Disperbyk 2000, Disperbyk 2001, Disperbyk 2050, Disperbyk 2070, Disperbyk 2095, Disperbyk 2150, Disperbyk LPN6919, Disperbyk 9075, and Disperbyk 9077 (all manufactured by BYK Chemie); EFKA 4008, EFKA 4009, EFKA 4010, EFKA 4015, EFKA 4020, EFKA 4046, EFKA 4047, EFKA 4050, EFKA 4055, EFKA 4060, EFKA 4080, EFKA 4400, EFKA 4401, EFKA 4402, EFKA 4403, EFKA 4406, EFKA 4408, EFKA 4300, EFKA 4330, EFKA 4340, EFKA 4015, EFKA 4800, EFKA 5010, EFKA 5065, EFKA 5066, EFKA 5070, EFKA 7500, and EFKA 7554 (all manufactured by Ciba Japan K.K.); Solsperse 3000, Solsperse 9000, Solsperse 13000, Solsperse 16000, Solsperse 17000, Solsperse 18000, Solsperse 20000, Solsperse 21000, Solsperse 24000, Solsperse 26000, Solsperse 27000, Solsperse 28000, Solsperse 32000, Solsperse 32500, Solsperse Solsperse 32550, Solsperse 33500, Solsperse 35100, Solsperse 35200, Solsperse 36000, Solsperse 36600, Solsperse 38500, Solsperse 41000, Solsperse 41090, and Solsperse 20000 (all manufactured by The Lubrizol Corporation); Ajisper PB-111, Ajisper PB-711, Ajisper PB-821, Ajisper PB-822, and Ajisper PB-824 (all manufactured by Ajinomoto Fine Techno); Disparlon 1850, Disparlon 1860, Disparlon 2150, Disparlon 7004, Disparlon DA-100, Disparlon DA-234, Disparlon DA 325, Disparlon DA-375, Disparlon DA-705, Disparlon DA-725, Disparlon PW-36 (all manufactured by Kusumoto Chemicals); Floren DOPA14, Floren DOPA-15B, Floren DOPA-17, Floren DOPA-22, Floren DOPA-44, Floren TG-710, and Floren D-90 (all manufactured by Kyoei Kagaku Co., Ltd.); and Anti-Terra-205 (manufactured by BYK Chemie). One or a combination of two or more of these dispersing agents can be used.

In the present invention, it is preferable to use both a dispersing agent having a prescribed acid value (hereinafter called “acid dispersing agent”) and a dispersing agent having a prescribed amine value (hereinafter called “amine dispersing agent”). An acid dispersing agent has an effect of lowering the viscosity of a color filter ink and an amine dispersing agent has an effect of stabilizing the viscosity of a color filter ink. By using both types of dispersing agent, the both effects can be utilized to obtain a color filter ink having particularly excellent dispersion stability of the pigment in the color filter ink. More particularly, a method to be described later has a preparatory dispersion step in which a mixture of a dispersing agent, a thermoplastic resin, and a solvent is agitated to disperse the dispersing agent in the solvent and obtain a dispersing-agent-dispersed liquid before a fine dispersion treatment is executed to finely disperse the pigment. In such a method, by using an acid dispersing agent together with an amine dispersing agent, association of the dispersing agents (i.e., association of the acid dispersing agent with the amine dispersing agent) can be reliably prevented and the aforementioned particularly excellent dispersion stability of the pigment can be achieved. Conversely, in a method not having a preparatory dispersion step, the aforementioned effects cannot be obtained by using both an acid dispersing agent and an amine dispersing agent. The reason for this difference is thought to be that when an acid dispersing agent and an amine dispersing agent are used together without executing a preparatory dispersion step, the acid dispersing agent and the amine dispersing agent contact the pigment particles in an associated state, thereby causing the pigment particles to cohere to one another.

Specific examples of an acid dispersing agent include: Disperbyk P104, Disperbyk P104S, Disperbyk 220S, Disperbyk 110, Disperbyk 111, Disperbyk 170, Disperbyk 171, Disperbyk 174, Disperbyk 2095 (all manufactured by BYK Chemie); EFKA 5010, EFKA 5065, EFKA 5066, EFKA 5070, EFKA 7500, and EFKA 7554 (all manufactured by Ciba Japan K.K.); Solsperse 3000, Solsperse 16000, Solsperse 17000, Solsperse 18000, Solsperse 36000, Solsperse 36600, and Solsperse 41000 (all manufactured by The Lubrizol Corporation).

Specific examples of an amine dispersing agent include: Disperbyk 102, Disperbyk 160, Disperbyk 161, Disperbyk 162, Disperbyk 163, Disperbyk 164, Disperbyk 166, Disperbyk 167, Disperbyk 168, Disperbyk 2150, Disperbyk LPN6919, Disperbyk 9075, and Disperbyk 9077 (all manufactured by BYK Chemie); EFKA 4015, EFKA 4020, EFKA 4046, EFKA 4047, EFKA 4050, EFKA 4055, EFKA 4060, EFKA 4080, EFKA 4300, EFKA 4330, EFKA 4340, EFKA 4400, EFKA 4401, EFKA 4402, EFKA 4403, EFKA 4800 (all manufactured by Ciba Japan K.K.); Ajisper PB-711 (manufactured by Ajinomoto Fine Techno); and Anti-Terra-205 (manufactured by BYK Chemie).

When an acid dispersing agent and an amine dispersing agent are used together, there are no particular limitations on the acid value of the acid dispersing agent (acid value calculated based on solid components), but the acid value is preferably from 5 to 370 KOH mg/g, more preferably 20 to 270 KOH mg/g, and still more preferably 30 to 135 KOH mg/g. When the acid value of the acid dispersing agent is within any of these ranges, particularly excellent dispersion stability of the pigment can be obtained when the acid dispersing agent is used together with an amine dispersing agent. The acid value of a dispersing agent can be found using a method in compliance with DINENIS02114.

The acid dispersing agent does not have a specific amine value and the amine value is preferably zero.

When an acid dispersing agent and an amine dispersing agent are used together, there are no particular limitations on the amine value of the amine dispersing agent (amine value calculated based on solid components), but the amine value is preferably from 5 to 200 KOH mg/g, more preferably 25 to 170 KOH mg/g, and still more preferably 30 to 130 KOH mg/g. When the amine value of the amine dispersing agent is within any of these ranges, particularly excellent dispersion stability of the pigment can be obtained when the amine dispersing agent is used together with an acid dispersing agent. The amine value of a dispersing agent can be found using a method in compliance with DIN16954.

The amine dispersing agent does not have a specific acid value and the acid value is preferably zero.

Also, when both an acid dispersing agent and an amine dispersing agent are used, the ratio of the amount acid dispersing agent used to the amount of amine dispersing agent used (amounts calculated based on solid components) in terms of a weight ratio is preferably from 1:1 to 1:9 or, more preferably, 1:2 to 1:5. The dispersion stability of the pigment in the color filter ink and the droplet discharge stability of the color filter ink can thereby be made to be particularly excellent.

It is also acceptable to use dispersing agents other than those mentioned above. For example, a compound provided with a cyamelide backbone can be used as the dispersing agent. The use of such a compound as the dispersing agent makes it possible to obtain particularly excellent dispersion properties of the pigment in the dispersion medium in which a curable resin material as described above is dissolved, and to endow the color filter ink with particularly excellent discharge stability. Such excellent effects are obtained not by merely using a compound provided with a cyamelide backbone as the dispersing agent, but by the synergistic effects of using a compound provided with a cyamelide backbone together with a pigment such as that described above (i.e., a main pigment and a secondary pigment) and a curable resin material such as that described above (resin material including the polymer A and the polymer B).

A compound having the partial structures indicated by Formula (7) and Formula (8) below, for example, can be used as the dispersing agent. Using such a compound as the dispersing agent makes it possible to obtain particularly excellent dispersion properties of the pigment in the color filter ink, and to endow the color filter ink with particularly excellent discharge stability.

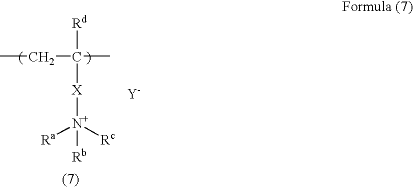

In Formula (7), R^{a}, R^{b}, and R^{c} are each independently a hydrogen atom, or a cyclic or chain hydrocarbon group which may be substituted; or two or more of R^{a}, R^{b}, and R^{c} bond with each other and form a cyclic structure; R^{d} is a hydrogen atom or a methyl group; X is a bivalent linking group; and Y⁻ is a counter anion.

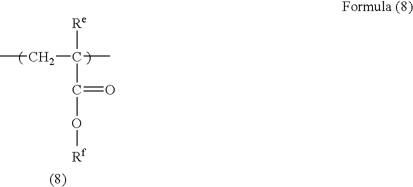

In Formula (8), R^{e} is a hydrogen atom or a methyl group; R^{f} is a cyclic or chain alkyl group which may have a substituted group, an aryl group which may have a substituted group, or an aralkyl group which may have a substituted group.

While there are no particular limitations on the content of the dispersing agent in the color filter ink, the content is preferably 2.5 to 10.2 wt % or, more preferably, 3.2 to 9.2 wt %.

### Thermoplastic Resin

It is acceptable for the color filter ink to contain a thermoplastic resin. By including a thermoplastic resin, the dispersion of the pigment particles in the color filter ink can be made to be particularly excellent. More specifically, by using a thermoplastic resin in the preparatory dispersion step of the manufacturing method that will be explained later, the dispersion stability of the pigment particles in the color filter ink can be made to be extremely excellent.

Examples of thermoplastic resins that can be used include alginate-based resin, polyvinyl alcohol, hydroxypropyl cellulose, carboxymethyl cellulose, hydroxyethyl cellulose, methyl cellulose, styrene-acrylate resin, styrene-acrylate acrylate-ester resin, styrene-maleate resin, styrene-maleate half-ester resin, methacrylate-methacrylic acid ester, acrylate-acrylic acid ester resin, isobutylene-maleic acid resin, rosin modified maleic acid resin, polyvinyl pyrrolidone, gum arabic starch, polyarylamine, polyvinyl amine, and polyethyl amine. One of these or a combination of two or more of these can be used.

While there are no particular limitations on the content of the thermoplastic resin in the color filter ink, the content is preferably 1.5 to 7.7 wt % or, more preferably, 2.1 to 7.2 wt %.

### Other Components

It is acceptable for a color filter ink according to the present invention to contain components other than those described above. Examples of such other components include various dyes, various cross-linking agents; thermoacid generators such as diazonium salt, iodonium salt, sulfonium salt, phosphonium salt, selenium salt, oxonium salt, ammonium salt, benzothiazolium salt, and other onium salts; diazonium salt, iodonium salt, sulfonium salt, phosphonium salt, selenium salt, oxonium salt, ammonium salt, and other photoacid generators; polymerization initiators; acid crosslinking agents; intensifiers; photostabilizers; adhesive improvers; polymerization accelerators; light stabilizers; glass, alumina, and other fillers; vinyl trimethoxysilane, vinyl triethoxysilane, vinyl tris(2-methoxy ethoxy)silane, N-(2-amino ethyl)-3-amino propyl methyl dimethoxysilane, N-(2-amino ethyl)-3-amino propyl trimethoxysilane, 3-amino propyl triethoxysilane, 3-glycidoxy propyl trimethoxysilane, 3-glycidoxy propyl methyl dimethoxysilane, 2-(3,4-epoxy cyclohexyl) ethyl trimethoxysilane, 3-chloro propyl methyl dimethoxysilane, 3-chloro propyl trimethoxysilane, 3-methacryloxy propyl trimethoxysilane, 3-mercapto propyl trimethoxysilane, and other adhesion accelerants; 2,2-thiobis(4-methyl-6-t-butyl phenol), 2,6-di-t-butyl phenol, and other antioxidants; 2-(3-t-butyl-5-methyl-2-hydroxy phenyl)-5-chlorobenzotriazole, alcoxy benzophenone, and other UV absorbers; and sodium polyacrylate, and other anti-coagulants.

Examples of dyes include azo dyes, anthraquinone dyes, condensed multi-ring aromatic carbonyl dyes, indigoid dyes, carbonium dyes, phthalocyanine dyes, methines, polymethine dyes, and the like. Specific examples of dyes include C. I direct red 2, 4, 9, 23, 26, 28, 31, 39, 62, 63, 72, 75, 76, 79, 80, 81, 83, 84, 89, 92, 95, 111, 173, 184, 207, 211, 212, 214, 218, 221, 223, 224, 225, 226, 227, 232, 233, 240, 241, 242, 243, and 247; C. I. acid red 35, 42, 51, 52, 57, 62, 80, 82, 111, 114, 118, 119, 127, 128, 131, 143, 145, 151, 154, 157, 158, 211, 249, 254, 257, 261, 263, 266, 289, 299, 301, 305, 319, 336, 337, 361, 396, and 397; C. I. reactive red 3, 13, 17, 19, 21, 22, 23, 24, 29, 35, 37, 40, 41, 43, 45, 49, and 55; C. I. basic red 12, 13, 14, 15, 18, 22, 23, 24, 25, 27, 29, 35, 36, 38, 39, 45, and 46; C. I direct violet 7, 9, 47, 48, 51, 66, 90, 93, 94, 95, 98, 100, and 101; C. I acid violet 5, 9, 11, 34, 43, 47, 48, 51, 75, 90, 103, and 126; C. I reactive violet 1,3, 4, 5, 6, 7, 8, 9, 16, 17, 22, 23, 24, 26, 27, 33, and 34; C. I. basic violet 1, 2, 3, 7, 10, 15, 16, 20, 21, 25, 27, 28, 35, 37, 39, 40, and 48; C. I. direct yellow 8, 9, 11, 12, 27, 28, 29, 33, 35, 39, 41, 44, 50, 53, 58, 59, 68, 87, 93, 95, 96, 98, 100, 106, 108, 109, 110, 130, 142, 144, 161, and 163; C. I. acid yellow 17, 19, 23, 25, 39, 40, 42, 44, 49, 50, 61, 64, 76, 79, 110, 127, 135, 143, 151, 159, 169, 174, 190, 195, 196, 197, 199, 218, 219, 222, and 227; C. I. reactive yellow 2, 3, 13, 14, 15, 17, 18, 23, 24, 25, 26, 27, 29, 35, 37, 41, and 42; C. I. basic yellow 1, 2, 4, 11, 13, 14, 15, 19, 21, 23, 24, 25, 28, 29, 32, 36, 39, and 40; C. I. acid green 16; C. I. acid blue 9, 45, 80, 83, 90 and 185; C. I. basic orange 21 and 23; and the like.

Examples of cross-linking agents that may be used include polycarboxylic acid anhydrides, polycarboxylic acids, polyfunctional epoxy monomers, polyfunctional acrylic monomers, polyfunctional vinyl ether monomers, and polyfunctional oxetane monomers. Specific examples of polycarboxylic acid anhydrides include phthalic anhydride, itaconic anhydride, succinic anhydride, citraconic anhydride, dodecenyl succinic anhydride, tricarballylic anhydride, maleic anhydride, hexahydrophthalic anhydride, dimethyl tetrahydrophthalic anhydride, himic anhydride, nadic anhydride, and other aliphatic or alicyclic dicarboxylic anhydrides; 1,2,3,4-butane tetracarboxylic acid dianhydride, cyclopentane tetracarboxylic acid dianhydride, and other aliphatic polycarboxylic acid dianhydrides; pyromellitic acid anhydride, trimellitic acid anhydride, benzophenone tetracarboxylic acid anhydride, and other aromatic polycarboxylic acid anhydrides; ethylene glycol vis(trimellitate), glycerin trimellitate, and other ester-containing acid anhydrides. Among these, aromatic polycarboxylic acid anhydrides are preferred. An epoxy resin curing agent made of a commercially available carboxylic acid anhydride can also be used favorably. Specific examples of a polycarboxylic acids include: succinic acid, glutamic acid, adipic acid, butane tetracarboxylic acid, maleic acid, itaconic acid and other aliphatic polycarboxylic acids; hexahydrophthalic acid, 1,2 cyclohexane dicarboxylic acid, 1,2,4-cyclohexane tricarboxylic acid, cyclopentane tetracarboxylic acid, and other aliphatic polycarboxylic acids; and phthalic acid, isophthalic acid, terephthalic acid, pyromellitic acid, trimellitic acid, 1,4,5,8-naphthalene tetracarboxylic acid, benzophenone tetracarboxylic acid, and other aromatic polycarboxylic acids, aromatic polycarboxylic acids being preferred. Specific example of a polyfunctional epoxy monomer the product name Celloxide 2021 manufactured by Daicel Chemical Industries, the product name Epolead GT401 manufactured by Daicel Chemical Industries, the product name Epolead PB3600 manufactured by Daicel Chemical Industries, bisphenol A, hydrogenated bisphenol A, and triglycidyl isocyanurate. Specific example of a polyfunctional acrylic monomer include pentaerythritol ethoxytetraacrylate, pentaerythritol tetraacrylate, pentaerythritol triacrylate, pentaerythritol ethoxytetraacrylate, ditrimethylol propane tetraacrylate, trimethylolpropane triacrylate, trimethylol propane ethoxytriacrylate, dipentaerythritol hexaacrylate trimethallyl isocyanurate, and triaryl isocyanurate. Examples of a polyfunctional vinyl ether monomer include 1,4-butanediol vinyl ether, 1,6-hexanediol divinyl ether, nonanediol divinyl ether, cyclohexanediol divinyl ether, cyclohexanedimethanol divinyl ether, triethylene glycol divinyl ether, trimethylolpropane trivinyl ether, and pentaerythritol tetravinyl ether. Examples of polyfunctional oxetane monomers include xylylene dioxetane, biphenyl-type oxetane, and novolac-type oxetane.

The thermoacid generator is a component for generating acid by applying heat, and particularly preferred among those described above are sulfonium salt and benzothiazolium salt. More specific examples of thermoacid generators in terms of product names include Sunaid SI-45, Sunaid SI-47, Sunaid SI-60, Sunaid SI-60L, Sunaid SI-80, Sunaid SI-80L, Sunaid SI-100, Sunaid SI-100L, Sunaid SI-145, Sunaid SI-150, Sunaid SI-160, Sunaid SI-110L, Sunaid SI-180L (all product names, manufactured by Sanshin Chemical Industry Co., Ltd.), CI-2921, CI-2920, CI-2946, CI-3128, CI-2624, CI-2639, CI-2064 (all product names, manufactured by Nippon Soda Co., Ltd.), CP-66, CP-77 (product names, manufactured by Adeka Corporation), and FC-520 (product name, manufactured by 3M Company).

The photoacid generator is a component for generating acid by using light, and more specific examples include the product names Cyracure UVI-6970, Cyracure UVI-6974, Cyracure UVI-6990, Cyracure UVI-950 (all product names, manufactured by US Union Carbide), Irgacure 261 (product name, Ciba Specialty Chemicals), SP-150, SP-151, SP-170, Optomer SP-171(all product names, manufactured by Adeka Corporation), CG-24-61 (product name, manufactured by Ciba Specialty Chemicals), Daicat II (product name, manufactured by Daicel Chemical Industries, Ltd.), UVAC 1591 (product name, manufactured by Daicel UCB Co., Ltd.), CI-2064, CI-2639, CI-2624, CI-2481, CI-2734, CI-2855, CI-2823, CI-2758 (product name, manufactured by Nippon Soda Co., Ltd.), PI-2074 (product name, manufactured by Rhone Poulenc, pentafluorophenyl borate tolyl cumyl iodonium), FFC509 (product name, manufactured by 3M Company), BBI-102, BBI-101, BBI-103, MPI-103, TPS-103, MDS-103, DTS-103, NAT-103, NDS-103 (product name, manufactured by Midori Kagaku Co., Ltd.), and CD-1012 (product name, manufactured by Sartomer Co., Inc.).

In a color filter ink according to the present invention, the pigment particles are finely distributed in a uniform fashion and the dispersion stability of the pigment particles over a long period of time (long-term dispersion stability) is excellent. Consequently, the properties of the color filter ink are effectively prevented from changing over time such that, for example, the color filter ink can be used to form a colored portion (color filter) having a uniform color saturation that last for a long period of time and unevenness of color and saturation can be effectively prevented from occurring in a color filter manufactured using the color filter ink. Since the pigment is finely distributed, excellent coloration is obtained from the pigment and the color filter ink is well-suited for making a color filter having a high lightness.

The viscosity of the color filter ink at 25° C. (viscosity (kinematic viscosity) measured using an E-type viscometer) is preferably 13 mPa·s or below, more preferably 12 mPa·s, and still more preferably from 5 to 11 mPa·s. If the viscosity (dynamic viscosity) of the color filter ink is sufficiently low, then, for example, color filters can be manufactured with particularly excellent production efficiency (colored portions can be formed very efficiently) and unintended variation of the thickness of colored portions formed can be effectively prevented. The viscosity (kinematic viscosity) of the color filter ink can be measured using, for example, an E-type viscometer (e.g., an RE-01 manufactured by Toki Sangyo Co., Ltd.); more particularly, the viscosity can be measured in accordance with JIS Z8809.

The color filter ink is contrived such that after it has been held at 60° C. for ten days, its viscosity at 25° C. is preferably 0.5 mPa·s or lower, more preferably 0.3 mPa·s, and still more preferably for 0.2 mPa·s. In this way, the color filter ink can be endowed with particularly excellent discharge stability and color filters reliably prevented from having unevenness of color or saturation can be favorably manufactured with the color filter ink over a longer period of time.

### Method of Manufacturing Color Filter Ink

A preferred embodiment of a manufacturing method for a color filter ink as described heretofore will now be explained.

A manufacturing method according to this embodiment includes a preparatory dispersion step in which a mixture of a dispersing agent, a thermoplastic resin, and a solvent is agitated to disperse the dispersing agent in the solvent and obtain a dispersing-agent-dispersed liquid, a fine dispersing step in which a pigment dispersed material is obtained by adding a pigment to the dispersing-agent-containing dispersion medium and executing a fine dispersion treatment in which inorganic beads are added in multiple stages, and a curable resin mixing step in which the pigment dispersed material is mixed with a curable resin material.

### Preparatory Dispersion Step

In the preparatory dispersion step, a mixture of a dispersing agent, a thermoplastic resin, and a solvent is agitated to disperse the dispersing agent in the solvent and obtain a dispersing-agent-dispersed liquid. In this way, the dispersing agent can be put into a state in which it is not associated with itself, i.e., the associations have been broken.

Thus, in this embodiment, by forming a mixture in which the dispersing agent has been dispersed without the pigment before executing a treatment in which the pigment is finely dispersed (described in detail later), the pigment particles are ultimately dispersed in a uniform and stable manner and a color filter ink having particularly excellent discharge stability can be obtained.

Since a thermoplastic resin and a dispersing agent are mixed with a solvent in this step, the dispersing agent and the thermoplastic resin can be made to adhere to the surfaces of the pigment particles (pigment particles that are not dispersed and have comparatively large diameters) added to the dispersing-agent-dispersed liquid during the fine dispersion step (which will be described later) and enable the pigment particles (pigment particles that are not dispersed and have comparatively large diameters) to achieve an excellent degree of dispersion in the dispersing-agent-dispersing liquid. As a result, the fine dispersion treatment of the fine dispersing step can be executed efficiently and the color filter ink can be manufactured with particularly excellent productivity. Furthermore, the color filter ink ultimately obtained has particularly excellent long-term dispersion stability of the pigment particles (finely dispersed fine pigment particles) in the color filter ink and particularly excellent droplet discharge stability.

Although there are no particular limitations on the content of dispersing agent in the dispersing-agent-dispersed liquid that is made in this step (when more than one type of dispersing agent is used, the “content” mentioned here is the sum of the individual contents of the different dispersing agents), the content of dispersing agent is preferably from 10 to 40 wt % or, more preferably, 12 to 32 wt %. If the content of dispersing agent is a value within one of these ranges, the previously described effects will be exhibited more demonstrably.

Although there are no particular restrictions on the content of thermoplastic resin in the dispersing-agent-dispersed liquid that is made in this step, the content of thermoplastic resin is preferably 6 to 30 wt % or, more preferably, 8 to 26 wt %. If the content of thermoplastic resin is a value within one of these ranges, the previously described effects will be exhibited more demonstrably.

Although there are no particular restrictions on the content of solvent in the dispersing-agent-dispersed liquid that is made in this step, the content of solvent is preferably 40 to 80 wt % or, more preferably, 53 to 75 wt %. If the content of solvent is a value within one of these ranges, the previously described effects will be exhibited more demonstrably.

In this step, various types of agitating machines are used to agitate the mixture of the aforementioned components so as to obtain a dispersing-agent-dispersed liquid.

An example of an agitating machine that can be used in this step is a single-axis or dual-axis mixer, such as a dispermill.

Although there are no particular limitations on the amount of time the agitating machine is used to execute the agitation treatment, the amount o time is preferably 1 to 30 minutes or, more preferably, 3 to 20 minutes. In this way, the color filter ink can be manufactured with sufficiently excellent productivity and the associated state of the dispersing agent(s) can be broken in an effective manner. The color filter ink ultimately obtained can thereby be endowed with particularly excellent dispersion stability of the pigment particles in the color filter ink and particularly excellent discharge stability of the color filter ink.

Although there are no particular restrictions on the rotational speed of an agitation propeller of the agitating machine used in this step, the rotational speed of the agitation propeller is preferably 500 to 4000 rpm or, more preferably, 800 to 3000 rpm. In this way, the color filter ink can be manufactured with sufficiently excellent productivity and the associated state of the dispersing agent(s) can be broken in an effective manner. The color filter ink ultimately obtained can thereby be endowed with particularly excellent dispersion stability of the pigment particles in the color filter ink. Furthermore, degradation and denaturalization of the thermoplastic resin due to heat or the like can be reliably prevented.

### Fine Dispersion Step

In the fine dispersion step, pigments in accordance with a preceding explanation are added to the dispersing-agent-dispersed liquid obtained in the preceding step (preparatory dispersion step) and inorganic beads are added in multiple stages.

Thus, in this embodiment, a preparatory dispersion step is provided before adding the pigment and inorganic beads are added in multiple stages during a step in which the pigment is finely dispersed (fine dispersion step). In the fine dispersion step, by adding the inorganic beads in multiple stages, the pigment can be broken into fine particles in a very efficient manner and the color filter ink ultimately obtained can be provided with sufficiently small pigment particles. The effects of using both a halogenated phthalocyanine zinc complex (main pigment) and a sulfonated pigment derivative (secondary pigment) and the effects of using a method having a preparatory dispersion step and a multiple-staged fine dispersion step compliment one another in a synergistic manner. As a result, the color filter ink ultimately obtained has extremely excellent dispersion stability of the pigment and droplet discharge stability and can be used to manufacture a color filter having extremely excellent lightness and contrast.

Conversely, if the fine dispersion step is not executed in multiple stages, then it will be difficult to obtain a color filter ink in which the pigment particles are sufficiently small and the productivity with which the color filter ink is manufactured could possibly decline markedly. Even if a fine dispersion step is executed, problems can occur if the preparatory dispersion step is omitted. If the preparatory dispersion step is omitted, then the associated state of the dispersing agent(s) will not be sufficiently broken (disassociated) when the pigment is added and, consequently, in the fine dispersion step it will be difficult to make the dispersing agent and the thermoplastic resin adhere uniformly to the surfaces of the pigment particles. Thus, it will be difficult to achieve a sufficiently excellent dispersion of the pigment particles (comparatively large diameter pigment particles that are not finely distributed) in the solvent during the fine dispersion step.

In this embodiment, the fine dispersion step is contrived such that the inorganic beads are added in multiple stages. While it is acceptable to add the inorganic beads in three or more stages, it is preferable to add the inorganic beads in two stages. As result, the color filter ink ultimately obtained can be endowed with sufficiently excellent long-term dispersion stability of the pigment particles in the color filter ink and the color filter ink can be manufactured with particularly excellent productivity.

A representative example of a method in which the inorganic beads are added in two stages, i.e., a method having a first treatment in which first inorganic beads are used and a second treatment in which second inorganic beads are used, will now be explained.

The inorganic beads used in this step (first inorganic beads and second inorganic beads) can be made of any inorganic material. A good example of a type of inorganic bead that can be used is a bead made of zirconia (e.g., Torayceram (trade name) pulverizing balls manufactured by Toray Industries, Inc.).

### First Treatment

In this step, first the pigments (main pigment and secondary pigment) are added to the dispersing-agent-dispersed liquid made in the previously described preparatory dispersion step and a first treatment constituting a primary dispersion is executed using first inorganic beads having a prescribed particle diameter.

The first inorganic beads used in the first treatment preferably have a larger diameter than the second inorganic beads used in the second treatment. By using larger beads in the first treatment and smaller beads in the second treatment, the efficiency with which the pigments are pulverized into fine particles (finely dispersed) in the fine dispersion step as a whole can be made to be particularly excellent.

Although there are no particular limitations on the average particle diameter of the first inorganic beads, the average particle diameter is preferably 0.5 to 3.0 mm, more preferably 0.5 to 2.0 mm, and still more preferably 0.5 to 1.2 mm. When the average particle diameter of the first inorganic beads is a value within one of these ranges, the pulverization of the pigments in to fine particles (fine dispersion of the pigments) in the fine dispersion step as a whole can be accomplished with particularly excellent efficiency. Conversely, if the average particle diameter of the first inorganic beads is smaller than the lower limit value of the aforementioned ranges, then depending on the type of pigments used, the efficiency of the pulverization of the pigments into fine particles (size reduction of the pigment particles) in the first treatment will tend to decline demonstrably. Meanwhile, if the average particle diameter of the first inorganic beads is larger than the upper limit value of the aforementioned ranges, the efficiency of the pulverization of the pigments into fine particles (size reduction of the pigment particles) in the first treatment can be comparatively good, but the efficiency of the pulverization of the pigments into fine particles (size reduction of the pigment particles) in the second treatment will decline and cause the overall pulverization (fine dispersion) efficiency of the fine dispersion step to decline.

Although there are no particular limitations on the amount of first inorganic beads used, the amount of first inorganic beads is preferably 100 to 600 parts by weight, and more preferably 200 to 500 parts by weight, for every 100 parts by weight of the dispersing-agent-dispersed liquid.

Although there are no particular limitations on the amount of pigment used when the pigment(s) is added to the dispersing-agent-dispersed liquid, the amount of pigment is preferably 12 or more parts by weight, and more preferably 18 to 35 parts by weight, for every 100 parts by weight of the dispersing-agent-dispersed liquid.

The first treatment can be accomplished by adding the first inorganic beads to the dispersing-agent-dispersed liquid and agitating the mixture with any of various agitating machines.

Examples of agitating machines that can be used in the first treatment include such media dispersing machines as a Pearl Mill and such single axis or dual axis mixers as a dispermill.

Although there are no particular limitations on the amount of time the agitating machine is used to execute the agitation treatment (first treatment), the amount o time is preferably 10 to 120 minutes or, more preferably, 15 to 40 minutes. As a result, the pigment can be pulverized into fine particles (finely dispersed) efficiently without decreasing the productivity with which the color filter ink is manufactured.

Although there are no particular restrictions on the rotational speed of an agitation propeller of the agitating machine used in the first treatment, the rotational speed of the agitation propeller is preferably 1000 to 5000 rpm or, more preferably, 1200 to 3800 rpm. With such a rotational speed, the pigment can be pulverized into fine particles (finely dispersed) efficiently without decreasing the productivity with which the color filter ink is manufactured. Furthermore, degradation and denaturalization of the thermoplastic resin due to heat or the like can be reliably prevented.

### Second Treatment

After the first treatment, the second treatment is executed using the second inorganic beads. In this way, a pigment dispersed material in which the pigment particles are sufficiently dispersed can be obtained.

Although it is acceptable to execute the second treatment with the first inorganic beads remaining in the mixture, it is preferable to remove the first inorganic beads before executing the second treatment. By removing the first inorganic beads, the efficiency with which the pigments are pulverized into fine particles (finely dispersed) in the second treatment can be made to be particularly excellent. The first inorganic beads can be removed easily and reliably by, for example, filtering.

The second inorganic beads used in the second treatment preferably have a smaller diameter than the first inorganic beads used in the first treatment. In this way, the pigments can be sufficiently pulverized into fine particles (finely dispersed) in the color filter ink ultimately obtained, and the color filter ink can be endowed with particularly excellent dispersion stability (long-term dispersion stability) of the ink particles over a long period time and particularly excellent droplet discharge stability.

Although there are no particular limitations on the average diameter of the second inorganic beads, the average diameter is preferably from 0.03 to 0.3 mm, and more preferably from 0.05 to 0.2 mm. When the average particle diameter of the second inorganic beads is a value within one of these ranges, the pulverization of the pigments into fine particles (fine dispersion of the pigments) in the fine dispersion step as a whole can be accomplished with particularly excellent efficiency. Conversely, if the average particle size of the second inorganic beads is smaller than the lower limit value of the aforementioned ranges, then depending on the type of pigments used, the efficiency of the pulverization of the pigments in to fine particles (size reduction of the pigment particles) in the second treatment will tend to decline demonstrably. Meanwhile, if the average particle diameter of the second inorganic beads is larger than the upper limit of the aforementioned ranges, then it can be difficult to sufficiently pulverize the pigments into fine particles (reduce the size of the pigment particles).

Although there are no particular limitations on the amount of second inorganic beads used, the amount of second inorganic beads is preferably 100 to 600 parts by weight, and more preferably 200 to 500 parts by weight, for every 100 parts by weight of the dispersing-agent-dispersed liquid.

The second treatment can be accomplished using any of various agitating machines.

Examples of agitating machines that can be used in the second treatment include such media dispersing machines as a Pearl Mill and such single axis or dual axis mixers as a dispermill.

Although there are no particular limitations on the amount of time the agitation machine is used to execute the agitation treatment (second treatment), the amount o time is preferably 10 to 120 minutes or, more preferably, 15 to 40 minutes. As a result, the pigment can be sufficiently pulverized into fine particles (finely dispersed) without decreasing the productivity with which the color filter ink is manufactured.

Although there are no particular restrictions on the rotational speed of an agitation propeller of the agitating machine used in the second treatment, the rotational speed of the agitation propeller is preferably 1000 to 5000 rpm or, more preferably, 1200 to 3800 rpm. With such a rotational speed, the pigment can be pulverized into fine particles (finely dispersed) efficiently without decreasing the productivity with which the color filter ink is manufactured. Furthermore, degradation and denaturalization of the thermoplastic resin due to heat or the like can be reliably prevented.

Although fine dispersion treatment is explained based on a case in which the fine dispersion treatment is executed in two stages, it is also acceptable to execute a treatment having three or more stages. In such a case, it is preferable for the inorganic beads used in later treatments to be smaller than the inorganic beads used in earlier treatments. In other words, it is preferable for the average particle diameter of the inorganic beads (n^{th} inorganic beads) used in the n^{th} treatment to be smaller than the average particle diameter of the inorganic beads ((n−1)^{th} inorganic beads) used in the (n−1)^{th} treatment. By satisfying this relationship, the pigment particles can be pulverized to a finer size (finely dispersed) in a particularly efficient manner and the color filter ink ultimately obtained can be endowed with smaller pigment particles.

In the fine dispersion step (e.g., the first treatment and the second treatment), it is acceptable to execute, for example, a dilution treatment using a solvent as necessary.

### Curable Resin Mixing Step

In the curable resin mixing step, the pigment dispersed material obtained in the fine dispersing step is mixed with a curable resin material. In this way, a color filter ink is obtained.

It is preferable for the second inorganic beads used in the second treatment to be removed before executing this step. The second inorganic beads can be removed easily and reliably by, for example, filtering.

The curable resin mixing step can be accomplished using any of various agitating machines.

An example of an agitating machine that can be used in this step is a single-axis or dual-axis mixer, such as a dispermill.

Although there are no particular limitations on the amount of time the agitation machine is used to execute the agitation treatment (to execute this step), the amount o time is preferably 1 to 60 minutes or, more preferably, 15 to 40 minutes.

Although there are no particular restrictions on the rotational speed of an agitation propeller of the agitating machine used in this step, the rotational speed of the agitation propeller is preferably 1000 to 5000 rpm or, more preferably, 1200 to 3800 rpm.

In this step, it is acceptable to add a liquid of a different composition than the solvent used in the previous steps. In this way, the dispersing agent can be dispersed in a favorable fashion in the preparatory dispersion step and the pigment particles can be dispersed in a favorable fashion in the fine dispersion step. Meanwhile, a color filter ink having the desired properties can be obtained in a reliable fashion in this step.

In this step, it is acceptable to remove at least a portion of the solvent used in the preceding steps before or after the curable resin material is mixed with the pigment dispersed material. In this way, the composition of the dispersion medium of the color filter ink ultimately obtained can be made to be different from the composition of the solvent used in the preparatory dispersion step and the fine dispersion step. As a result, the dispersing agent can be dispersed in a favorable fashion in the preparatory dispersion step and the pigment particles can be dispersed in a favorable fashion in the fine dispersion step. Meanwhile, a color filter ink having the desired properties can be obtained in a reliable fashion in this step. The solvent can be removed by, for example, putting the targeted liquid into an atmosphere of reduced pressure and heating it.

### Ink Set

A color filter ink such as that described above is used in the manufacture of a color filter using an inkjet method. A color filter ordinarily has a plurality of colored portions of different colors (ordinarily, the three colors red, green, and blue corresponding to the three primary colors of light) in order to accommodate a full color display. In order to form the different colored portions, a plurality of types of color filter ink corresponding to each of the colors of the colored portions is used. In other words, an ink set provided with a plurality of colors of color filter ink is used in the manufacture of a color filter. In the present invention, the ink set comprises a color filter ink according to the present invention that contains a halogenated phthalocyanine zinc complex as a main pigment and a sulfonated pigment derivative as a secondary pigment, and other colors of ink (color filter ink). A color filter ink according to the present invention that contains a halogenated phthalocyanine zinc complex and a sulfonated pigment derivative is normally used to form a green colored portion. Thus, the ink set comprises a color filter ink according to the present invention and, for example, an ink (color filter ink) used to form a red colored portion and an ink (color filter ink) used to form a blue colored portion. Although the other colors of ink (inks other than the color filter ink according to the present invention) included in the ink set can be manufactured by any method, it is preferred for the other colors of ink to be manufactured using the same manufacturing method as the color filter ink according to the present invention described previously (i.e., the same method except that the types of pigment are changed). In this way, the variation of the droplet discharge stability between colors can be suppressed to a higher degree and a more reliable color filter can be manufactured. Although there are no particular limitations on the other colors of ink (inks other than the color filter ink according to the present invention) comprising the ink set, it is preferred that the other colors of ink contain a curable resin material of the kind described previously. In this way, the variation of the droplet discharge stability between colors can be suppressed to a higher degree and a more reliable color filter can be manufactured. Additionally, the variation of properties (e.g., light fastness and adhesion to a substrate) between colored portions having different colors can be suppressed and a color filter having a high level of reliability and durability can be manufactured.

When the ink set includes a red color filter ink (red ink) in addition to the color filter ink (green color filter ink) according to the present invention, the pigment of the red ink is preferably C.I. pigment red 177 and a derivative thereof and/or C.I. pigment red 254 and a derivative thereof. In this way, the coloration of the red ink can be made particularly excellent. The long-term dispersion stability of the pigment particles in the color filter ink and the droplet discharge stability of the color filter ink can also be made to be particularly excellent.

These effects are exhibited even more demonstrably when the ink contains a compound (derivative) in accordance with Formula (9) or Formula (10) as a derivative of C.I. pigment red 177 or a derivative of C.I. pigment red 254.

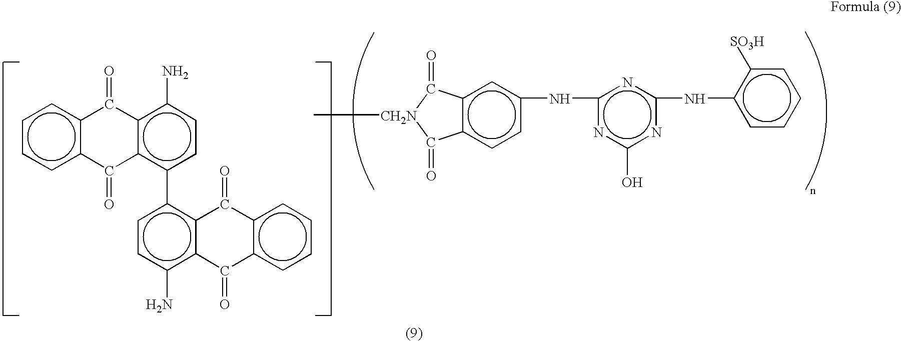

In Formula (9), n is an integer from 1 to 4.

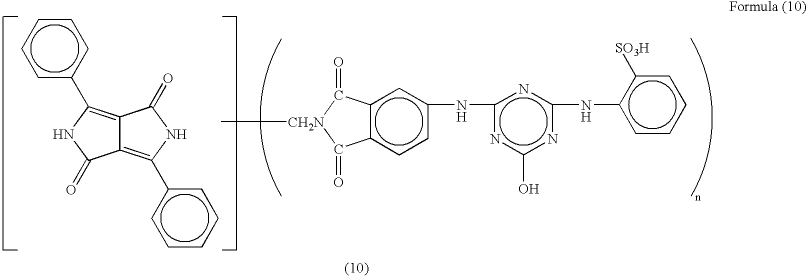

In Formula (10), n is an integer from 1 to 4.

### Color Filter

Following is a description of an example of a color filter manufactured using the color filter ink (ink set) described above.

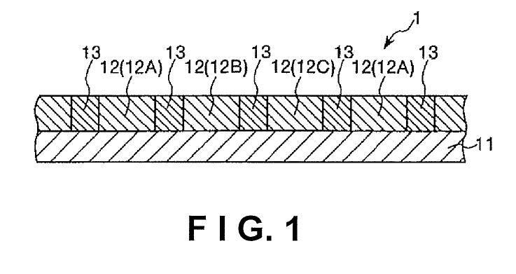

FIG. 1 is a cross-sectional view showing a preferred embodiment of a color filter in accordance with the present invention.

As shown in FIG. 1, the color filter 1 comprises a substrate 11 and colored portion 12 formed using the color filter inks described previously. The colored portions 12 include a first colored portion 12A, a second colored portion 12B, and a third colored portion 12C, each having a different color. A partition wall 13 is disposed between adjacent colored portions 12.

### Substrate

The substrate 11 is a plate-shaped member having optical transparency and a function of holding the colored portion 12 and the partition walls 13.

It is preferred that the substrate 11 be essentially composed of a transparent material. A clearer image can thereby be formed by light transmitted through the color filter 1.

The substrate 11 preferably has excellent heat resistance and mechanical strength. Deformations or the like caused by, for example, heat applied during the manufacture of the color filter 1 can thereby be reliably prevented. Examples of a constituent material of the substrate 11 that satisfies such conditions include glass, silicon, polycarbonate, polyester, aromatic polyamide, polyamidoimide, polyimide, norbornene-based ring-opening polymers, and hydrogenated substances.

### Colored Portions

The colored portion 12 are formed using a color filter ink (ink set) such as that described above.

Since the colored portion 12 are formed using a color filter ink such as that described above, there is little variation in characteristics between pixels and unintentional color mixing (mixing of a plurality of color filter inks) and the like is reliably prevented. For this reason, the color filter 1 is highly reliable in that the occurrence of unevenness of color and saturation is reduced. Additionally, the colored portion 12 have excellent coloration and the color filter 1 has excellent contrast.

Each colored portion 12 is disposed inside a cell 14, which is an area enclosed by a partition wall 13 (described later).

The first colored portion 12A, the second colored portion 12B, and the third colored portion 12C each have a different color. For example, the first colored portion 12A can be a red filter area (R), second colored portion 12B can be a green filter area (G), and the third colored portion 12C can be a blue filter area (B). Each set of different-colored colored portions 12A, 12B, 12C constitutes a single pixel. In a colored filter 1, prescribed numbers of colored portion 12 are arranged in the horizontal and vertical directions. For example, the color filter 1 has 1366×768 pixels if it is a high vision color filter, 1920×1080 pixels if it is a full high vision color filter, and 7680×4320 pixels if it is a super high vision color filter. The color filter 1 may be provided with spare pixels outside of an effective area.

### Partition Wall

A partition wall (bank) 13 is disposed between adjacent colored portions 12. As a result, color mixing between adjacent colored portion 12 can be reliably prevented and a clear image can be displayed in a reliable fashion.

The partition wall 13 may be composed of a transparent material, but it is preferably composed of material having light-blocking properties. Using such a material enables an image with excellent contrast to be displayed. The color of the partition wall (light-blocking portion) 13 is not particularly limited, but black is preferred. Using black partition walls enables a displayed image having particularly good contrast to be obtained.

Although there are no particular limits on the height of the partition walls 13, the height is preferably larger than the film thickness of the colored portions 12. By making the height of the partition walls 13 larger than the film thickness, mixing of colors between adjacent colored portion 12 can be reliably prevented. The thickness of the partition walls 13 is preferably from 0.1 to 10 μm, and more preferably 0.5 to 3.5 μm. When the wall thickness is within these ranges, mixing of colors between adjacent colored portion 12 can be reliably prevented and an image display device or electronic device equipped with the color filter 1 can be endowed with an excellent viewing angle characteristic.

The partition wall 13 may be composed of any material, but is preferably composed principally of a resin material, for example. In this way, a partition wall 13 having a desired shape can be easily formed using a method described hereinafter. When the partition wall 13 will function as a light-blocking portion, carbon black or another light-absorbing material may be included as a constituent material of the partition wall.

### Method for Manufacturing Color Filter

Next, an example of the method for manufacturing the color filter 1 will be described.

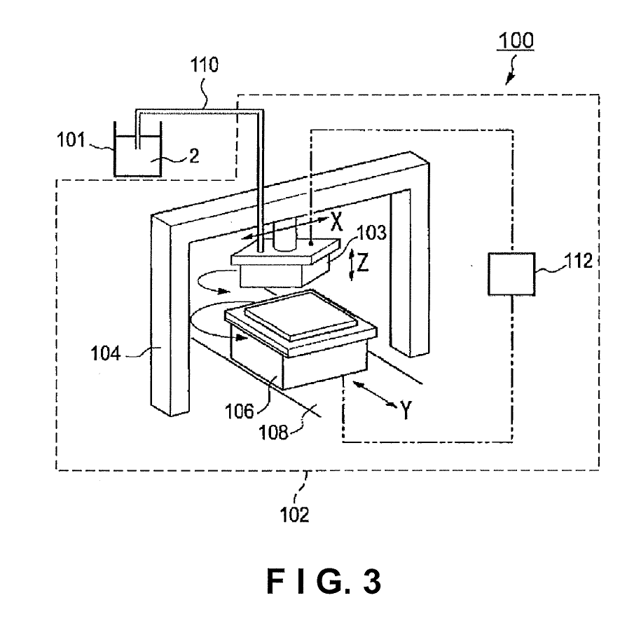

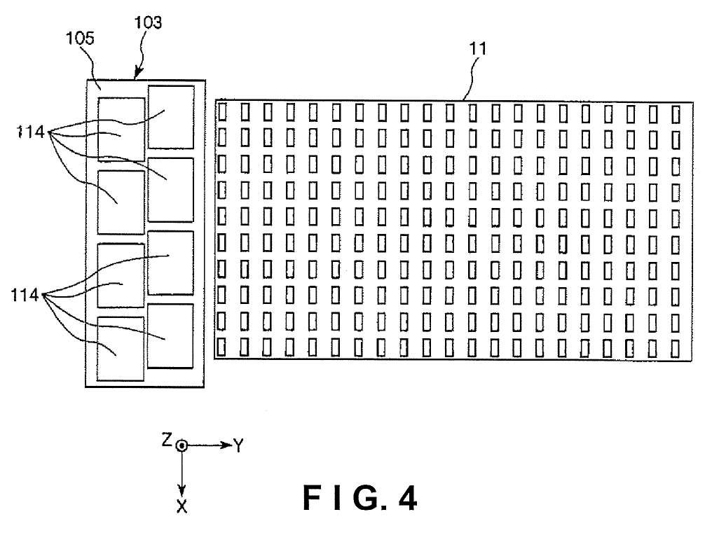

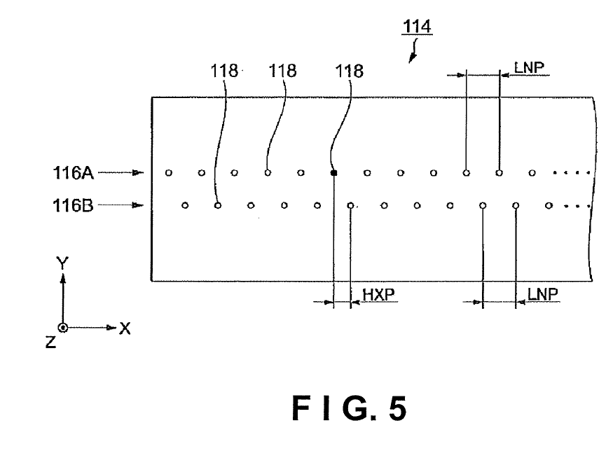

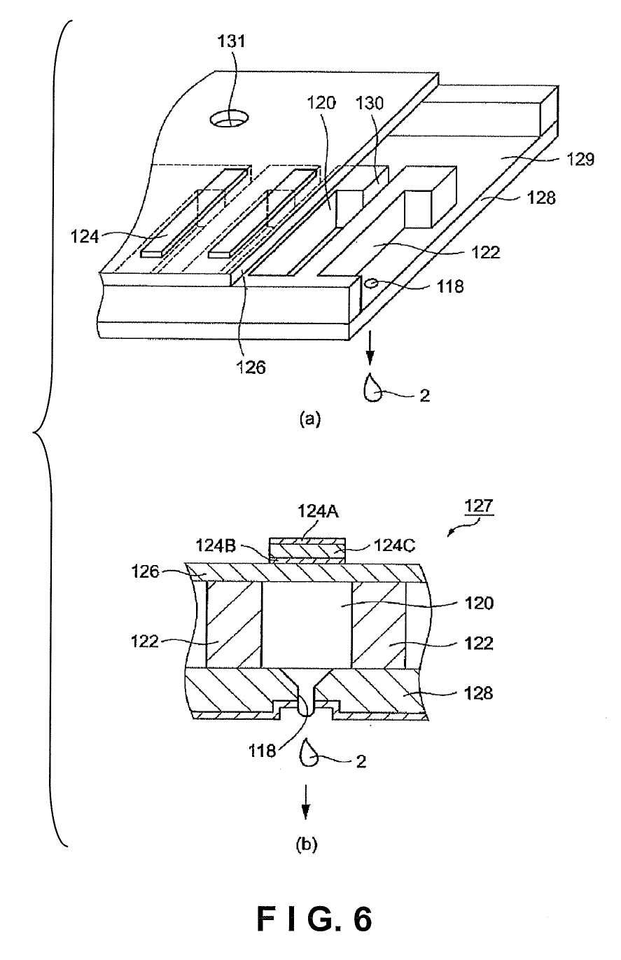

FIG. 2 is a cross-sectional view showing a method for manufacturing a color filter; FIG. 3 is a perspective view showing the droplet discharge device used in the manufacture of the color filter; FIG. 4 is a view of a droplet discharge means in the droplet discharge device shown in FIG. 3, as seen from the stage side; FIG. 5 is a view showing the bottom surface of the droplet discharge head in the droplet discharge device shown in FIG. 3; and FIG. 6 is a view showing the droplet discharge head in the droplet discharge device shown in FIG. 3, wherein FIG. 6 (a) is a cross-sectional perspective view and FIG. 6 (b) is a cross-sectional view.

The present embodiment has a substrate preparation step (1a) for preparing a substrate 11, a partition wall formation step (1b, 1c) for forming a partition wall 13 on the substrate 11, an ink application step (1d) for applying color filter ink 2 into an area surrounded by the partition wall 13 by using an inkjet method, and a colored portion formation step (1e) for forming solid colored portion 12 by removing liquid medium from the color filter ink 2 and curing the resin material, as shown in FIG. 2.

### Substrate Preparation Step

First, a substrate 11 is prepared (1a). It is preferred that the substrate 11 to be prepared in the present step undergo a washing treatment. The substrate 11 to be prepared in the present step may be washed by chemical treatment using a silane-coupling agent or the like, a plasma treatment, ion plating, sputtering, gas phase reaction, vacuum deposition, or another suitable washing treatment.

### Partition Wall Formation Step

Next, a radiation-sensitive composition is applied to substantially the entire surface of one of the surfaces of the substrate 11 to form (1b) a coated film 3. A pre-baking treatment may be performed as required after the radiation-sensitive composition has been applied to the substrate 11. The pre-baking treatment may be carried out under the conditions of, for example, a heating temperature of 50 to 150° C. and a heating time of 30 to 600 seconds.

Next, a partition wall 13 is formed (1c) by irradiating the radiation-sensitive composition via a photomask, performing a post exposure bake (PEB) treatment, and carrying out a development treatment using an alkaline liquid developer. PEB can be carried out at, for example, a heating temperature of 50 to 150° C., a heating time of 30 to 600 seconds, and an irradiation intensity of 1 to 500 mJ/cm². The development treatment can be accomplished using, for example, a fluid overflow method, a dipping method, a vibration soaking method, or the like, and the development treatment time can be set to 10 to 300 seconds, for example. After the development treatment, a post-baking treatment may be performed as required. The post-baking treatment can be carried out at, for example, a heating temperature of 150 to 280° C. and a heating time of 3 to 120 minutes.

### Ink Application Step

Next, the color filter ink 2 is applied (id) to the cells 14 surrounded by the partition wall 13 using the inkjet method.

The present step is carried out using a plurality of types of color filter inks 2 that correspond to the plurality of colors of the colored portion 12 to be formed. Since a partition wall 13 is provided, mixing of two or more color filter inks 2 can be reliably prevented.

The color filter ink 2 is discharged using a droplet discharge device such as that shown in FIGS. 3 to 6.

The droplet discharge device 100 used in the present step is provided with a tank 101 for holding the color filter ink 2, a tube 110, and a discharge scan unit 102 to which the color filter ink 2 is fed from the tank 101 via the tube 110, as shown in FIG. 3. The discharge scan unit 102 is provided with droplet discharge means 103 having a plurality droplet discharge heads (inkjet heads) 114 mounted on a carriage 105, a first position control device 104 (movement means) for controlling the position of the droplet discharge means 103, a stage 106 for holding a substrate 11 on which partition walls 13 have been formed in the aforementioned step (hereinafter simply referred to as “substrate 11”), a second position control device 108 (movement means) for controlling the position of the stage 106, and a controller 112. The tank 101 and the droplet discharge heads 114 of the droplet discharge means 103 are connected by the tube 110, and the color filter ink 2 is fed from the tank 101 to each of the droplet discharge heads 114 with compressed air.

The first position control device 104 is contrived to move the droplet discharge means 103 along an X-axis direction and a Z-axis direction that is orthogonal to the X-axis direction in accordance with a signal from the controller 112. The first position control device 104 also functions to rotate the droplet discharge means 103 about an axis parallel to the Z-axis. In this embodiment, the Z-axis is oriented in a vertical direction (i.e., a direction of acceleration due to gravity). The second position control device 108 is contrived move the stage 106 along a Y-axis direction that is orthogonal to the X-axis direction and the Z-axis direction in accordance with a signal from the controller 112. The second position controller 108 also functions to rotate the stage 106 about an axis parallel to the Z-axis.

The stage 106 has a flat surface that is parallel to both the X-axis and the Y-axis. The stage 106 is contrived such that a substrate 11 having cells 14 into which color filter ink 2 will be discharged can be fixed to or held on the flat surface of the stage 106.

The droplet discharge means 103 is moved along the X-axis direction by the first position control device 104, as explained previously. Similarly, the stage 106 is moved along the Y-axis direction by the second position control device 108. Thus, the relative positions of the droplet discharge heads with respect to the stage 6 are changed (i.e., the substrate 11 held on the stage 106 and the droplet discharge means 103 are moved relative to each other) by the first position control device 104 and the second position control device 108.

The controller 112 receives discharge data indicating a relative position where the color filter ink 2 should be discharged from an external information processor.

As shown in FIG. 4, the droplet discharge means 103 has a plurality of droplet discharge heads (inkjet heads) 114, each having the same structure and a carriage 105 contrived to hold the droplet discharge heads 114. In the this embodiment, the number of droplet discharge heads 114 held in the droplet discharge means 103 is eight. Each of the droplet discharge heads 114 has a bottom surface on which a plurality of nozzles 118 (described later) is disposed. The shape of the bottom surface of each of the droplet discharge heads 114 is a polygon having two short sides and two long sides. The bottom surface of the droplet discharge heads 114 held in the droplet discharge means 103 faces toward the stage 106, and the long-side direction and the short-side direction of the droplet discharge heads 114 are parallel to the X-axis direction and the Y-axis direction, respectively.

As shown in FIG. 5, the droplet discharge heads 114 have a plurality of nozzles 118 aligned in the X-axis direction. The nozzles 118 are arranged so as to have a prescribed nozzle pitch HXP in the X-axis direction of the droplet discharge heads 114. Although there are no particular limitations on the specific value of the nozzle pitch HXP, the nozzle pitch HXP can be set to a value from 50 to 90 μm, for example. In this embodiment, “the nozzle pitch HXP in the X-axis direction of the droplet discharge heads 114” corresponds to the pitch that would result between a plurality of nozzle images obtained by projecting all of the nozzles 118 of the droplet discharge heads 114 onto the X axis along the Y-axis direction.

In this embodiment, the nozzles 118 in the droplet discharge heads 114 form a nozzle row 116A and a nozzle row 116B, both of which extend in the X-axis direction. The nozzle row 116A and the nozzle row 116B are arranged to be parallel to each other with an interval in-between. In the present embodiment, each of the nozzle rows 116A and 116B has 90 nozzles 118 that are aligned in the X-axis direction so as to be separated by a fixed interval LNP. Although there are no particular limitations on the specific value of LNP, LNP can be a value from 100 to 180 μm, for example.

The position of the nozzle row 116B is offset from the position of the nozzle row 116A by half the length of the nozzle pitch LNP in the positive direction of the X-axis (rightward in FIG. 5). For this reason, the nozzle pitch HXP in the X-axis direction of the droplet discharge heads 114 is half the length of the nozzle pitch LNP of the nozzle row 116A (or the nozzle row 116B).

Therefore, the nozzle line density in the X-axis direction of the droplet discharge heads 114 is twice the nozzle line density of the nozzle row 116A (or the nozzle row 116B). In the present specification, “the nozzle line density in the X-axis direction” corresponds to the number per unit length of the plurality of nozzle images obtained by projecting a plurality of nozzles onto the X-axis along the Y-axis direction. Naturally, the number of nozzle rows included in the droplet discharge heads 114 is not limited to two rows. The droplet discharge heads 114 may include a number M of nozzle rows, where M is a natural number equal to or larger than 1. In this case, the plurality of nozzles 118 in each of the M number of nozzle rows is aligned at a pitch having a length that is M times that of the nozzle pitch HXP. If M is a natural number equal to or larger than 2, then, among the M nozzle rows, (M−1) of the nozzle rows are offset from one of the nozzle rows by a distance equal to i times the nozzle pitch HXP in the X-axis direction without overlapping, where i is a natural number from 1 to (M−1).

In the present embodiment, since the nozzle row 116A and the nozzle row 116B are each composed of 90 nozzles 118,a single droplet discharge head 114 has 180 nozzles 118. However, five nozzles at each end of the nozzle row 116A are set as “reserve nozzles.” Similarly, five nozzles at each end of the nozzle row 116B are set as “reserve nozzles.” The color filter ink 2 is not discharged from these 20 “reserve nozzles.” Thus, of the 180 nozzles 118 provided in each of the droplet discharge heads 114, 160 nozzles 118 function as nozzles for discharging the color filter ink 2.

As shown in FIG. 4, in the droplet discharge means 103, the plurality of droplet discharge heads 114 is disposed in two rows along the X-axis direction. The two rows of droplet discharge heads 114 are arranged to partially overlap each other when viewed from the Y-axis direction, the degree of overlap being determined in consideration of the reserve nozzles. As a result, the nozzles 118 for discharging the color filter ink 2 are arranged in the droplet discharge means 103 so as to span uninterruptedly across the X-direction dimension of the substrate 11 in the X-axis direction at the nozzle pitch HXP.

In the droplet discharge means 103 of the present embodiment, the droplet discharge heads 114 are disposed so as to cover the entire length of the X-direction dimension of the substrate 11. However, it is also acceptable for a droplet discharge means in accordance with the present invention to cover a portion of the X-direction dimension of the substrate 11.

Each of the droplet discharge heads 114 is an inkjet head, as shown in the figures. More specifically, each of the droplet discharge heads 114 comprises a vibration plate 126 and a nozzle plate 128. A fluid reservoir 129 is positioned between the vibration plate 126 and the nozzle plate 128. The color filter ink 2 is fed from the tank 101 into the fluid reservoir 129 via a hole 131 such that the fluid reservoir 129 is constantly filled.

A plurality of partition walls 122 are also provided between the vibration plate 126 and the nozzle plate 128, and cavities 120 are formed by the spaces enclosed by the vibration plate 126, the nozzle plate 128, and pairs of partition walls 122. Since the cavities 120 are disposed in correspondence with the nozzles 118, the number of cavities 120 and the number of nozzles 118 are the same.

The color filter ink 2 is fed to the cavities 120 from the fluid reservoir 129 via supply ports 130 positioned between pairs of partition walls 122.

An oscillator 124 is arranged on the vibration plate 126 with respect to each of the cavities 120. Each of the oscillators 124 includes a piezoelectric element 124C and a pair of electrodes 124A and 124B that sandwich the piezoelectric element 124C. The color filter ink 2 is discharged from a nozzle 118 by applying a drive voltage between the corresponding pair of electrodes 124A, 124B. The shape of the nozzles 118 is adjusted so that the color filter ink 2 is discharged in the Z-axis direction from the nozzles 118.

The controller 112 (see FIG. 3) may be configured so as to apply signals independently to each of the oscillators 124. In other words, the volume of the color filter ink 2 discharged from each of the nozzles 118 can be controlled independently in accordance with a signal from the controller 112. The controller 112 can also set which nozzles 118 will perform a discharge operation during a coating scan, as well as which nozzles 118 will not perform a discharge operation.

In the present specification, a portion that includes a single nozzle 118, a cavity 120 that corresponds to the nozzle 118, and the oscillator 124 that corresponds to the cavity 120 will be referred to as a “discharge portion 127.” In accordance with this designation, a single droplet discharge head 114 has the same number of discharge portions 127 as the number of nozzles 118.

Using a droplet discharge device 100 like that described above, color filter inks 2 corresponding to the plurality of colored portion 12 of the color filter 1 are deposited into the cells 14. By using such a device, the color filter inks 2 can be selectively deposited into the cells 14 with good efficiency. As described above, a color filter ink 2 has excellent discharge stability and flight deflection, loss of stability in the droplet discharge quantity, and other problems are much less likely to occur, even when droplet discharge is carried out over a long period of time. Therefore, it is possible to reliably prevent such problems as mixing (color mixing) of a plurality of types of ink used in the formation of colored portions having different colors, and variability in the color saturation between the plurality of colored portions in which the same color saturation is required. In the configuration shown in the diagrams, the droplet discharge device 100 has a tank 101 for holding the color filter ink 2, a tube 110, and other components for only one color, but analogous components for a plurality of colors may be provided to accommodate a plurality of different-colored colored portion 12 of a color filter 1. In the manufacture of a color filter 1, it is also acceptable to use a plurality of droplet discharge devices 100 each corresponding to a different color of color filter ink 2.

In the present invention, the droplet discharge heads 114 may use an electrostatic actuator instead of a piezoelectric element as a drive element. It is also acceptable if the droplet discharge heads 114 are contrived to use an electrothermal converter as a drive element and to discharge the color filter ink by utilizing a thermoexpansion of material produced by the electrothermal converter.

### Colored Portion Formation Step (Curing Step)

Next, the solvent (dispersion medium) is removed from the color filter ink 2 in the cells 14 and solid colored portion 12 are formed by curing the resin material (1e). The color filter 1 is obtained in this manner.

Although heating is ordinarily carried out in this step, it is also acceptable to, for example, execute a treatment involving irradiation of active energy rays or a treatment in which the substrate 11 onto which the color filter ink 2 has been applied is placed under a reduced-pressure environment. By irradiating with active energy rays, the curing reaction of the curable resin material can be made to proceed with good efficiency and the curing reaction of the curable resin material can be reliably promoted even when the heating temperature is relatively low. Also, the occurrence of adverse effects on the substrate 11 and other components can be reliably prevented. Examples of the active energy rays that may be used include light rays of various wavelengths, UV rays, X-rays, g-rays, i-rays, and excimer lasers. By placing the substrate 11 on which the color filter ink 2 has been applied under a reduced-pressure environment, the solvent (dispersion medium) can be removed with good efficiency, the shape of the colored portions in the pixels (cells) can be reliably made into desirable shapes, the solvent (dispersion medium) can be reliably removed even when the heating temperature is relatively low, and the occurrence of adverse effects on the substrate 11 and the like can be reliably prevented.

Although there are no particular limitations on the heating temperature in this step, a heating temperature 50 to 260° C. is preferred and a heating temperature of 80 to 240° C. is even more preferred.

### Image Display Device

Preferred embodiments of a liquid crystal display device exemplifying an image display device (electro-optic device) having the color filter 1 will now be explained.

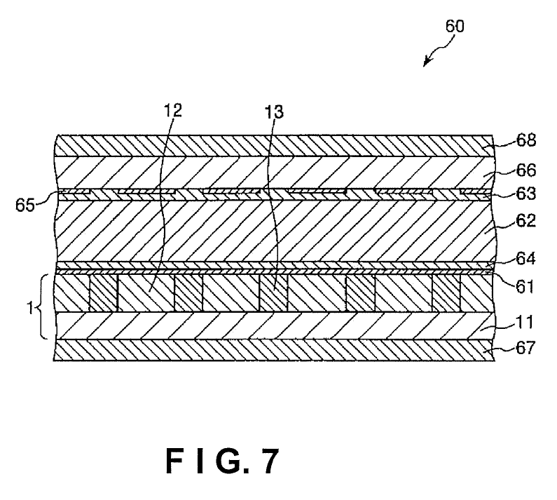

FIG. 7 is a cross-sectional view showing a preferred embodiment of the liquid crystal display device. As shown in the diagram, the liquid crystal display device 60 has a color filter 1, a substrate (opposing substrate) 66 arranged on the surface on which the colored portion 12 of the color filter 1 are disposed, a liquid crystal layer 62 composed of a liquid crystal sealed in the gaps between the color filter 1 and the substrate 66, a polarizing plate 67 disposed on the surface (lower side in FIG. 7) opposite from the surface that faces the liquid crystal layer 62 of the substrate 11 of the color filter 1, and a polarizing plate 68 disposed on the side (upper side in FIG. 7) opposite from the surface that faces liquid crystal layer 62 of the substrate 66. A shared electrode 61 is disposed on the surface of the color filter 1 on which the colored portion 12 and the partition wall 13 are disposed (i.e., the surfaces of the colored portion 12 and the partition walls 13 that are opposite from the surfaces of the same that face the substrate 11). Pixel electrodes 65 are arranged in the form of a matrix on the substrate (opposing substrate) 66 in positions corresponding to the colored portion 12 of the color filter 1. The pixel electrodes 65 are arranged on the side of the substrate 66 that faces the liquid crystal layer 62 and color filter 1. An alignment film 64 is disposed between the shared electrode 61 and the liquid crystal layer 62, and an alignment film 63 is disposed between the substrate 66 (pixel electrodes 65) and the liquid crystal layer 62.

The substrate 66 is a substrate having optical transparency with respect to visible light and is, for example, a glass substrate.

The shared electrode 61 and the pixel electrodes 65 are composed of a material having optical transparency with respect to visible light and are made of, for example, ITO.

Although not depicted in the drawings, a plurality of switching elements (e.g., TFT: thin film transistors) is provided so as to correspond to the pixel electrodes 65. The pixel electrode 65 corresponding to each of the colored portion 12 can be used to control the transmission properties of light in an area corresponding to the colored portion 12 (pixel electrode 65) by controlling the state of a voltage applied between the shared electrode 61 the pixel electrode 65.

In the liquid crystal display device 60, light emitted from a backlight (not depicted in the figures) is incident from the polarizing plate 68 side (the upper side in FIG. 7). The light that passes through the liquid crystal layer 62 and enters the colored portion 12 (12A, 12B, 12C) of the color filter 1 is emitted from the polarizing plate 67 (lower side of FIG. 7) as light having colors that correspond to the respective colored portion 12 (12A, 12B, 12C).

As described above, the colored portion 12 are formed using color filter inks 2 (ink set) that are in accordance with the present invention and therefore have reduced variability of characteristics between pixels. As a result, an image having reduced unevenness of color and saturation can be displayed on the liquid crystal display device 60 in a stable fashion. Additionally, an image with excellent contrast can be obtained because the colored portion 12 are formed using a color filter ink that is in accordance with the present invention.

### Electronic Device

A liquid crystal display device or another image display device (electro*optic device) 1000 having a color filter 1 such as that described above can be used in a display unit of a variety of electronic devices.

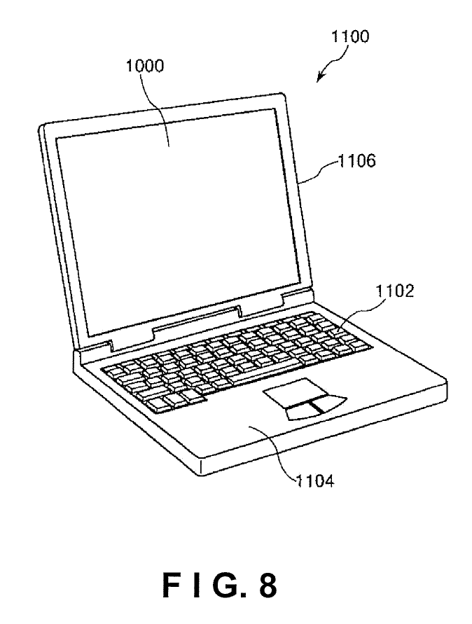

FIG. 8 is a perspective view showing a mobile (or notebook) personal computer exemplifying an electronic device in accordance with the present invention.

As shown in the figure, the personal computer 1100 is comprises a main unit 1104 provided with a keyboard 1102, and a display unit 1106. The display unit 1106 is rotatably supported with respect to the main unit 1104 with a hinge structure.

In the personal computer 1100, the display unit 1106 is provided with an image display device 1000.

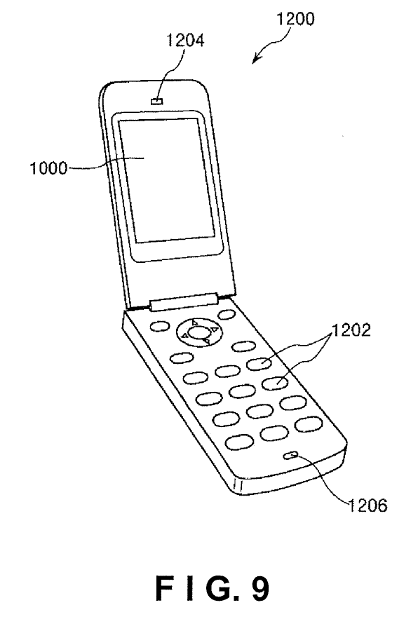

FIG. 9 is a perspective view showing a portable telephone (including PHS) exemplifying an electronic device in accordance with the present invention.

As shown in the figure, the portable telephone 1200 has a plurality of operating buttons 1202, an earpiece 1204, a mouthpiece 1206, and an image display device 1000 provided as a display unit.

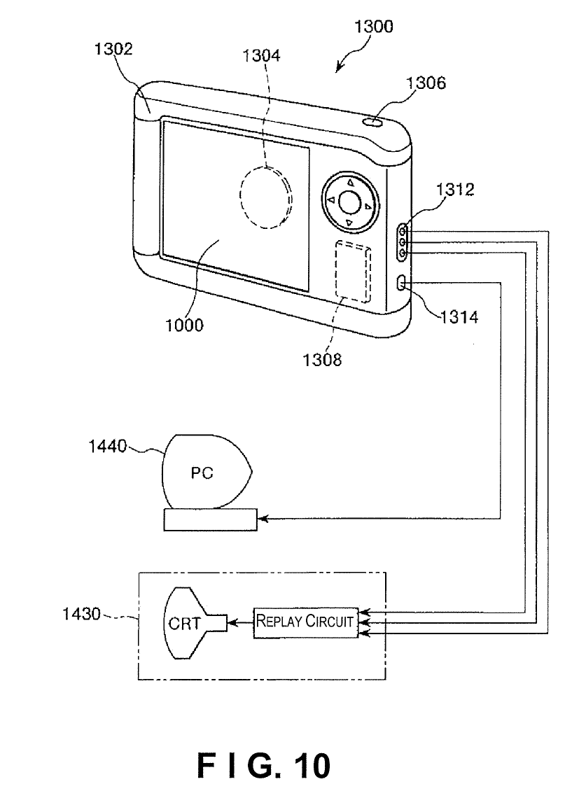

FIG. 10 is a perspective view showing the configuration of a digital still camera exemplifying an electronic device in accordance with the present invention. In the figure, connections to external devices are shown in a simplified manner.

While an ordinary camera exposes a silver-salt photography film to the optical image of a object being photographed, a digital still camera 1300 photoelectrically converts the optical image of an object to be photographed and generates an imaging signal (image signal) with the aid of a CCD (Charge Coupled Device) or another imaging element.

An image display device 1000 is disposed in the display section on the back surface of a case (body) 1302 of the digital still camera 1300. The image display device 1000 is contrived to perform display operations based on a pickup signal from the CCD and function as a finder for displaying the object to be photographed as an electronic image.

A circuit board 1308 is disposed inside the case. The circuit board 1308 has a memory that can store (record) the imaging signal.

A photo-detection unit 1304 that includes an optical lens (imaging optical system), a CCD, and the like is provided on a front side of the case 1302 (back side from the perspective of the figure).

A photographer confirms the image of the object to be photographed displayed on the display unit and depresses a shutter button 1306. When the shutter button 1306 is pressed, the imaging signal of the CCD at that point in time is transferred to and stored in the memory of the circuit board 1308.

A video signal output terminal 1312 and a data communication I/O terminal 1314 are provided on a lateral side face of the case 1302 of the digital still camera 1300. As shown in the figure, a television monitor 1430 is connected to the video signal output terminal 1312 as required, and a personal computer 1440 is connected to the data communication I/O terminal 1314 as required. Additionally, the digital still camera 1300 is contrived to output an imaging signal stored in the memory of the circuit board 1308 to a television monitor 1430 or a personal computer 1440 when a prescribed operation is performed.

In addition to the personal computer (mobile personal computer), portable telephone, and digital still camera described above, other examples of an electronic device in accordance with the present invention include televisions (e.g., liquid crystal display devices), video cameras, view finder-type and direct-view monitor-type video tape recorders, laptop personal computers, car navigation devices, pagers, electronic assistants (including those with a communication function), electronic dictionaries, calculators, electronic game devices, word processors, work stations, videophones, security television monitors, electronic binoculars, POS terminals, apparatuses having a touch panel (e.g., cash dispensers for financial institutions, and automatic ticketing machines), medical equipment (e.g., electronic thermometers, sphygmomanometers, blood glucose sensors, electrocardiograph display devices, ultrasound diagnostic devices, and endoscopic display devices), fish finders, various measuring apparatuses, instruments (e.g., instruments in vehicles, aircraft, and ships), flight simulators, and various other monitors, and projectors, and other projection display devices. Among these, televisions have display units that are tending to become markedly larger in recent years and in electronic devices having such a large display unit (e.g., a display unit having a diagonal length of 80 cm or more), unevenness of color and saturation, and other problems occur particularly readily when a color filter manufactured using a conventional color filter ink is used. However, with the present invention, the occurrence of such problems can be reliably prevented. In other words, the effects of the present invention is more exhibited more demonstrably when the invention is applied to an electronic device having a large display unit, such as that described above.

Although the present invention is described heretofore based on preferred embodiments, the present invention is not limited to these embodiments.

For example, in the embodiments described above, color filter inks corresponding to the colored portions of various colors are applied inside the cells and, afterwards, the solvent (dispersed medium) is removed from the different colors of color filter ink in the cells and the curable resin material is cured in a single process. In other words, a colored portion formation step (curing step) is carried out only once. However, it is acceptable to repeat the ink application step and the colored portion formation step for each color.

It is also possible to replace any of the parts constituting a color filter, an image display device, or electronic device with any other part that demonstrates the same function, or to add other constituent parts. For example, in a color filter according to the present invention, a protective film for covering the colored portions may be provided on the surface of the colored portions that is opposite from the surface facing the substrate. Damage, degradation, and the like of the colored portions can thereby be more effectively prevented.

A color filter ink according to the present invention can be manufactured using any of various methods and is not limited to the manufacturing method described previously in the embodiments. For example, although the previously described embodiments have a preparatory dispersion step and a multiple-stage fine dispersion step, a color filter ink in accordance with the present invention can be manufactured using a method that does not have a preparatory dispersion step or method having a fine dispersion step that is not multiple staged. Also, although in the previously described embodiments a thermoplastic resin is used in the preparatory dispersion step, it is acceptable to use a curable resin material, e.g., the previously described polymer A and polymer B, in the preparatory dispersion step. In this way, for example, the curable resin mixing step can be omitted.

Although the embodiments presented above describe chiefly a case in which a color filter ink set is provided with three types (three colors) of color filter inks corresponding to the three primary colors of light was mainly described, the number and type (color) of color filter inks constituting the ink set for a color filter is not limited to the arrangement described above. For example, in the present invention, the color filter ink set may be provided with four or more types of color filter inks.

### EXAMPLES

Specific working examples of the present invention will now be described.

### 1. Synthesis of Polymer (Preparation of Polymer Solution)

### Synthesis Example 1

37.6 parts by weight of 1,3-butylene glycol diacetate was placed as a solvent in a 1-L reaction container provided with an agitator, a reflux condenser, a dropping funnel, a nitrogen introduction tube, and a temperature gauge, and heated to 90° C. Next, 2 parts by weight of 2,2′-azobis(isobutyronitrile) (AIBN) and 3 parts by weight 1,3-butylene glycol diacetate (solvent) were added, and a solution in which 27 parts by weight of (3,4-epoxy cyclohexyl) methyl methacrylate (product name: Cyclomer M100, manufactured by Daicel Chemical Industries), 1.5 parts by weight of 2-(0-[1′-methylpropylideneamino]carboxyamino) ethyl methacrylate (product name: MOI-BM, manufactured by Showa Denko), and 1.5 parts by weight of 2-hydroxy ethyl methacrylate (HEMA) were admixed for form a solution and the solution was dropped over for approximately four hours using a dropping pump. Meanwhile, a solution (polymerization initiator solution) in which 5 parts by weight of dimethyl 2,2′-azobis(isobutyrate) (product name V-601, manufactured by Wako Pure Chemical Industries) as the polymerization initiator were dissolved in 20 parts by weight of 1,3-butylene glycol diacetate (solvent) was dropped over for approximately four hours using a separate dropping pump. After the dropping of the polymerization initiator solution was completed, 0.2 part by weight of AIBN and 1 part by weight of 1,3-butylene glycol diacetate (solvent) was added and held for approximately two hours at about the same temperature. Then, 0.2 part by weight of AIBN and 1 part by weight of 1,3-butylene glycol diacetate (solvent) was added and held for approximately two hours at about the same temperature. The solution was then cooled to approximately room temperature to obtain a polymer solution A1 containing a polymer A.

### Synthesis Examples 2 to 8

The same operation as Synthesis Example 1 described above was carried out, except that the type of monomer components, usage amounts, and type of solvent used in the synthesis of the polymer (preparation of the polymer solution) were varied in the manner shown in Table 1. As a result, seven polymer solutions (polymer solutions A2 to A8) containing a polymer A were obtained.

### Synthesis Example 9

The same operation as Synthesis Example 1 described above was carried out, except that 1H,1H,5H-octafluoropentyl methacrylate (product name: Biscoat 8FM, manufactured by Osaka Organic Chemical Industry) was used in place of 2-(0-[1′methylpropylideneamino]carboxyamino) ethyl methacrylate (product name: MOI-BM, manufactured by Showa Denko) and 2-hydroxyethyl methacrylate (HEMA).

As a result, a polymer solution (polymer solution B1) containing a polymer B was obtained.

### Synthesis Examples 10 to 15

The same operation as Synthesis Example 9 described above was carried out, except that the type of monomer components, usage amounts, and type of solvent used in the synthesis of the polymer (preparation of the polymer solution) were varied in the manner shown in Table 1. As a result, six polymer solutions (polymer solutions B2 to B7) containing a polymer B were obtained.

### Synthesis Example 16

The same operation as Synthesis Example 1 described above was carried out, except that 30 parts by weight of γ-methacryloxypropyl trimethoxysilane (product name: SZ6030, manufactured by Dow Corning Toray) was used in place of (3,4-epoxy cyclohexyl) methyl methacrylate (product name: Cyclomer M100, manufactured by Daicel Chemical Industries), 2-(0-[1′-methylpropylideneamino]carboxyamino) ethyl methacrylate (product name: MOI-BM, manufactured by Showa Denko), and 2-hydroxyethyl methacrylate (HEMA). As a result, a polymer solution C1 (homopolymer solution) containing a polymer C was obtained.

### Syntheses Examples 17 to 21

The same operation as Synthesis Example 16 described above was carried out, except that the type of monomer components, usage amounts, and type of solvent used in the synthesis of the polymer (preparation of the polymer solution) were varied in the manner shown in Table 1. As a result, five polymer solutions (polymer solutions C2 to C6) containing the polymer C were obtained.

The types and usage amounts of materials used to synthesize the polymer (prepare the polymer solution) in each of Synthesis Examples 1 to 21 (i.e., the composition of the polymers synthesized in each of in each of Synthesis Examples 1 to 21) are summarized in Table 1. In the table, “S” stands for solvent. More particularly, “S1” stands for 3-butylene glycol diacetate, “S2” stands for bis(2-butoxyethyl)ether, “S3” diethylene glycol monobutyl ether acetate, and “S4” stands for tripropylene glycol monomethyl ester. Also, “V-601” refers to dimethyl 2,2′-azobis(isobutyrate), “AIBN” refers to 2,2′-azobis(isobutyronitrile), “a1-1” refers to (3,4-epoxy cyclohexyl) methyl methacrylate (Cyclomer M100), “a1-2” refers to (3,4-epoxy cyclohexyl) methyl acrylate, “a2-1” refers to 2-(0-[1′-methylpropylideneamino]carboxyamino)methacrylate (MOI-BM), “a2-2” refers to 2-acryloyloxyethyl isocyanate (product name: “Karenz MOI”, manufactured by Showa Denko), “a3-1” refers to 2-hydroxy ethyl methacrylate (HEMA), “a3-2” refers to 4-hydroxybutyl acrylate, “a4-1” refers to 2-ethylhexyl methacrylate, “b1-1” refers to 1H, 1H,5H-octafluoropentyl methacrylate (Biscoat 8FM), “b1-2” refers to 1,2,3,4,5-pentafluorostyrene, “b2-1” refers to (3,4-epoxy cyclohexyl) methyl methacrylate (Cyclomer M100), “b2-2” refers to cyclohexyl methacrylate, “c1-1” refers to γ-methacryloxypropyl trimethoxysilane (SZ6030), “c1-2” refers to γ-methacryloxypropyl triethoxysilane, “c2-1” refers to ethyl methacrylate. Also shown in the table are the molecular weights Mw of the polymers that constitute the polymer solutions.

TABLE 1

| | COMPONENTS (PARTS BY WEIGHT) | | | | | | | | | | |
|---|---|---|---|---|---|---|---|---|---|---|---|
| | MONOMER COMPONENT | | | | | | | | | | |
| | a 1-1 | a 1-2 | a 2-1 | a 2-2 | a 3-1 | a 3-2 | a 4-1 | b 1-1 | b 1-2 | b 2-1 | b 2-2 |
| POLYMER SOLUTION A1 | 27 | — | 1.5 | — | 1.5 | — | — | — | — | — | — |
| POLYMER SOLUTION A2 | 27 | — | 3 | — | — | — | — | — | — | — | — |
| POLYMER SOLUTION A3 | 27 | — | — | — | 3 | — | — | — | — | — | — |
| POLYMER SOLUTION A4 | 24 | — | — | — | — | — | 6 | — | — | — | — |
| POLYMER SOLUTION A5 | 19 | — | 5 | — | 4.5 | — | 1.5 | — | — | — | — |
| POLYMER SOLUTION A6 | 20.5 | — | 3 | — | 5.5 | — | 1 | — | — | — | — |
| POLYMER SOLUTION A7 | — | 27.5 | — | 1.5 | — | 1 | — | — | — | — | — |
| POLYMER SOLUTION A8 | 25 | — | 1 | — | 2 | — | 2 | — | — | — | — |
| POLYMER SOLUTION B1 | — | — | — | — | — | — | — | 6 | — | 24 | — |
| POLYMER SOLUTION B2 | — | — | — | — | — | — | — | 2 | — | 28 | — |
| POLYMER SOLUTION B3 | — | — | — | — | — | — | — | 19 | — | 11 | — |
| POLYMER SOLUTION B4 | — | — | — | — | — | — | — | 30 | — | — | — |
| POLYMER SOLUTION B5 | — | — | — | — | — | — | — | 4 | — | — | 26 |
| POLYMER SOLUTION B6 | — | — | — | — | — | — | — | 6 | — | 24 | — |
| POLYMER SOLUTION B7 | — | — | — | — | — | — | — | — | 6 | 24 | — |
| POLYMER SOLUTION C1 | — | — | — | — | — | — | — | — | — | — | — |
| POLYMER SOLUTION C2 | — | — | — | — | — | — | — | — | — | — | — |
| POLYMER SOLUTION C3 | — | — | — | — | — | — | — | — | — | — | — |
| POLYMER SOLUTION C4 | — | — | — | — | — | — | — | — | — | — | — |
| POLYMER SOLUTION C5 | — | — | — | — | — | — | — | — | — | — | — |
| POLYMER SOLUTION C6 | — | — | — | — | — | — | — | — | — | — | — |

| | COMPONENTS (PARTS BY WEIGHT) | | | | | | | |
|---|---|---|---|---|---|---|---|---|
| | MONOMER | | | | | | | |
| | COMPONENT | | | | | | SOLVENT (S) | POLYMER |
| | c 1-1 | c 1-2 | c 2-1 | S | V-601 | AIBN | COMPOSITION | Mw |
| POLYMER SOLUTION A1 | — | — | — | 62.6 | 5 | 2.4 | S1 | 2700 |
| POLYMER SOLUTION A2 | — | — | — | 62.6 | 5 | 2.4 | S3 | 2800 |
| POLYMER SOLUTION A3 | — | — | — | 62.6 | 5 | 2.4 | S3 | 2800 |
| POLYMER SOLUTION A4 | — | — | — | 62.6 | 5 | 2.4 | S3 | 2800 |
| POLYMER SOLUTION A5 | — | — | — | 62.6 | 5 | 2.4 | S4 | 2700 |
| POLYMER SOLUTION A6 | — | — | — | 62.6 | 5 | 2.4 | S1 | 2700 |
| POLYMER SOLUTION A7 | — | — | — | 62.6 | 5 | 2.4 | S1 | 2800 |
| POLYMER SOLUTION A8 | — | — | — | 62.6 | 5 | 2.4 | S2 | 2700 |
| POLYMER SOLUTION B1 | — | — | — | 62.6 | 5 | 2.4 | S1 | 2800 |
| POLYMER SOLUTION B2 | — | — | — | 62.6 | 5 | 2.4 | S3 | 2800 |
| POLYMER SOLUTION B3 | — | — | — | 62.6 | 5 | 2.4 | S1 | 2800 |
| POLYMER SOLUTION B4 | — | — | — | 62.6 | 5 | 2.4 | S4 | 2800 |
| POLYMER SOLUTION B5 | — | — | — | 62.6 | 5 | 2.4 | S3 | 2800 |
| POLYMER SOLUTION B6 | — | — | — | 62.6 | 5 | 2.4 | S2 | 2800 |
| POLYMER SOLUTION B7 | — | — | — | 62.6 | 5 | 2.4 | S3 | 2800 |
| POLYMER SOLUTION C1 | 30 | — | — | 62.6 | 5 | 2.4 | S1 | 2800 |
| POLYMER SOLUTION C2 | 26 | — | 4 | 62.6 | 5 | 2.4 | S1 | 2700 |
| POLYMER SOLUTION C3 | 23 | — | 7 | 62.6 | 5 | 2.4 | S1 | 2700 |
| POLYMER SOLUTION C4 | — | 30 | — | 62.6 | 5 | 2.4 | S2 | 2800 |
| POLYMER SOLUTION C5 | — | 28 | 2 | 62.6 | 5 | 2.4 | S4 | 2800 |
| POLYMER SOLUTION C6 | 30 | — | — | 62.6 | 5 | 2.4 | S2 | 2800 |

### 2. Preparation of Color Filter Inks (Ink Set)

### Example 1

12.96 g (36 parts by weight) of the dispersing agent Disperbyk 162, 4.32 g (12 parts by weight) of the dispersing agent Disperbyk 111, 28.43 g (79 parts by weight) of the thermoplastic resin SPCN-17X (manufactured by Showa Highpolymer Co., limited), and 61.90 g (172 parts by weight) of the solvent 1,3-butylene glycol diacetate put into an agitating machine (single-axis mixer) having a capacity of 400 cc and agitated for 10 minutes with a dispermill as a preparatory dispersion treatment, thereby obtaining a dispersing-agent-dispersed liquid (preparatory dispersion step). The rotational speed of the agitation propeller of the agitating machine was 2000 rpm.

A fine dispersion step was then executed by adding pigments to the dispersing-agent-dispersed liquid obtained in the preparatory dispersion step and adding inorganic beads in multiple stages as a fine dispersion treatment.

First, 35.99 g (100 parts by weight) of a pigment were added to the dispersing-agent-dispersed liquid and agitated for 10 minutes. The rotational speed of the agitation propeller of the agitating machine was 2000 rpm. The pigment used was a mixture of 32.39 g of a halogenated phthalocyanine zinc complex (main pigment) powder having the chemical structure shown in Formula (3) (in this example, the sixteen X's of the molecule comprise two hydrogen atoms, four chlorine atoms, and ten bromine atoms) and 3.60 g if a sulfonated pigment derivative (secondary pigment) powder having the chemical structure shown in Formula 4. Meanwhile, the mixture of the dispersing-agent-dispersed liquid and the pigment was diluted with the solvent 1,3-butylene glycol diacetate such that the content of pigment in the mixture would be 16 wt %.

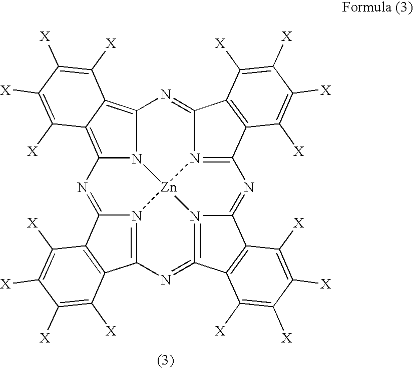

In Formula (3), each X is independently a hydrogen atom (H), a chlorine atom (C1), or a bromine atom (Br), the number of H in one molecule is from 0 to 4, the number of C1 in one molecule is 0 to 8, and the number of Br in one molecule is 4 to 16.

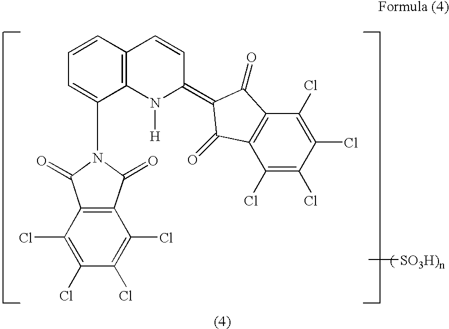

In Formula (4), n is an integer from 1 to 5.

Next, inorganic beads (first inorganic beads made of zirconia (Torayceram (trade name) pulverizing balls manufactured by Toray Industries)) were added and a first-stage dispersion treatment (first treatment) was executed by agitating the mixture for 30 minutes at room temperature. The rotational speed of the agitation propeller of the agitating machine was 2000 rpm.

The inorganic beads (first inorganic beads) were then removed by filtering with a filter (Pall HDC II Membrane Filter manufactured by Pall Corporation), inorganic beads (second inorganic beads made of zirconia (Torayceram (trade name) pulverizing balls manufactured by Toray Industries)) having an average diameter of 0.1 mm were added, and a second-stage dispersion treatment (second treatment) was executed by agitating the mixture for another 30 minutes. The rotational speed of the agitation propeller of the agitating machine was 2000 rpm. Meanwhile, the resulting mixture was diluted with the solvent 1,3-butylene glycol diacetate such that the content of pigment in the pigment dispersed material would be 13 wt %.

The inorganic beads (second inorganic beads) were then removed to by filtering with a filter (Pall HDC II Membrane Filter manufactured by Pall Corporation), thereby obtaining a pigment dispersed material.

The pigment dispersed material is mixed with a polymer solution A1, a polymer solution B1, and a polymer solution C1. In this step, the pigment dispersed material, the polymer solution A1, the polymer solution B1, and the polymer solution C1 are put into an agitating machine (single-axis mixer) having a capacity of 400 cc and agitated for 10 minutes with a dispermill. The rotational speed of the agitation propeller of the agitating machine was 2000 rpm. In this way, a green color filter ink (green ink) in accordance with the present invention was obtained.

A red color filter ink (red ink) and a blue color filter ink (blue ink) were prepared in the same manner as the green color filter ink described above, except that the type of pigment and the usage amount of each component were varied. Accordingly, an ink set composed of the three colors red, green, and blue were obtained. The average particle diameters of the pigment used in the red ink, the pigment used in the green ink, and the pigment used in the green ink were 70 nm, 70nm, and 70 nm, respectively.

### Examples 2 to 7

The color filter inks (ink set) were prepared in substantially the same manner as in Working Example 1 except that the types and amounts of materials used to prepare the color filter ink were changed and the treatment conditions used in the fine dispersion step (first treatment and second treatment) and the curable resin mixing step were modified as indicated in Tables 2, 3, 4, and 5.

### Comparative Example 1

In this comparative example, the color filter inks (ink set) was prepared in substantially the same manner as in Working Example 1 except that the pigment used to prepare the green color filter ink (green ink) comprised 35.99 g of a halogenated phthalocyanine zinc complex (main pigment) powder having the chemical structure shown in Formula (3) (the sixteen X's of the molecule comprise two hydrogen atoms, four chlorine atoms, and ten bromine atoms) instead of a mixture of 32.39 g of a halogenated phthalocyanine zinc complex (main pigment) powder having the chemical structure shown in Formula (3) and 3.60 g of a sulfonated pigment derivative (secondary pigment) powder having the chemical structure shown in Formula (4). In other words, in this comparative example, only a halogenated phthalocyanine zinc complex (main pigment) was used to prepare the green color filter ink (green ink) instead of a mixture of a halogenated phthalocyanine zinc complex (main pigment) and a sulfonated pigment derivative (secondary pigment).

### Comparative Example 2

In this comparative example, the color filter inks (ink set) was prepared in substantially the same manner as in Working Example 1 except that in the preparation of the green color filter ink (green ink), C.I. pigment green 36 was used as a main pigment instead of using a halogenated phthalocyanine zinc complex (main pigment) powder having the chemical structure shown in Formula (3).

### Comparative Example 3

In this comparative example, the color filter inks (ink set) was prepared in substantially the same manner as in Working Example 1 except that the pigment used to prepare the green color filter ink (green ink) comprised 36.01 g of a sulfonated pigment derivative (secondary pigment) powder having the chemical structure shown in Formula (4) instead of a mixture of 32.39 g of a halogenated phthalocyanine zinc complex (main pigment) powder having the chemical structure shown in Formula (3) and 3.60 g of a sulfonated pigment derivative (secondary pigment) powder having the chemical structure shown in Formula (4). In other words, in this comparative example, only a sulfonated pigment derivative was used to prepare the green color filter ink (green ink) instead of a mixture of a halogenated phthalocyanine zinc complex (main pigment) and a sulfonated pigment derivative (secondary pigment).

### Comparative Examples 4 and 5

The color filter inks (ink set) were prepared in substantially the same manner as in Working Example 1 except that the types and amounts of materials used to prepare the polymer solution were changed and types and amounts of curable resin material contained in the color filter ink were changed as indicated in the tables. In Comparative Example 4 only the polymer material A was used as a curable resin material, and in Comparative Example 5 only the polymer material B was used as a curable resin material.

In the working examples and comparative examples, the solvents (dilution solvents) added in each of the steps had the same composition as the solvent used to form the polymer solution (i.e., the polymer solution used to prepare the particular color filter ink).

The composition of the dispersing-agent-dispersed liquid, the types and amounts of the pigments added to the dispersing-agent-dispersed liquid in the fine dispersing step, and the types and solid amounts of curable resin material used in the curable resin mixing step are summarized in Tables 2 and 3 for each of the working examples and comparative examples. In the tables, “HPZC1” indicates a powder made of a halogenated phthalocyanine zinc complex in accordance with the aforementioned Formula (3) in which the sixteen X's in the molecule comprise two hydrogen atoms, four chlorine atoms, and ten bromine atoms; “HPZC2” indicates a powder made of a halogenated phthalocyanine zinc complex in accordance with Formula (3) in which the sixteen X's in the molecule comprise one hydrogen atom, three chlorine atoms, and twelve bromine atoms; “SPD1” indicates a powder made of a pigment derivative in accordance with the aforementioned Formula (4) in which the number of sulfo groups in the molecule is 1; “SPD2” indicates a powder made of a pigment derivative in accordance with Formula (11) below in which the number of sulfo groups in the molecule is 2; “PG36” indicates C.I. pigment green 36; “PR177” indicates C.I. pigment red 177; “PR254” indicates C.I. pigment red 254; “PB15:6” indicates C.I. pigment blue 15:6; “PR177D” indicates a mixture of C.I. pigment red 177 and a pigment derivative in accordance with the aforementioned Formula (9); “PR254D” indicates a mixture of C.I. pigment red 254 and a pigment derivative in accordance with the aforementioned Formula (10); “S 1” indicates 1,3-butylene glycol diacetate; “S2” indicates bis(2-butoxyethyl)ether; “S3” indicates diethylene glycol monobutyl ether acetate; “S4” indicates tripropylene glycol monomethyl ether; “DA1” indicates Disperbyk 162; “DA2” indicates Disperbyk 163; “DA3” indicates EFKA 4300; “DA4” indicates Disperbyk 111; and “DR1” indicates SPCN-17X. In both the working examples and the comparative examples that used a mixture of C.I. pigment red 177 and a pigment derivative in accordance with Formula (9), the content of the pigment derivative according to Formula (9) in the mixture was from 0.1 to 10 wt %. Similarly, in both the working examples and the comparative examples that used a mixture of C.I. pigment red 254 and a pigment derivative in accordance with Formula (10), the content of the pigment derivative according to Formula (10) in the mixture was from 0.1 to 10 wt %. The amine value of Disperbyk 162 (DA1) was 34 KOH mg/g, the amine value of Disperbyk 163 (DA2) was 22 KOH mg/g, the amine value of EFKA 4300 (DA3) was 70 KOH mg/g, and the acid value of Disperbyk 111 (DA4) was 129 KOH mg/g. The acid value was found using a method in compliance with DINENIS02114, and the amine values were found using a method in compliance with DIN16954. In the curable resin material columns of Tables 2 and 3, A1 indicates a polymer contained in a polymer solution A1. Similarly, A2 to A8, B1 to B7, and C1 to C6 indicate polymers contained in the polymer solutions A2 to A8, B1 to B7, and C1 to C6, respectively. The manufacturing conditions for manufacturing the color filter inks in the working examples and comparative examples are summarized in Tables 4 and 5. The contents (weight percents) of pigment at the end of the first treatment, the end of the second treatment, and the end of the curable resin mixing step (finished color filter ink) are also shown in Tables 4 and 5. Viscosity measurements were conducted in accordance with JIS Z8809 using an E-type viscometer (RE-01 manufactured by Toki Sangyo Co., Ltd.) in an environment at 25° C.

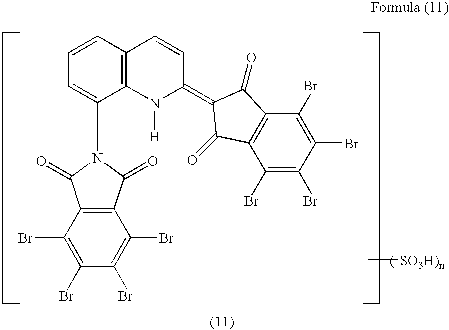

In Formula (11), n is an integer from 1 to 5.

TABLE 2

| | | COMPOSITION OF DISPERSING-AGENT-DISPERSED LIQUID | | | | | | | |
|---|---|---|---|---|---|---|---|---|---|
| | | DISPERSING AGENT | | | | | | | |
| | | AMINE DISPERSING | | ACID DISPERSING | | THERMOPLASTIC | | | |
| | | AGENT | | AGENT | | RESIN | | SOLVENT | |
| | | | AMOUNT | | AMOUNT | | AMOUNT | | AMOUNT |
| | | TYPE | (PARTS BY WT.) | TYPE | (PARTS BY WT.) | TYPE | (PARTS BY WT.) | TYPE | (PARTS BY WT.) |
| EXAMPLE 1 | R INK | DA1 | 69 | DA4 | 23 | DR1 | 54 | S1 | 253 |
| | G INK | DA1 | 36 | DA4 | 12 | DR1 | 79 | S1 | 172 |
| | B INK | DA1 | 42 | DA4 | 14 | DR1 | 88 | S1 | 312 |
| EXAMPLE 2 | R INK | DA1 | 54 | DA4 | 18 | DR1 | 40 | S2 | 287 |
| | G INK | DA1 | 68 | DA4 | 22 | DR1 | 30 | S2 | 179 |
| | B INK | DA1 | 42 | DA4 | 14 | DR1 | 88 | S2 | 312 |
| EXAMPLE 3 | R INK | DA1 | 54 | DA4 | 19 | DR1 | 41 | S3 | 288 |
| | G INK | DA1 | 68 | DA4 | 23 | DR1 | 31 | S3 | 180 |
| | B INK | DA1 | 42 | DA4 | 15 | DR1 | 89 | S3 | 313 |
| EXAMPLE 4 | R INK | DA1 | 70 | DA4 | 22 | DR1 | 55 | S4 | 252 |
| | G INK | DA2 | 50 | — | — | DR1 | 21 | S4 | 228 |
| | B INK | DA1 | 41 | DA4 | 15 | DR1 | 87 | S4 | 313 |
| EXAMPLE 5 | R INK | DA1 | 53 | DA4 | 19 | DR1 | 39 | S1 | 288 |
| | G INK | DA1 | 27 | — | — | DR1 | 41 | S1 | 231 |
| | B INK | DA1 | 45 | DA4 | 17 | DR1 | 89 | S1 | 311 |
| EXAMPLE 6 | R INK | DA1 | 51 | DA4 | 21 | DR1 | 42 | S3 | 285 |
| | G INK | — | — | DA4 | 42 | DR1 | 84 | S3 | 173 |
| | B INK | DA1 | 43 | DA4 | 13 | DR1 | 88 | S3 | 312 |

| | | COMPONENTS ADDED IN FINE | | COMPONENTS ADDED IN | | |
|---|---|---|---|---|---|---|
| | | DISPERSION STEP | | CURABLE RESIN MIXING STEP | | |
| | | PIGMENT | | CURABLE RESIN MATERIAL | | VISCOSITY |
| | | | AMOUNT | | AMOUNT | OF |
| | | TYPE | (PARTS BY WT.) | TYPE | (PARTS BY WT.) | INK (mP · s) |
| EXAMPLE 1 | R INK | PR177D/PR254D | 50/50 | A1/B1/C1 | 13/11/6 | 10.7 |
| | G INK | HPZC1/SPD1 | 90/10 | A1 B1/C1 | 9/7/4 | 8.7 |
| | B INK | PB15:6 | 100 | A1/B1/C1 | 18/16/8 | 8.5 |
| EXAMPLE 2 | R INK | PR177D | 100 | A8/B6/C6 | 19/8/11 | 10.8 |
| | G INK | HPZC1/SPD1 | 85/15 | A8/B6/C6 | 19/8/11 | 8.4 |
| | B INK | PB15:6 | 100 | A8/B6/C6 | 19/7/11 | 8.5 |
| EXAMPLE 3 | R INK | PR177D | 100 | A2/A4/B2 | 11/19/5 | 10.9 |
| | G INK | HPZC1/SPD1 | 77/23 | A2/A4/B2 | 11/19/4 | 8.1 |
| | B INK | PB15:6 | 100 | A2/A4/B2 | 11/18/4 | 8.3 |
| EXAMPLE 4 | R INK | PR177D/PR254D | 50/50 | A5/B4/C5 | 16/13/3 | 10.3 |
| | G INK | HPZC1/SPD2 | 90/10 | A5/B4/C5 | 25/21/6 | 9.1 |
| | B INK | PB15:6 | 100 | A5/B4/C5 | 21/15/4 | 9.0 |
| EXAMPLE 5 | R INK | PR177D | 100 | A6/B3/C2 | 16/16/7 | 10.7 |
| | G INK | HPZC2/SPD1 | 90/10 | A6/B3/C2 | 14/14/7 | 8.2 |
| | B INK | PB15:6 | 100 | A6/B3/C2 | 17/17/8 | 8.8 |
| EXAMPLE 6 | R INK | PR177D | 100 | A3/B5/B7 | 8/16/16 | 10.6 |
| | G INK | HPZC1/SPD1 | 95/5 | A3/B5/B7 | 3/5/6 | 8.5 |
| | B INK | PB15:6 | 100 | A3/B5/B7 | 7/15/14 | 9.1 |

TABLE 3

| | | COMPOSITION OF DISPERSING-AGENT-DISPERSED LIQUID | | | | | | | |
|---|---|---|---|---|---|---|---|---|---|
| | | DISPERSING AGENT | | | | THERMOPLASTIC | | | |
| | | AMINE DISPERSING | | ACID DISPERSING | | RESIN | | SOLVENT | |
| | | AGENT | | AGENT | | | AMOUNT | | AMOUNT |
| | | | AMOUNT | | AMOUNT | | (PARTS BY | | (PARTS BY |
| | | TYPE | (PARTS BY WT.) | TYPE | (PARTS BY WT.) | TYPE | WT.) | TYPE | WT.) |
| EXAMPLE 7 | R INK | DA1 | 72 | DA4 | 20 | DR1 | 55 | S1 | 252 |
| | G INK | DA3 | 12 | DA4 | 36 | DR1 | 79 | S2 | 172 |
| | B INK | DA1 | 43 | DA4 | 13 | DR1 | 90 | S2 | 310 |
| COMPARATIVE | R INK | DA1 | 69 | DA4 | 23 | DR1 | 54 | S1 | 253 |
| EXAMPLE 1 | G INK | DA1 | 36 | DA4 | 12 | DR1 | 79 | S1 | 172 |
| | B INK | DA1 | 42 | DA4 | 14 | DR1 | 88 | S1 | 312 |
| COMPARATIVE | R INK | DA1 | 69 | DA4 | 23 | DR1 | 54 | S1 | 253 |
| EXAMPLE 2 | G INK | DA1 | 36 | DA4 | 12 | DR1 | 79 | S1 | 172 |
| | B INK | DA1 | 42 | DA4 | 14 | DR1 | 88 | S1 | 312 |
| COMPARATIVE | R INK | DA1 | 69 | DA4 | 23 | DR1 | 54 | S1 | 253 |
| EXAMPLE 3 | G INK | DA1 | 36 | DA4 | 12 | DR1 | 79 | S1 | 172 |
| | B INK | DA1 | 72 | DA4 | 14 | DR1 | 88 | S1 | 312 |
| COMPARATIVE | R INK | DA1 | 69 | DA4 | 23 | DR1 | 54 | S1 | 253 |
| EXAMPLE 4 | G INK | DA1 | 36 | DA4 | 12 | DR1 | 79 | S1 | 172 |
| | B INK | DA1 | 42 | DA4 | 14 | DR1 | 88 | S1 | 312 |
| COMPARATIVE | R INK | DA1 | 69 | DA4 | 23 | DR1 | 54 | S1 | 253 |
| EXAMPLE 5 | G INK | DA1 | 36 | DA4 | 12 | DR1 | 79 | S1 | 172 |
| | B INK | DA1 | 42 | DA4 | 14 | DR1 | 88 | S1 | 312 |

| | | | | COMPONENTS ADDED IN | | |
|---|---|---|---|---|---|---|
| | | | | CURABLE RESIN | | |
| | | COMPONENTS ADDED IN FINE | | MIXING STEP | | |
| | | DISPERSION STEP | | CURABLE | | |
| | | PIGMENT | | RESIN MATERIAL | | VISCOSITY |
| | | | AMOUNT | | AMOUNT | OF |
| | | TYPE | (PARTS BY WT.) | TYPE | (PARTS BY WT.) | INK (mP-s) |
| EXAMPLE 7 | R INK | PR177D/PR254D | 70/30 | A7/B1/C3 | 12/9/9 | 10.7 |
| | G INK | HPZC1/SPD1 | 77/23 | A8/B6/C4 | 8/6/7 | 9.5 |
| | B INK | PB15:6 | 100 | A8 B6/C4 | 18/13/14 | 9.6 |
| COMPARATIVE | R INK | PR177D/PR254D | 50/50 | A1/B1/C1 | 13/11/6 | 10.7 |
| EXAMPLE 1 | G INK | HPZC1 | 100 | A1/B1/C1 | 9/7/4 | 18.7 |
| | B INK | PB15:6 | 100 | A1/B1/C1 | 18/16/8 | 8.4 |
| COMPARATIVE | R INK | PR177D/PR254D | 50/50 | A1/B1/C1 | 13/11/6 | 10.7 |
| EXAMPLE 2 | G INK | PG36/SPD1 | 90/10 | A1/B1/C1 | 9/7/4 | 17.6 |
| | B INK | PB15:6 | 100 | A1/B1/C1 | 18/16/8 | 8.5 |
| COMPARATIVE | R INK | PR177D/PR254D | 50/50 | A1/B1/C1 | 13/11/6 | 10.7 |
| EXAMPLE 3 | G INK | SPD1 | 100 | A1/B1/C1 | 9/7/4 | 12.3 |
| | B INK | PB15:6 | 100 | A1/B1/C1 | 18/16/8 | 8.5 |
| COMPARATIVE | R INK | PR177D/PR254D | 50/50 | A1 | 30 | 13..0 |
| EXAMPLE 4 | G INK | HPZC1/SPD1 | 90/10 | A1 | 20 | 11.2 |
| | B INK | PB15:6 | 100 | A1 | 42 | 10.8 |
| COMPARATIVE | R INK | PR177D/PR254D | 50/50 | B1 | 30 | 11.7 |
| EXAMPLE 5 | G INK | HPZC1/SPD1 | 90/10 | B1 | 20 | 9.9 |
| | B INK | PB15:6 | 100 | B1 | 42 | 9.8 |

TABLE 4

| | | | | FINE DISPERSION STEP | | | | |
|---|---|---|---|---|---|---|---|---|
| | | | | FIRST TREATMENT | | | | |
| | | | | FIRST INORGANIC BEADS | | | | |
| | | | | | AMOUNT | | | |
| | | | | | (PARTS BY wt.) PER | | | |
| | | | | | 100 PARTS BY | | | |
| | | PREPARATORY | | | WEIGHT OF | | | |
| | | DISPERSION STEP | | AVERAGE | DISPERSING- | | | |
| | | TREATMENT | | PARTICLE | AGENT- | TREATMENT | ROTATIONAL | PIGMENT |
| | | TIME | ROTATIONAL | DIAMETER | DISPERSED | TIME | SPEED | CONTENT |
| | | (min.) | SPEED (rpm) | (mm) | LIQUID | (min.) | (rpm) | (wt %) |
| EXAMPLE 1 | R INK | 10 | 2000 | 0.8 | 500 | 30 | 2000 | 16 |
| | G INK | 10 | 2000 | 0.8 | 500 | 30 | 2000 | 16 |
| | B INK | 7 | 1800 | 0.8 | 500 | 30 | 2000 | 12 |
| EXAMPLE 2 | R INK | 15 | 1200 | 0.6 | 300 | 20 | 2500 | 17 |
| | G INK | 5 | 2000 | 0.7 | 450 | 25 | 1900 | 17 |
| | B INK | 6 | 1900 | 0.8 | 550 | 25 | 2300 | 14 |
| EXAMPLE 3 | R INK | 13 | 1500 | 0.6 | 400 | 20 | 2500 | 17 |
| | G INK | 7 | 2000 | 0.7 | 450 | 30 | 2000 | 17 |
| | B INK | 7 | 1800 | 0.8 | 500 | 25 | 2300 | 14 |
| EXAMPLE 4 | R INK | 3 | 4000 | 1.3 | 480 | 60 | 4000 | 15 |
| | G INK | 2 | 4100 | 1.4 | 500 | 70 | 4200 | 18 |
| | B INK | 3 | 3800 | 1.2 | 460 | 60 | 4000 | 12 |
| EXAMPLE 5 | R INK | 25 | 2200 | 1.1 | 350 | 15 | 1600 | 15 |
| | G INK | 30 | 2400 | 1.1 | 350 | 12 | 1700 | 17 |
| | B INK | 25 | 2400 | 1.1 | 300 | 15 | 1700 | 13 |
| EXAMPLE 6 | R INK | 7 | 2700 | 0.5 | 400 | 35 | 1900 | 15 |
| | G INK | 10 | 2500 | 0.4 | 350 | 40 | 1700 | 16 |
| | B INK | 5 | 2800 | 0.5 | 400 | 40 | 1600 | 14 |

| | | FINE DISPERSION STEP | | | | | | | |
|---|---|---|---|---|---|---|---|---|---|
| | | SECOND TREATMENT | | | | | | | |
| | | SECOND INORGANIC | | | | | | | |
| | | | AMOUNT | | | | | | |
| | | | (PARTS BY | | | | | | |
| | | | wt.) PER 100 | | | | | | |
| | | | PARTS BY | | | | CURABLE RESIN | | |
| | | | WEIGHT OF | | | | MIXING STEP | | |
| | | AVERAGE | DISPERSING- | TREAT- | | | TREAT- | | |
| | | PARTICLE | AGENT- | MENT | | PIGMENT | MENT | | PIGMENT |
| | | DIAMETER | DISPERSED | TIME | ROTATIONAL | CONTENT | TIME | ROTATIONAL | CONTENT |
| | | (mm) | LIQUID | (min.) | SPEED (rpm) | (wt %) | (min.) | SPEED (rpm) | (wt %) |
| EXAMPLE 1 | R INK | 0.1 | 500 | 30 | 2000 | 13 | 20 | 1500 | 7.3 |
| | G INK | 0.1 | 500 | 30 | 2000 | 13 | 20 | 1500 | 10.1 |
| | B INK | 0.1 | 500 | 30 | 2000 | 8 | 30 | 1800 | 4.9 |
| EXAMPLE 2 | R INK | 0.07 | 350 | 20 | 3000 | 13 | 40 | 3000 | 7.1 |
| | G INK | 0.2 | 500 | 25 | 2200 | 13 | 45 | 3500 | 9.8 |
| | B INK | 0.1 | 550 | 30 | 1900 | 12 | 35 | 2800 | 4.8 |
| EXAMPLE 3 | R INK | 0.07 | 350 | 20 | 2700 | 13 | 40 | 3000 | 7.1 |
| | G INK | 0.2 | 550 | 25 | 2200 | 13 | 45 | 3500 | 9.8 |
| | B INK | 0.1 | 550 | 30 | 2400 | 12 | 35 | 2800 | 4.8 |
| EXAMPLE 4 | R INK | 0.1 | 220 | 35 | 3500 | 13 | 20 | 1800 | 7.3 |
| | G INK | 0.1 | 170 | 45 | 4000 | 16 | 20 | 2100 | 10.1 |
| | B INK | 0.1 | 250 | 35 | 3300 | 10 | 25 | 1600 | 4.9 |
| EXAMPLE 5 | R INK | 0.1 | 450 | 40 | 2500 | 14 | 25 | 1800 | 7.3 |
| | G INK | 0.1 | 450 | 40 | 2700 | 15 | 25 | 1800 | 10.1 |
| | B INK | 0.1 | 500 | 35 | 2600 | 12 | 25 | 1800 | 4.9 |
| EXAMPLE 6 | R INK | 0.07 | 500 | 30 | 2400 | 14 | 25 | 2800 | 7.3 |
| | G INK | 0.05 | 450 | 30 | 2500 | 15 | 25 | 3000 | 10.1 |
| | B INK | 0.1 | 500 | 25 | 2700 | 10 | 20 | 2800 | 4.9 |

TABLE 5

| | | | | FINE DISPERSION STEP | | | | |
|---|---|---|---|---|---|---|---|---|
| | | | | FIRST TREATMENT | | | | |
| | | | | FIRST INORGANIC BEADS | | | | |
| | | | | | AMOUNT | | | |
| | | | | | (PARTS BY wt.) | | | |
| | | | | | PER 100 | | | |
| | | | | | PARTS BY | | | |
| | | PREPARATORY DISPERSION | | | WEIGHT OF | | | |
| | | STEP | | AVERAGE | DISPERSING- | | | |
| | | TREATMENT | | PARTICLE | AGENT- | TREATMENT | ROTATIONAL | PIGMENT |
| | | TIME | ROTATIONAL | DIAMETER | DISPERSED | TIME | SPEED | CONTENT |
| | | (min.) | SPEED (rpm) | (mm) | LIQUID | (min.) | (rpm) | (wt %) |
| EXAMPLE 7 | R INK | 18 | 1400 | 0.5 | 250 | 50 | 1800 | 15 |
| | G INK | 20 | 1200 | 0.4 | 250 | 70 | 1100 | 17 |
| | B INK | 15 | 1300 | 0.5 | 250 | 50 | 1600 | 13 |
| COMPARATIVE | R INK | 10 | 2000 | 0.8 | 500 | 30 | 2000 | 16 |
| EXAMPLE 1 | G INK | 10 | 2000 | 0.8 | 500 | 30 | 2000 | 16 |
| | B INK | 7 | 1800 | 0.8 | 500 | 30 | 2000 | 12 |
| COMPARATIVE | R INK | 10 | 2000 | 0.8 | 500 | 30 | 2000 | 16 |
| EXAMPLE 2 | G INK | 10 | 2000 | 0.8 | 500 | 30 | 2000 | 16 |
| | B INK | 7 | 1800 | 0.8 | 500 | 30 | 2000 | 12 |
| COMPARATIVE | R INK | 10 | 2000 | 0.8 | 500 | 30 | 2000 | 16 |
| EXAMPLE 3 | G INK | 10 | 2000 | 0.8 | 500 | 30 | 2000 | 16 |
| | B INK | 7 | 1800 | 0.8 | 500 | 30 | 2000 | 12 |
| COMPARATIVE | R INK | 10 | 2000 | 0.8 | 500 | 30 | 2000 | 16 |
| EXAMPLE 4 | G INK | 10 | 2000 | 0.8 | 500 | 30 | 2000 | 16 |
| | B INK | 7 | 1800 | 0.8 | 500 | 30 | 2000 | 12 |
| COMPARATIVE | R INK | 10 | 2000 | 0.8 | 500 | 30 | 2000 | 16 |
| EXAMPLE 5 | G INK | 10 | 2000 | 0.8 | 500 | 30 | 2000 | 16 |
| | B INK | 7 | 1800 | 0.8 | 500 | 30 | 2000 | 12 |

| | | FINE DISPERSION STEP | | | | | | | |
|---|---|---|---|---|---|---|---|---|---|
| | | SECOND TREATMENT | | | | | | | |
| | | SECOND | | | | | | | |
| | | INORGANIC BEADS | | | | | | | |
| | | | AMOUNT | | | | | | |
| | | | (PARTS BY | | | | | | |
| | | | wt.) PER 100 | | | | | | |
| | | | PARTS BY | | | | | | |
| | | | WEIGHT OF | | | | CURABLE RESIN MIXING STEP | | |
| | | AVERAGE | DISPERSING- | TREAT- | | | TREAT- | | |
| | | PARTICLE | AGENT- | MENT | | PIGMENT | MENT | | PIGMENT |
| | | DIAMETER | DISPERSED | TIME | ROTATIONAL | CONTENT | TIME | ROTATIONAL | CONTENT |
| | | (mm) | LIQUID | (min.) | SPEED (rpm) | (wt %) | (min.) | SPEED (rpm) | (wt %) |
| EXAMPLE 7 | R INK | 0.1 | 550 | 35 | 2700 | 13 | 20 | 2000 | 7.3 |
| | G INK | 0.1 | 600 | 45 | 2500 | 15 | 20 | 2300 | 10.1 |
| | B INK | 0.1 | 550 | 40 | 2800 | 10 | 25 | 2000 | 4.9 |
| COMPARATIVE | R INK | 0.1 | 500 | 30 | 2000 | 13 | 20 | 1500 | 7.3 |
| EXAMPLE 1 | G INK | 0.1 | 500 | 30 | 2000 | 13 | 20 | 1500 | 10.1 |
| | B INK | 0.1 | 500 | 30 | 2000 | 8 | 30 | 1800 | 4.9 |
| COMPARATIVE | R INK | 0.1 | 500 | 30 | 2000 | 13 | 20 | 1500 | 7.3 |
| EXAMPLE 2 | G INK | 0.1 | 500 | 30 | 2000 | 13 | 20 | 1500 | 10.1 |
| | B INK | 0.1 | 500 | 30 | 2000 | 8 | 30 | 1800 | 4.9 |
| COMPARATIVE | R INK | 0.1 | 500 | 30 | 2000 | 13 | 20 | 1500 | 7.3 |
| EXAMPLE 3 | G INK | 0.1 | 500 | 30 | 2000 | 13 | 20 | 1500 | 10.1 |
| | B INK | 0.1 | 500 | 30 | 2000 | 8 | 30 | 1800 | 4.9 |
| COMPARATIVE | R INK | 0.1 | 500 | 30 | 2000 | 13 | 20 | 1500 | 7.3 |
| EXAMPLE 4 | G INK | 0.1 | 500 | 30 | 2000 | 13 | 20 | 1500 | 10.1 |
| | B INK | 0.1 | 500 | 30 | 2000 | 8 | 30 | 1800 | 4.9 |
| COMPARATIVE | R INK | 0.1 | 500 | 30 | 2000 | 13 | 20 | 1500 | 7.3 |
| EXAMPLE 5 | G INK | 0.1 | 500 | 30 | 2000 | 13 | 20 | 1500 | 10.1 |
| | B INK | 0.1 | 500 | 30 | 2000 | 8 | 30 | 1800 | 4.9 |

### Evaluation of Stability (Durability) of color Filter Inks (Ink Set)

### 3-1. Change in External Appearance after Heat Treatment

The green color filter ink (green ink) of each of the working examples and comparative examples was visually inspected after being held at 60° C. for ten days and evaluated in terms of the four categories shown below.

A: No change observed in comparison with before heating.

B: Slight cohesion and precipitation of pigment particles observed.

C: Obvious cohesion and precipitation of pigment particles observed.

D: Marked cohesion and precipitation of pigment particles observed.

### 3-2. Amount of Change in Viscosity

The viscosity (kinematic viscosity) of the green color filter ink (green ink) of each of the working examples and comparative examples was measured after the color filter ink had been held at 60° C. for ten days and the difference between the viscosity immediately after the color filter ink was manufactured and the viscosity after ten days was calculated. More specifically, a viscosity v0 (mPa·s) was measured immediately after manufacturing, the viscosity v1 (mPa·s) at 60° C. was measured after ten days, and the difference value v1−v0 was calculated. The calculate value was then evaluated in terms of the five categories shown below.

A: The value of v1−v0 was smaller than 0.2 mPa·s.

B: The value of v1−v0 was equal to or larger than 0.2 mPa·s and smaller than 0.3 mPa·s.

C: The value of v1−v0 was equal to or larger than 0.3 mPa·s and smaller than 0.5 mPa·s.

D: The value of v1−v0 was equal to or larger than 0.5 mPa·s and smaller than 0.7 mPa·s.

E: The value of v1−v0 was equal to or larger than 0.7 mPa·s.

### 4. Evaluation of Stability of Droplet Discharge (Evaluation of Stable Discharge Properties)

Green color filter inks obtained in each of the working examples and comparative examples (color filter ink immediately after manufacturing) and green color filter inks that had been held at 60° C. for ten days after manufacturing (color filter ink held in a heated environment) were evaluated by being subjected to the tests explained below.

### 4-1. Evaluation of Landing Position Accuracy

A droplet discharge device such as that shown in FIGS. 3 to 6 was disposed in a chamber (thermal chamber), and the ink sets for a color filter of the working examples and comparative examples were prepared. 300,000 droplets (300,000 drops) of the inks were continuously discharged from the nozzles of a droplet discharge head in a state in which the drive waveform of the piezoelectric element had been optimized. The average value of the offset distance d from the center aim position of the center position of the landed droplets was calculated for the 300,000 droplets discharged from specified nozzles in the vicinity of the center of the droplet discharge head, and an evaluation was made based on the four ranges described below. Basically, the smaller this value is, the more effectively flight deflection is being prevented.

A: The average value of an offset distance d is smaller than 0.03 μm.

B: The average value of the offset distance d is equal to or larger than 0.03 μm and smaller than 0.08 μm.

C: The average value of the offset distance d is equal to or larger than 0.08 μm and smaller than 0.12 μm.

D: The average value of the offset distance d is equal to or larger than 0.12 μm.

### 4-2. Evaluation of Stability of Droplet Discharge Quantity

A droplet discharge device such as that shown in FIGS. 3 to 6 was disposed in a chamber (thermal chamber), and the ink sets for a color filter of the working examples and comparative examples were prepared. 300,000 droplets (300,000 drops) of the inks were continuously discharged from the nozzles of a droplet discharge head in a state in which the drive waveform of the piezoelectric element had been optimized. The total weight of the discharged droplets was calculated for two specific nozzles at the left and right ends of the droplet discharge head, and the absolute value ΔW (ng) of the difference between the average discharge quantities of the droplets discharged from the two nozzles was calculated. The ratio (ΔW/W_{T}) of the ΔW in relation to a target discharge quantity W_{T}(ng) of the droplets was calculated, and an evaluation was made based on the four ranges described below. Basically, the smaller the value of ΔW/W_{T} is, the better the stability of the droplet discharge quantity is.

A: The value of ΔW/W_{T} is smaller than 0.020.

B: The value of ΔW/W_{T} is equal to or larger than 0.020 and smaller than 0.420.

C: The value of ΔW/W_{T} is equal to or larger than 0.420 and smaller than 0.720.

D: The value of ΔW/W_{T} is equal to or larger 0.720.

### 4-3. Evaluation of Intermittent Printing Performance

A droplet discharge device such as that shown in FIGS. 3 to 6 was disposed in a chamber (thermal chamber), and the ink sets for a color filter of the examples and comparative examples were prepared. 50,000 droplets (50,000 drops) of the inks were continuously discharged from the nozzles of a droplet discharge head in a state in which the drive waveform of the piezoelectric element had been optimized, after which droplet discharging was stopped for 30 seconds (first sequence). Thereafter, droplets were continuously discharged in the same manner and the operation of stopping the discharge of droplets was repeated. The average weight W₁ (ng) of the droplets discharged in the first sequence and the average weight W₂₀ (ng) of the droplets discharged in the 20^{th} sequence were calculated for the specified nozzles in the vicinity of the center of the droplet discharge head. The ratio of the absolute value of the difference between W1 and W20 to a target discharge quantity W_{T}, i.e., the ratio (|W1−W20|/W_{T}), was calculated, and an evaluation was made based on the four ranges described below. Basically, the smaller the value of |W1−W20|/W_{T} is, the better the intermittent printing performance (stability of the droplet discharge quantity) is.

A: The value of |W1−W20|/W_{T} is smaller than 0.025.

B: The value of |W1−W20|/W_{T} is equal to or larger than 0.025 and smaller than 0.300.

C: The value of |W1−W20|/W_{T} is equal to or larger than 0.300 and smaller than 0.625.

D The value of |W1−W20|/W_{T} is equal or higher 0.625.

### 4-4. Continuous Discharge Test

The inks constituting the ink set for a color filter were discharged by continuously operating the droplet discharge device for 96 hours in an environment of 40% RH using a droplet discharge device such as that shown in FIGS. 3 to 6 disposed in a chamber (thermal chamber); the color filter ink sets of each of the working examples and comparative examples were tested.

The rate ([(number of clogged nozzles)/(total number of nozzles)]×100) at which clogging of the nozzles constituting the droplet discharge head occurs after continuous operation was calculated, and it was investigated whether clogging can be eliminated using a cleaning member composed of a plastic material. The results were evaluated in terms of the five categories described below.

A: Nozzle clogging does not occur.

B: The occurrence rate of nozzle clogging is less than 0.5% (not including 0), and clogging can be eliminated by cleaning.

C: The occurrence rate of nozzle clogging is 0.5% or higher and less than 0.7%, and clogging can be eliminated by cleaning.

D: The occurrence rate of nozzle clogging is 0.7% or higher and less than 1.0%, and clogging can be eliminated by cleaning.

E: The occurrence rate of nozzle clogging is 1.0% or higher, or clogging cannot be eliminated by cleaning.

The evaluation described above was carried out in the same conditions for the examples and the comparative examples.

### 5. Manufacture of Color Filters

Color filters were manufactured using color filter inks obtained in each of the working examples and comparative examples, both immediately after the color filter inks were manufactured and after the color filter inks had been held at 60° C. for ten days (held in a heated environment). The manner in which the color filters were manufactured will now be explained.

First, a substrate (G5 size: 1100 mm×1300 mm) composed of soda glass and having a silica (SiO₂) film for preventing elution of sodium ions formed on both sides thereof was prepared and washed.

Next, a radiation-sensitive composition for forming a partition wall containing carbon black was applied to the entire surface of one of the surfaces of the washed substrate to form a coated film.

Next, a pre-baking treatment was performed at a heating temperature of 110° C. and a heating time of 120 seconds.

After the pre-baking treatment, partition walls were formed by irradiating the radiation sensitive composition via a photomask, subjecting the same to post exposure baking (PEB), conducting a development treatment using an alkali development fluid, and then conducting a post baking treatment. PEB was carried out at a heating temperature of 110° C., a heating time of 120 seconds, and an irradiation intensity of 150 mJ/cm². The development processing was conducted using a vibration soaking method. The development treatment time was 60 seconds. The post baking treatment was carried out at a heating temperature of 150° C. for heating time of 5 minutes. The thickness of the partition wall thus formed was 2.1 μm.

Next, the color filter ink was discharged into the cells as areas surrounded by the partition walls by using a droplet discharge device such as that shown in FIGS. 3 to 6. Three colors of color filter ink were used and the color filter ink was discharged such that mixing of the colors did not occur. A droplet discharge head was used in which the nozzle plate had been joined using an epoxy adhesive (AE-40, manufactured by Ajinomoto Fine-Techno).

After depositing the color filter inks, a heat treatment was carried out for 10 minutes at 100° C. on a hot plate and another heat treatment was then carried out for one hour in an oven at 200° C. In this way, colored portions having three different n colors were formed. A color filter such as that shown in FIG. 1 was thereby obtained.

Using the method described above, 7000 color filters were manufactured with the color filter inks (ink set) obtained in each of the working examples and the comparative examples, i.e., each ink set was used to manufacture 7000 color filters per ink set.

### 6. Evaluation of Color Filters

The color filters obtained in the manner described above were evaluated in the manner described below

### 6-1. Unevenness of Color and Saturation

Of the 7000 color filters manufactured using the color filter inks (ink set) of each of the working examples and the comparative examples, the 7000^{th} color filter made with each ink set was used to manufacture a liquid crystal display device such as that shown in FIG. 7. All of the liquid crystal display devices were manufactured under the same conditions.

Green monochromatic display and white monochromatic display were visually observed in a darkroom using these liquid crystal display devices and the occurrence of uneven color and uneven saturation between different regions was evaluated in terms of the five standards described below.

A: Uneven color and uneven saturation were not observed.

B: Uneven color and uneven saturation were substantially not observed.

C: Some uneven color and uneven saturation was observed.

D: Uneven color and uneven saturation were plainly observed.

E: Marked uneven color and uneven saturation were observed.

### 6-2. Differences in Characteristics Between Units

Of the 7000 color filters manufactured using the color filter inks (ink set) of each of the working examples and the comparative examples, the 1^{st} to 10^{th} and the 5990^{th} to 5999^{th} color filters made with each ink set were evaluated by randomly extracting 100 pixels from each color filter. A green monochromatic display and a white monochromatic display were conducted in a darkroom and the chrominance of each of the extracted pixels was measured using a spectrophotometer (MCPD 3000, manufactured by Otsuka Electronics). The average value of the chrominances measured for the 100 pixels of each color filter was used as the chrominance for that color filter. The maximum color difference (color difference ΔE in the Lab display system) among first to the 10^{th} and the 5990^{th} to the 5999^{th} color filters (total of twenty color filters) was calculated for each of the working examples and comparative examples and the results were evaluated in terms of the five ranges described below.

A: Color difference (ΔE) is less than 0.5.

B: Color difference (ΔE) is equal to or larger than 0.5 and less than 1.0.

C: Color difference (ΔE) is equal to or larger than 1.0 and less than 1.5.

D: Color difference (ΔE) is equal to or larger than 1.5 and less than 2.0.

E: Color difference (ΔE) is 2.0 or more.

### 6-3. Durability

Of the 7000 color filters manufactured using the color filter inks (ink set) of each of the working examples and the comparative examples, the 2001^{th} to 2010^{th} color filters made with each ink set were used to manufacture a liquid crystal display device such as that shown in FIG. 7. All of the liquid crystal display devices were manufactured under the same conditions.

A green monochromatic display and a white monochromatic display were visually observed in a darkroom using each of these liquid crystal display devices and the occurrence of the leakage (white spots, luminescent spots) of light was investigated.

Next, the color filters were removed from the liquid crystal display devices.

Each of the removed color filters was placed successively in environments at the following temperatures: 20° C. for 1.5 hours, 50° C. for 2 hours, 20° C. for 1.5 hours, and −10° C. for 3 hours. Finally, the temperature was returned to 20° C., thereby completing one cycle (8 hours). This cycle was repeated 20 times (for a total treatment time of 160 hours).

Thereafter, the liquid crystal display devices like that shown in FIG. 7 were reassembled using these color filters.

A green monochromatic display and a white monochromatic display were visually observed in a darkroom using each of these liquid crystal display devices and the occurrence of light leakage (white spots, luminescent spots) was investigated in terms of the five standards described below.

A: There were no color filters in which light leakage (white spots, luminescent spots) occurred.

B: Light leakage (white spots, luminescent spots) was observed in one or two color filters.

C: Light leakage (white spots, luminescent spots) was observed in three to five color filters.

D: Light leakage (white spots, luminescent spots) was observed in six to nine color filters.

E. Light leakage (white spots, luminescent spots) was observed in ten color filters.

### 7. Evaluation of Contrast

Green color filter inks obtained in each of the working examples and comparative examples (color filter ink immediately after manufacturing) and green color filter inks that had been held at 60° C. for ten days after manufacturing (color filter ink held in a heated environment) were evaluated by being subjected to the tests explained below.

The green ink of the ink set obtained in each of the working examples and comparative examples was used to form a green colored film on a different glass plate (diameter: 10 cm) using an inkjet method.

The colored films were formed by discharging droplets of the ink onto the glass plates, heating the glass plates on a hot plate for 10 minutes at 120° C., and heating the glass plates inside an oven for 0.5 hour at 260° C. The discharge quantity of the color filter ink was adjusted such that the colored films formed had a thickness of 1.5 μm.

The contrast (CR) was determined for each of the glass substrates on which a colored film was formed using a contrast tester (CT-1, manufactured by Tsubosaka Electric) and evaluated in terms of the three ranges described below.

A: CR was 11,000 or higher.

B: CR was 5500 or higher and less than 11000.

C: CR was less than 5500.

### 8. Evaluation of Lightness

A calorimeter (CM-3700 manufactured by Minolta) was used to measure tristimulus values with respect to each of the glass substrates on which a green colored film was formed (i.e., the glass plates used in the contrast evaluation) using an xyY color specification method. The results were evaluated in terms of the five ranges shown below.

A: Lightness Y was equal to or larger than 63.0.

B: The lightness Y was equal to or larger than 61.0 and smaller than 63.0.

C: The lightness Y was equal to or larger than 59.0 and smaller than 61.0.

D: The lightness Y was equal to or larger than 57.5 and smaller than 59.0.

E: Lightness Y was smaller than 57.5.

In the evaluations described above, all of the color filters and glass plates were observed and measured under the same conditions.

The results are shown in Table 6. In the table, results for color filter inks evaluated immediately after being manufactured are indicated as “before heating” and results for color filter inks evaluated after being held at 60° C. for ten days (held in a heated environment) are indicated as “after heating.”

TABLE 6

| | | | EVALUATION OF DISCHARGE STABILITY CHARACTERISTICS | | | | | | | |
|---|---|---|---|---|---|---|---|---|---|---|
| | | | | | STABILITY OF | | | | | |
| | | | LANDING | | DROPLET | | INTERMITTENT | | | |
| | | | POSITION | | DISCHARGE | | PRINTING | | CONTINUOUS | |
| | APPEARANCE | | ACCURACY | | QUANTITY | | PERFORMANCE | | DISCHARGE TEST | |
| | CHANGE | | | AFTER | | AFTER | | AFTER | | AFTER |
| | AFTER | CHANGE IN | BEFORE | HEAT- | BEFORE | HEAT- | BEFORE | HEAT- | BEFORE | HEAT- |
| | HEATING | VISCOSITY | HEATING | ING | HEATING | ING | HEATING | ING | HEATING | ING |
| EXAMPLE 1 | A | A | A | A | A | A | A | A | A | A |
| EXAMPLE 2 | A | A | A | A | A | A | A | A | A | A |
| EXAMPLE 3 | A | A | B | B | B | B | A | B | B | B |
| EXAMPLE 4 | A | A | A | A | A | B | A | B | A | A |
| EXAMPLE 5 | A | B | B | B | A | A | A | A | B | B |
| EXAMPLE 6 | A | A | A | A | A | B | A | A | A | A |
| EXAMPLE 7 | A | B | A | B | A | A | A | B | A | A |
| COMPARATIVE | D | E | D | D | D | D | D | D | E | E |
| EXAMPLE 1 | | | | | | | | | | |
| COMPARATIVE | D | E | C | D | D | D | C | C | D | E |
| EXAMPLE 2 | | | | | | | | | | |
| COMPARATIVE | D | E | C | D | C | D | C | C | D | E |
| EXAMPLE 3 | | | | | | | | | | |
| COMPARATIVE | C | D | C | D | C | D | C | D | E | E |
| EXAMPLE 4 | | | | | | | | | | |
| COMPARATIVE | A | A | A | A | A | B | A | B | A | B |
| EXAMPLE 5 | | | | | | | | | | |

| | COLOR AND | | DIFFERENCES IN | | | | | | | |
|---|---|---|---|---|---|---|---|---|---|---|
| | SATURATION | | CHARACTERISTICS | | | | | | | |
| | VARIATION | | BETWEEN UNITS | | DURABILITY | | CONTRAST | | LIGHTNESS | |
| | | AFTER | | AFTER | | AFTER | | AFTER | | AFTER |
| | BEFORE | HEAT- | BEFORE | HEAT- | BEFORE | HEAT- | BEFORE | HEAT- | BEFORE | HEAT- |
| | HEATING | ING | HEATING | ING | HEATING | ING | HEATING | ING | HEATING | ING |
| EXAMPLE 1 | A | A | A | A | A | A | A | A | A | A |
| EXAMPLE 2 | A | A | A | A | A | A | A | A | A | A |
| EXAMPLE 3 | B | B | A | A | A | A | A | A | A | A |
| EXAMPLE 4 | A | B | A | A | A | A | A | A | A | A |
| EXAMPLE 5 | A | B | A | A | A | A | B | B | A | B |
| EXAMPLE 6 | A | A | A | A | B | B | A | B | B | B |
| EXAMPLE 7 | A | B | A | A | A | A | A | A | A | A |
| COMPARATIVE | E | E | E | E | E | E | C | C | E | E |
| EXAMPLE 1 | | | | | | | | | | |
| COMPARATIVE | E | E | E | E | A | A | C | C | C | D |
| EXAMPLE 2 | | | | | | | | | | |
| COMPARATIVE | E | E | E | E | B | B | C | C | D | E |
| EXAMPLE 3 | | | | | | | | | | |
| COMPARATIVE | C | D | D | E | E | E | C | C | C | D |
| EXAMPLE 4 | | | | | | | | | | |
| COMPARATIVE | B | D | A | D | E | E | A | C | B | D |
| EXAMPLE 5 | | | | | | | | | | |

As is clear from Table 6, a color filter ink in accordance with the present invention has excellent droplet discharge stability, and unevenness of color and saturation and light leakage are suppressed in the color filters manufactured with a color filter ink in accordance with the present invention. Moreover, the variation between units of color filters manufactured in accordance with the present invention was small. The durability of color filters in accordance with the present invention was also excellent. The contrast and lightness achieved with the present invention were also excellent. The stability of color filter inks in accordance with the present invention is excellent and the color filter inks can be discharged in a favorable fashion even after being held in a heated condition for some time. It was demonstrated that high quality color filters can be manufactured in a stable fashion using a color filter ink in accordance with the present invention. Conversely, satisfactory results were not obtained in the comparative examples.

Commercially available liquid crystal televisions were disassembled and the liquid crystal display device portions were exchanged with those manufactured in the manner described above. The same evaluation as that described above was carried out and the same results as those described above were obtained.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A color filter ink adapted to be used to manufacture a color filter by an inkjet method, the color filter ink comprising:
a main pigment including a halogenated phthalocyanine zinc complex;
a secondary pigment including a sulfonated pigment derivative;
a solvent; and
a curable resin material including a first polymer and a second polymer with
the first polymer including at least a first epoxy-containing vinyl monomer as a monomer component and not including a fluoroalkyl- or fluoroaryl-containing vinyl monomer represented by a chemical formula (1) below as a monomer component,
the second polymer including at least the fluoroalkyl- or fluoroaryl-containing vinyl monomer represented by the chemical formula (1) below as a monomer component, 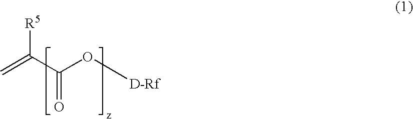
wherein, in the chemical formula (1), R⁵ represents a hydrogen atom or a C₁₋₇ alkyl group, D represents a single bond hydrocarbon group, a bivalent hydrocarbon group or a bivalent hydrocarbon group having a hetero atom, Rf represents a C₁₋₂₀ fluoroalkyl group or fluoroaryl group, and a value z is 0 or 1.

2. The color filter ink according to claim 1, wherein
the first polymer is a copolymer having the first epoxy-containing vinyl monomer and a second vinyl monomer as monomer components, the second vinyl monomer having an isocyanate group or a block isocyanate group in which an isocyanate group is protected by a protective group.

3. The color filter ink according to claim 1, wherein
the first polymer is a copolymer having the first epoxy-containing vinyl monomer and a third vinyl monomer as monomer components, the third vinyl monomer having a hydroxyl group.

4. The color filter ink according to claim 1, wherein
a ratio of a content of the first polymer to a content of the second polymer is 25:75 to 75:25 in terms of weight.

5. The color filter ink according to claim 1, wherein
the pigment derivative has a chemical structure represented by a chemical formula (2) below 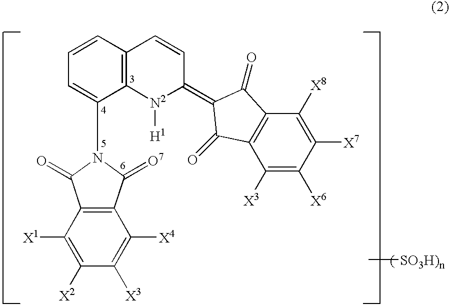
wherein, in the chemical formula (2), n is an integer from 1 to 5, and each of X₁ to X⁸ is independently one of a hydrogen atom and a halogen atom.

6. The color filter ink according claim 1, wherein
the color filter ink contains 0.5 to 32 parts by weight of the pigment derivative with respect to 100 parts by weight of the main pigment.

7. The color filter ink according to claim 1, wherein
the solvent includes one or more compounds selected from the group consisting of 1,3-butylene glycol diacetate, bis(2-butoxyethyl)ether, and diethylene glycol monobutyl ether acetate.

8. A color filter ink set including a plurality of different colors of color filter ink with a green ink being the color filter ink according to claim 1.

9. A color filter manufactured using the color filter ink according to claim 1.

10. A color filter manufactured using the color filter ink set according claim 8.

11. An image display device having the color filter according to claim 9.

12. The image display device according to claim 11, wherein the image display device is a liquid crystal panel.

13. An electronic device having the image display device according to claim 11.
